(19) United States
(12) Patent Application Publication
(10) Pub. No.: US 2024/0122214 A1
(43) Pub. Date: Apr. 18, 2024

(54) COMPOSITIONS, METHOD OF MAKING AND METHOD OF USE THEREOF

(71) Applicant: EPC NATURAL PRODUCTS CO., LTD, BEIJING (CN)

(72) Inventors: Weiyue SHI, BEIJING (CN); Weiyao SHI, Bethlehem, PA (US); Jingang SHI, BEIJING (CN); Thomas EIDENBERGER, Wels (AT)

(21) Appl. No.: 18/516,254

(22) Filed: Nov. 21, 2023

Related U.S. Application Data
(63) Continuation-in-part of application No. 17/455,327, filed on Nov. 17, 2021.
Application No. 17/455,327 is a continuation of application No. 16/403,053, filed on May 3, 2019, now Pat. No. 11,304,431.
Application No. 16/403,053 is a continuation-in-part of application No. 17/454,548, filed on Nov. 11, 2021.
Application No. 17/454,548 is a continuation of application No. 16/402,360, filed on May 3, 2019, now Pat. No. 11,425,923.
Application No. 16/402,360 is a continuation-in-part of application No. 16/405,748, filed on May 7, 2019.
Application No. 16/405,748 is a continuation-in-part of application No. 14/714,644, filed on May 18, 2015, now Pat. No. 10,264,811.
Application No. 14/714,644 is a continuation-in-part of application No. 17/309,184, filed on May 4, 2021.
Application No. 17/309,184 is a continuation-in-part of application No. 16/402,641, filed on May 3, 2019, now Pat. No. 11,102,996.
Application No. 16/402,641 is a continuation-in-part of application No. 16/434,292, filed on Jun. 7, 2019.
Application No. 16/434,292 is a continuation-in-part of application No. 17/806,851, filed on Jun. 14, 2022.
Application No. 17/806,851 is a continuation-in-part of application No. 18/053,593, filed on Nov. 8, 2022.
Application No. 18/053,593 is a continuation-in-part of application No. 18/060,894, filed on Dec. 1, 2022.
Application No. 18/060,894 is a continuation-in-part of application No. 18/320,502, filed on May 19, 2023.
Application No. 18/320,502 is a continuation-in-part of application No. 16/676,945, filed on Nov. 7, 2019, now Pat. No. 11,751,593.
Application No. 16/676,945 is a continuation-in-part of application No. 16/402,641, filed on May 3, 2019, now Pat. No. 11,102,996.
Application No. 18/320,502 is a continuation-in-part of application No. 17/018,086, filed on Sep. 11, 2020, now abandoned.
Application No. 18/320,502 is a continuation-in-part of application No. 17/302,995, filed on May 18, 2021.
Application No. 18/320,502 is a continuation-in-part of application No. 17/457,250, filed on Dec. 1, 2021, now abandoned.
(60) Provisional application No. 62/668,580, filed on May 8, 2018.
(60) Provisional application No. 62/696,481, filed on Jul. 11, 2018.
(60) Provisional application No. 62/744,755, filed on Oct. 12, 2018.
(60) Provisional application No. 62/771,485, filed on Nov. 26, 2018.
(60) Provisional application No. 62/775,983, filed on Dec. 6, 2018.
(60) Provisional application No. 62/819,980, filed on Mar. 18, 2019.
(60) Provisional application No. 62/841,858, filed on May 2, 2019.
(60) Provisional application No. 62/668,580, filed on May 8, 2018.
(60) Provisional application No. 62/696,481, filed on Jul. 11, 2018.
(60) Provisional application No. 62/744,755, filed on Oct. 12, 2018.
(60) Provisional application No. 62/771,485, filed on Nov. 26, 2018.
(60) Provisional application No. 62/775,983, filed on Dec. 6, 2018.
(60) Provisional application No. 62/819,980, filed on Mar. 18, 2019.
(60) Provisional application No. 62/841,858, filed on May 2, 2019.
(60) Provisional application No. 62/000,210, filed on May 19, 2014.
(60) Provisional application No. 62/023,216, filed on Jul. 11, 2014.
(60) Provisional application No. 62/668,580, filed on May 8, 2018.
(60) Provisional application No. 62/696,481, filed on Jul. 11, 2018.
(60) Provisional application No. 62/744,755, filed on Oct. 12, 2018.
(60) Provisional application No. 62/771,485, filed on Nov. 26, 2018.
(60) Provisional application No. 62/775,983, filed on Dec. 6, 2018.
(60) Provisional application No. 62/819,980, filed on Mar. 18, 2019.
(60) Provisional application No. 62/841,858, filed on May 2, 2019.
(60) Provisional application No. 62/683,154, filed on Jun. 11, 2018.
(60) Provisional application No. 62/729,524, filed on Sep. 11, 2018.
(60) Provisional application No. 62/857,875, filed on Jun. 6, 2019.
(60) Provisional application No. 63/202,553, filed on Jun. 16, 2021.
(60) Provisional application No. 63/264,006, filed on Nov. 12, 2021.
(60) Provisional application No. 63/382,322, filed on Nov. 4, 2022.
(60) Provisional application No. 62/264,895, filed on Dec. 9, 2015.
(60) Provisional application No. 62/902,035, filed on Sep. 18, 2019.
(60) Provisional application No. 63/026,910, filed on May 19, 2020.
(60) Provisional application No. 63/062,645, filed on Aug. 7, 2020.
(60) Provisional application No. 63/144,025, filed on Feb. 1, 2021.
(60) Provisional application No. 63/120,462, filed on Dec. 2, 2020.

(51) Int. Cl. A23L 2/60; A21D 2/18; A21D 2/24; A21D 2/26; A23C 9/13; A23C 9/152; A23C 9/156; A23F 5/46; A23L 2/02; A23L 2/38; A23L 2/54; A23L 2/56; A23L 2/66; A23L 27/00; A23L 27/10; A23L 27/21; A23L 27/30; A23L 33/105; A23L 33/125; A23L 33/145; A23L 33/175; A23L 33/18

(52) U.S. Cl. CPC A23L 2/60; A21D 2/181; A21D 2/245; A21D 2/26; A23C 9/1307; A23C 9/1526; A23C 9/156; A23F 5/465; A23L 2/02; A23L 2/38; A23L 2/54; A23L 2/56; A23L 2/66; A23L 27/11; A23L 27/215; A23L 27/31; A23L 27/33; A23L 27/34; A23L 27/36; A23L 27/88; A23L 33/105; A23L 33/125; A23L 33/145; A23L 33/175; A23L 33/18; A23F 3/405; A23V 2002/00

(57) ABSTRACT

Compositions comprising a flavor/taste modifying agent and a sweetener are disclosed. The flavor/taste modifying agent is present at an amount sufficient to enhance a flavor and/or taste profile of the sweetener in the composition.

### COMPOSITIONS, METHOD OF MAKING AND METHOD OF USE THEREOF

This application is a continuation-in-part application of U.S. patent application Ser. No. 17/455,327, filed on Nov. 17, 2021, which is a continuation of U.S. patent application Ser. No. 16/403,053, filed May 3, 2019, now U.S. Pat. No. 11,304,431, which claims priority to U.S. Provisional Patent Application No. 62/668,580, filed May 8, 2018, U.S. Provisional Patent Application No. 62/696,481, filed Jul. 11, 2018, U.S. Provisional Patent Application No. 62/744,755, filed Oct. 12, 2018, U.S. Provisional Patent Application No. 62/771,485, filed Nov. 26, 2018 and U.S. Provisional Patent Application No. 62/775,983, filed Dec. 6, 2018, U.S. Provisional Application No. 62/819,980, filed Mar. 18, 2019 and U.S. Provisional Application No. 62/841,858, filed May 2, 2019. The contents of the above cited references are incorporated herein in their entirety for all purposes.

This application is also a continuation-in-part application of U.S. patent application Ser. No. 17/454,548, filed on Nov. 11, 2021, which is a continuation of U.S. patent application Ser. No. 16/402,360, filed May 3, 2019, now U.S. Pat. No. 11,425,923, which claims priority to U.S. Provisional Patent Application No. 62/668,580, filed May 8, 2018, U.S. Provisional Patent Application No. 62/696,481, filed Jul. 11, 2018, U.S. Provisional Patent Application No. 62/744,755, filed Oct. 12, 2018, U.S. Provisional Patent Application No. 62/771,485, filed Nov. 26, 2018 and U.S. Provisional Patent Application No. 62/775,983, filed Dec. 6, 2018, U.S. Provisional Patent Application No. 62/819,980, filed on Mar. 18, 2019 and U.S. Provisional Patent Application No. 62/841,858, filed on May 2, 2019.

This application is also a continuation-in-part application of U.S. patent application Ser. No. 16/405,748, filed on May 7, 2019, which is a continuation-in-part application to U.S. patent application Ser. No. 14/714,644, filed May 18, 2015, now U.S. Pat. No. 10,264,811, which claims priority from U.S. Provisional Patent Application No. 62/000,210, filed May 19, 2014, and U.S. Provisional Patent Application No. 62/023,216, filed Jul. 11, 2014. This application also claims priority from U.S. Provisional Patent Application No. 62/668,535, filed May 8, 2018; U.S. Provisional Patent Application No. 62/691,723, filed Jun. 29, 2018; and U.S. Provisional Patent Application No. 62/730,449, filed Sep. 12, 2018. The contents of the above cited references are incorporated herein in their entirety for all purposes.

This application is also a continuation-in-part application of U.S. patent application Ser. No. 17/309,184, filed on May 4, 2021, which is a Continuation-in-part application of U.S. patent application Ser. No. 16/402,641, filed on May 3, 2019, now U.S. Pat. No. 11,102,996, which claims priority to U.S. Provisional Patent Application No. 62/668,580, filed May 8, 2018, U.S. Provisional Patent Application No. 62/696,481, filed Jul. 11, 2018, U.S. Provisional Patent Application No. 62/744,755, filed Oct. 12, 2018, U.S. Provisional Patent Application No. 62/771,485, filed Nov. 26, 2018 and U.S. Provisional Patent Application No. 62/775,983, filed Dec. 6, 2018, U.S. Provisional Application No. 62/819,980, filed Mar. 18, 2019 and U.S. Provisional Application No. 62/841,858, filed May 2, 2019 and U.S. Provisional Patent Application No. 62/902,035, filed Sep. 18, 2019. The contents of the above cited references are incorporated herein in their entirety for all purposes.

This application is also a continuation-in-part application of U.S. patent application Ser. No. 16/434,292, filed on Jun. 7, 2019, which claims priority to U.S. Provisional Application No. 62/683,154, filed Jun. 11, 2018, U.S. Provisional Application No. 62/729,524, filed Sep. 11, 2018 and Provisional Application No. 62/857,875, filed Jun. 6, 2019. The contents of the above cited references are incorporated herein in their entirety for all purposes.

This application is also a continuation-in-part application of U.S. patent application Ser. No. 17/806,851, filed on Jun. 14, 2022, which claims priority of U.S. Provisional Patent Application No. 63/202,553, filed on Jun. 16, 2021, which is incorporated by reference in its entirety.

This application is also a continuation-in-part application of U.S. patent application Ser. No. 18/053,593, filed on Nov. 8, 2022, which claims priority from U.S. Provisional Patent Application No. 63/264,006, filed Nov. 12, 2021; U.S. Provisional Patent Application No. 63/382,322, filed Nov. 4, 2022, and PCT Application No. PCT/CN2022/130555, filed Nov. 8, 2022. These applications are incorporated herein by reference.

This application is also a continuation-in-part application of U.S. patent application Ser. No. 18/060,894, filed on Dec. 1, 2022, which claims priority from U.S. Provisional Application No. 62/264,895, filed Dec. 3, 2021 and PCT Application No. PCT/CN2022/135489, filed Nov. 30, 2022, both of which are incorporated herein by reference.

This application is also a continuation-in-part application of U.S. patent application Ser. No. 18/320,502, filed on May 19, 2023, which is continuation-in-part of U.S. patent application Ser. No. 16/676,945, filed on Nov. 7, 2019, now U.S. Pat. No. 11,751,593 which is a continuation-in-part of U.S. patent application Ser. No. 16/402,641, filed on May 3, 2019, now U.S. Pat. No. 11,102,996, which claims priority to U.S. Provisional Application No. 62/668,580, filed on May 8, 2018, U.S. Provisional Patent Application No. 62/696,481, filed on Jul. 11, 2018, U.S. Provisional Application No. 62/744,755, filed on Oct. 12, 2018, U.S. Provisional Application No. 62/771,485, filed on Nov. 26, 2018, U.S. Provisional Application No. 62/775,983, filed on Dec. 6, 2018, U.S. Provisional Application No. 62/819,980, filed on Mar. 18, 2019, and U.S. Provisional Application No. 62/841,858, filed on May 2, 2019. Application Ser. No. 18/320,502, filed on May 19, 2023 is also a continuation-in-part application of U.S. patent application Ser. No. 17/018,086, filed on Sep. 11, 2020, now Abandoned, which claims priority to U.S. Provisional Application No. 62/902,035, filed on Sep. 18, 2019, U.S. patent application Ser. No. 18/320,502 is also a continuation-in-part application of U.S. patent application Ser. No. 17/302,995, filed on May 18, 2021, which claims priority to U.S. Provisional Application No. 63/026,910, filed on May 19, 2020, U.S. Provisional Application No. 63/062,645, filed on Aug. 7, 2020, and U.S. Provisional Application No. 63/144,025, filed on Feb. 1, 2021. U.S. patent application Ser. No. 18/320,502 is also a continuation-in-part application of U.S. patent application Ser. No. 17/457,250, filed Dec. 1, 2021, which claims priority to U.S. Provisional Application No. 63/120,462, filed on Dec. 2, 2020. The contents of the above cited references are incorporated herein in their entirety for all purposes.

This application is also a continuation-in-part application of U.S. patent application Ser. No. 18/562,026, filed on Nov 17, 2023, which is a U.S. National Stage Entry of PCT Application No. PCT/CN2022/123036, filed on Sep. 30, 2022.

### FIELD

The present disclosure relates generally to sweetener and flavoring agents, compositions containing the same and method of making and using the same.

### BACKGROUND

High intensity sweeteners (HIS) have been widely used in the food and beverage products as sugar replacement. Presently, the sensory benchmarks associated with products containing HIS, including the natural HIS (NHIS), such as steviol glycosides, sweet tea extracts and monk fruit extracts, are mostly predicated on the taste of sugar sweetness. There is need for further exploring the characteristics of natural HIS sweeteners and their use in the food and beverage products.

### BRIEF SUMMARY

One aspect of the present application relates to a method for inhibiting glucose absorption in a subject. The method comprises the step of administering to the subject, an effective amount of a plant extract that inhibits glucose transport in a mammalian cell, wherein the plant extract contains one or more substances selected from the group consisting of alkaloids, flavonoids, polyphenols and isoprenoids.

In some embodiments, the plant extract comprises one or more of the substances selected from the group consisting of rubusosides, protocatechuic acid, caffeic acid, rutin, hyperodise, isoquercetin, guajaverin, and apigenin-7-O-glucoside. In some embodiments, the plant extract is a sweet tea extract. In some embodiments, the plant extract comprises rubusoside. In some embodiments, the plant extract is a monk fruit extract. In some embodiments, the plant extract is a Stevia extract. In some embodiments, the plant extract is a guava fruit extract or guava leaf extract.

Another aspect of the present application relates to a composition comprising: (1) a high intensity sweetner (HIS); and (2) a glucose transport inhibitor that is not derived from the HIS.

In some embodiments, the glucose transport inhibitor is a plant extract comprising rubusoside. In some embodiments, the glucose transport inhibitor is a Stevia extract. In some embodiments, the glucose transport inhibitor is a non-SG substance. In some embodiments, the glucose transport inhibitor is a monk fruit extract. In some embodiments, the glucose transport inhibitor is a sweet tea extract. In some embodiments, the glucose transport inhibitor is RU60 or RU85. In some embodiments, the glucose transport inhibitor is a guava leaf extract or a guava fruit extract. In some embodiments, the glucose transport inhibitor has antioxidant activities. In some embodiments, the glucose transport inhibitor is selected from the group consisting of alkaloids, flavonoids, polyphenols and isoprenoids.

Another aspect of the present application relates to a beverage that comprise the composition of the present application.

Another aspect of the present application relates to a dairy product that comprise the composition of the present application.

Another aspect of the present application relates to a food product that comprise the composition of the present application.

Another aspect of the present application relates to a method for inhibiting glucose absorption in a subject, comprising the step of administering to the subject, an effective amount of the composition of the present application.

### BRIEF DESCRIPTION OF DRAWINGS

While the present disclosure will now be described in detail, and it is done so in connection with the illustrative embodiments, it is not limited by the particular embodiments illustrated in the figures and the appended numbered paragraphs.

FIG. 1 shows one embodiment of an experimental set up wherein the flavor substance is delivered to the pharynx area through a nasal tube and the grape essential oil solution is delivered to the pharynx area through a feeding tube

FIG. 2 shows cell viability tests with guava and sweet tea extracts in Caco-2 cells. Cells were seeded in 96-well microtiter plates, grown for 24 h and then treated with the extracts in the indicated dilutions for 3 and 24 h. Resazurin was added, and the cells were incubated for 1.5 h. The fluorescence intensity (Ex 560 nm/Em 590 nm) of the intermediate resorufin was detected and normalized to the untreated control. Error bars are based on the standard deviation (n=3). **p<0.01 ***p<0.001 and ****p<0.0001 indicate significant differences from the control (one-way ANOVA, Dunnett's multiple comparison test).

FIG. 3 shows effect of guava and sweet tea extracts on intestinal glucose transport inhibition. Caco-2 cells were seeded on 0.4 μm trans-well inserts for monolayer formation and fast differentiation. On day 5, glucose transport across the cell monolayer was performed. Therefore, cell culture medium containing 13.5 g/L glucose and 1 g/L xylitol with or without the indicated dilutions of extracts or phloretin (100 mg/L) was placed as donor solution onto the apical compartment. Samples were collected from the basolateral compartment (HEPES buffer) after 0, 0.5, 1, 1.5, and 2 hours. Glucose concentrations of the samples were measured by HPLC. The graphs show data obtained from one experiment performed in duplicate (A: absolute glucose transport, B: glucose transport relative to control). Error bars are based on the standard error of the mean (n=2). *p<0.05 indicates a significant difference from the control (two-way ANOVA, Tukey's multiple comparison test).

FIG. 4 shows TEER values and xylitol permeability of filter-grown Caco-2 cell layers during the intestinal glucose transport study. Caco-2 cells were seeded on 0.4 μm trans-well inserts for monolayer formation and fast differentiation. On day 5, glucose transport across the cell monolayer was performed. The effect on barrier integrity was analyzed by measuring TEER after 0, 0.5, 1, 1.5, and 2 hours (A) and by including xylitol as a reference substance for the paracellular permeability of the cell layer (B). Xylitol concentrations of the samples taken were measured by HPLC. Error bars are based on the standard error of the mean (n=2).

FIG. 5. Cell viability tests with crude RU60 and refined RU85 products in Caco-2 cells (trial 1). Cells were seeded in 96-well microtiter plates, grown for 24 h and then treated with the test compounds in the indicated dilutions for 24 h. Resazurin was added, and the cells were incubated for 1.5 h. The fluorescence intensity (Ex 560 nm/Em 590 nm) of the intermediate resorufin was detected and normalized to the untreated control (HBSS). Error bars are based on the standard deviation (n=3). **p<0.01 and ****p<0.0001 indicate significant differences from the control (one-way ANOVA, Tukey's multiple comparison test).

FIG. 6. Cell viability tests with crude RU60 and refined RU85 products in Caco-2 cells (trial 2). Cells were seeded in 96-well microtiter plates, grown for 24 h and then treated with the test compounds in the indicated dilutions for 24 h. Resazurin was added, and the cells were incubated for 1.5 h. The fluorescence intensity (Ex 560 nm/Em 590 nm) of the intermediate resorufin was detected and normalized to the untreated control (HBSS). Error bars are based on the standard deviation (n=3). ****p<0.0001 indicates a significant difference from the control (one-way ANOVA, Tukey's multiple comparison test).

FIG. 7 shows effect of rubusoside containing plant extracts on intestinal glucose transport inhibition. Caco-2 cells were seeded on 0.4 μm trans-well inserts for monolayer formation and fast differentiation. On day 5, glucose transport across the cell monolayer was performed. Therefore, cell culture medium containing 13.5 g/L glucose and 1 g/L xylitol with or without the indicated concentrations of rubusoside plant extract or phloretin was placed as donor solution onto the apical compartment. Samples were collected from the basolateral compartment (HEPES buffer) after 0, 0.5, 1, 1.5, 2 and 3 hours. Glucose concentrations of the samples were measured by HPLC. The graph shows data obtained from one experiment performed in duplicate (Panels A, C and E: absolute glucose transport, Panels B, D and F: glucose transport relative to control). Error bars are based on the standard error of the mean (n=2). *p<0.05 indicates a significant difference from the control (two-way ANOVA, Tukey's multiple comparison test).

FIG. 8 shows TEER values and xylitol permeability of filter-grown Caco-2 cell layers during the intestinal glucose transport study. Caco-2 cells were seeded on 0.4 μm trans-well inserts for monolayer formation and fast differentiation. On day 5, glucose transport across the cell monolayer was performed. Therefore, cell culture medium containing 13.5 g/L glucose and 1 g/L xylitol with or without the indicated concentrations of rubusoside plant extract or phloretin was placed as donor solution onto the apical compartment. The effect on barrier integrity was analyzed by measuring TEER after 0, 0.5, 1, 1.5, 2 and 3 hours (Panels A, C and E) and by including xylitol as a reference substance for the paracellular permeability of the cell layer (Panels B, D and F). Xylitol concentrations of the samples taken were measured by HPLC. Error bars are based on the standard error of the mean (n=2).

One of ordinary skill will understand that the differing embodiments disclosed in this application can all be used either independently or in combination with each other and there is no limitation implied on such combinations by the order or manner in which embodiments are disclosed.

### DETAILED DESCRIPTION

### I. Definitions

Unless defined otherwise, all technical and scientific terms used herein have the same meanings as commonly understood by one of ordinary skill in the art to which this application belongs. All publications and patents specifically mentioned herein are incorporated by reference in their entirety for all purposes including describing and disclosing the chemicals, instruments, statistical analyses and methodologies which are reported in the publications which might be used in connection with the application. All references cited in this specification are to be taken as indicative of the level of skill in the art. Nothing herein is to be construed as an admission that the application is not entitled to antedate such disclosure by virtue of prior invention.

In the specification and in the claims, the terms “including” and “comprising” are open-ended terms and should be interpreted to mean “including, but not limited to. . . . ” These terms encompass the more restrictive terms “consisting essentially of” and “consisting of”

It must be noted that as used herein and in the appended claims, the singular forms “a,” “an,” and “the” include plural reference unless the context clearly dictates otherwise. Further, the terms “a” (or “an”), “one or more” and “at least one” can be used interchangeably herein. It is also to be noted that the terms “comprising,” “including,” “characterized by” and “having” can be used interchangeably. Further, any reactant concentrations described herein should be considered as being described on a weight to weight (w/w) basis, unless otherwise specified to the contrary (e.g., mole to mole, weight to volume (w/v), etc.).

As used herein, the term “glycoside” refers to a molecule in which a sugar (the “glycone” part or “glycone component” of the glycoside) is bonded to a non-sugar (the “aglycone” part or “aglycone component”) via a glycosidic bond.

The terms “steviol glycoside” and “SG” are used interchangeably with reference to a glycoside of steviol, a diterpene compound shown in Formula I, wherein one or more sugar residues are attached to the steviol compound of Formula I.

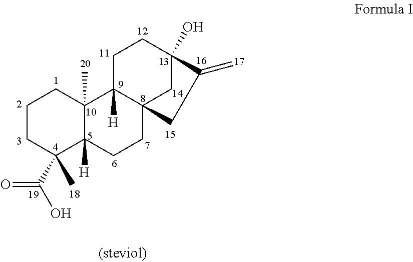

Steviol glycosides also include glycosides of isomers of steviol (isosteviol) as depicted in Formula II below, and derivatives of steviol, such as 12α-hydroxy-steviol and 15α-hydroxy-steviol.

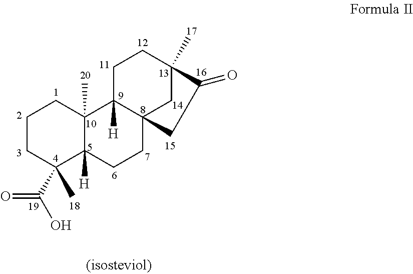

The terms “glycosidic bond” and “glycosidic linkage” refer to a type of chemical bond or linkage formed between the anomeric hydroxyl group of a saccharide or saccharide derivative (glycone) and the hydroxyl group of another saccharide or a non-saccharide organic compound (aglycone) such as an alcohol. The reducing end of the di- or polysaccharide lies towards the last anomeric carbon of the structure, whereas the terminal end lies in the opposite direction.

By way of example, a glycosidic bond in steviol and isosteviol involves the hydroxyl-group at the sugar carbon atom numbered 1 (so-called anomeric carbon atom) and a hydroxyl-group in the C19 carbonyl group of the steviol or isosteviol molecule building up a so-called O-glycoside or glycosidic ester. Additional glycosidic ester linkages can be formed at the hydroxyl group at C13 of steviol and at the carbonyl oxygen at C16 of isosteviol. Linkages at carbon atoms in the C1, C2, C3, C6, C7, C11, C12 and C15 positions of both steviol and isosteviol yield C-glycosides. In addition, C-glycosides can also be formed at the 2 methyl groups at C18 and C20 in both steviol and isosteviol.

The sugar part can be selected from any sugar with 3-7 carbon atoms, derived from either a dihydroxy-acetone (ketose) or a glycerin-aldehyde (aldose). The sugars can occur in open chain or in cyclic form, as D- or L- enantiomers and in α- or β-conformation.

Representative structures of possible sugar (Sug) conformations exemplified by glucose include D-glucopyranose and L-glucopyranose in which the position 1 is determinative of the α- or β-conformation:

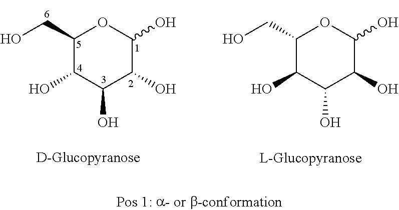 [SMILES: OC[C@H]1OC(O)[C@H](O)[C@@H](O)[C@@H]1O ; OC[C@@H]1OC(O)[C@@H](O)[C@H](O)[C@H]1O]

The steviol glycosides for use in the sweetener or flavor composition of the present application include one or more glycosylated steviol glycoside (GSG) compounds with structures depicted in Table A.

TABLE A
Possible positions of sugar (Sug) molecules
linked to steviol/isosteviol.

| | | Sugar | | |
|---|---|---|---|---|
| Aglycone | Position | (Sug) | Conjugation | Category |
| Steviol | 13 | D-α | D-Sug α (1-13) | O-glucoside |
| | | D-β | D-Sug β (1-13) | |
| | | L-α | L-Sug α (1-13) | |
| | | L-β | L-Sug β (1-13) | |
| Isosteviol | 16 | D-α/β | D-Sug α/β (1-16) | O-glucoside |
| | | L-α/β | L-Sug α/β (1-16) | (after reduction |
| | | | | of keto-group) |
| Steviol | 19 | D/L-α/β | D/L-Sug α/β (1-19) | Glucose-ester |
| Isosteviol | | | | |
| Steviol | 1 | D/L-α/β | D/L-Sug α/β (1-1) | C-glucoside |
| | 2 | | D/L-Sug α/β (1-2) | |
| | 3 | | D/L-Sug α/β (1-3) | |
| | (5) | | D/L-Sug α/β (1-5) | |
| | 6 | | D/L-Sug α/β (1-6) | |
| | 7 | | D/L-Sug α/β (1-7) | |
| | (9) | | D/L-Sug α/β (1-9) | |
| | 11 | | D/L-Sug α/β (1-11) | |
| | 12 | | D/L-Sug α/β (1-12) | |
| | 14 | | D/L-Sug α/β (1-14) | |
| | 15 | | D/L-Sug α/β (1-15) | |
| Steviol | (18) | D/L-α/β | D/L-Sug α/β (1-18) | Methylen- |
| | | | | glucoside |
| | (20) | | D/L-Sug α/β (1-20) | |
| Isosteviol | 1 | D/L-α/β | D/L-Sug α/β (1-1) | C-glucoside |
| | 2 | | D/L-Sug α/β (1-2) | |
| | 3 | | D/L-Sug α/β (1-3) | |
| | (5) | | D/L-Sug α/β (1-5) | |
| | 6 | | D/L-Sug α/β (1-6) | |
| | 7 | | D/L-Sug α/β (1-7) | |
| | (9) | | D/L-Sug α/β (1-9) | |
| | 11 | | D/L-Sug α/β (1-11) | |
| | 12 | | D/L-Sug α/β (1-12) | |
| | (13) | | D/L-Sug α/β (1-12) | |
| | 14 | | D/L-Sug α/β (1-14) | |
| | 15 | | D/L-Sug α/β (1-15) | |
| Isosteviol | (18) | D/L-α/β | D/L-Sug α/β (1-18) | Methylen- |
| | | | | glucoside |
| | (20) | | D/L-Sug α/β (1-20) | |

Stevia plants contain a variety of different SGs in varying percentages. The phrase “steviol glycoside” is recognized in the art and is intended to include the major and minor constituents of Stevia. These “SGs” include, for example, stevioside, steviolbioside (SB), rebaudioside A (RA), rebaudioside B (RB), rebaudioside C (RC), rebaudioside D (RD), rebaudioside E (RE), rebaudioside F (RF), rebaudioside M (RM), rebaudioside O (RO), rebaudioside H (RH), rebaudioside I (RI), rebaudioside L (RL), rebaudioside N (RN), rebaudioside K (RK), rebaudioside J (RJ), rebaudioside U, rubusoside, dulcoside A (DA) as well as those listed in Tables A and B or mixtures thereof.

As used herein, the terms “rebaudioside A,” “Reb A,” “Reb-A” and “RA” are equivalent terms referring to the same molecule. The same condition applies to all lettered rebaudiosides with the exception of rebaudioside U, which may be referred to as Reb-U or Reb U, but not RU, so as to not be confused with rubusoside which is also referred to as RU.

Based on the type of sugar (i.e. glucose, rhamnose/deoxyhexose, xylose/arabinose) SGs can be grouped into three families (1) SGs with glucose; (2) SG with glucose and one rhamnose or deoxyhexose moiety; and (3) SGs with glucose and one xylose or arabinose moiety. The steviol glycosides for use in the present application are not limited by source or origin. Steviol glycosides may be extracted from Stevia leaves, synthesized by enzymatic processes, synthesized by chemical syntheses, or produced by fermentation.

Specific examples of steviol glycosides include, but are not limited to, the compounds listed in Table B and isomers thereof. The steviol glycosides for use in the present application are not limited by source or origin. Steviol glycosides may be extracted from Stevia plants, Sweet tea leaves, synthesized by enzymatic processes or chemical syntheses, or produced by fermentation. In Table B, the phrase “# Added sugar moieties” means sugar moieties added to the steviol or isosteviol backbone. The “added sugar moieties” are native to the respective steviol glycoside and are NOT sugar groups added in an exogenous glycosylation reaction.

TABLE B
Exemplary steviol glycosides

| | | | # Added | | | | |
|---|---|---|---|---|---|---|---|
| | | | Rhamnose/ | # Added | | | |
| | | # Added | Deoxy- | Xylose/ | | | |
| | | Glucose | hexose | Arabinose | | | |
| | | moieties | moieties | moieties | | | |
| SG Name | MW | mw = 180 | mw = 164 | mw = 150 | R1 (C-19) | R2 (C-13) | Backbone |
| Related | 457 | — | | | | | |
| SvGn#l | | | | | | | |
| Steviol- | 479 | 1 | | | H- | Glcβ1- | Steviol |
| monoside | | | | | | | |
| Steviol- | 479 | 1 | 1 | | Glcβ1- | H- | |
| monoside A | | | | | | | |
| SG-4 | 611 | 1 | | 1 | H- | Xylβ(1-2)Glcβ1- | Steviol |
| Dulcoside | 625 | 1 | 1 | | H- | Rhaα(1-2)Glcβ1- | Steviol |
| A1 | | | | | | | |
| Iso-steviol- | 641 | 2 | | | H- | Glcβ(1-2)Glcβ1- | Isosteviol |
| bioside | | | | | | | |
| Reb-G1 | 641 | 2 | | | H- | Glcβ(1-3)Glcβ1- | Steviol |
| Rubusoside | 641 | 2 | | | Glcβ1- | Glcβ1- | Steviol |
| Steviolbioside | 641 | 2 | | | H- | Glcβ(1-2)Glcβ1- | Steviol |
| Related | 675 | — | | | | | |
| SvGn#3 | | | | | | | |
| Reb-F1 | 773 | 2 | | 1 | H- | Xylβ(1-2)[Glcβ(1- | Steviol |
| | | | | | | 3)]Glcβ1- | |
| Reb-R1 | 773 | 2 | | 1 | H- | Glcβ(1-2)[Glcβ(1- | Steviol |
| | | | | | | 3)]Xylβ1- | |
| Stevioside F | 773 | 2 | | 1 | Glcβ1- | Xylβ(1-2)Glcβ1- | Steviol |
| (SG-1) | | | | | | | |
| SG-Unk1 | 773 | 2 | | 1 | — | — | Steviol |
| Dulcoside A | 787 | 2 | 1 | | Glcβ1- | Rhaα(1-2)Glcβ1- | Steviol |
| Dulcoside B | 787 | 2 | 1 | | H- | Rhaα(1-2)[GlcP(1- | Steviol |
| (JECFA C) | | | | | | 3)]Glcβ1- | |
| SG-3 | 787 | 2 | 1 | | H- | 6-deoxyGlcβ(1- | Steviol |
| | | | | | | 2)[Glcβ(1-3)]Glcβ1- | |
| Stevioside D | 787 | 2 | 1 | | Glcβ1- | Glcβ(1-2)6- | |
| | | | | | | deoxyGlcβ1- | |
| Iso-Reb B | 803 | 3 | | | H- | Glcβ(1-2)[Glcβ(1- | Isosteviol |
| | | | | | | 3)]Glcβ1- | |
| Iso- | 803 | 3 | | | Glcβ1- | Glcβ(1-2)Glcβ1- | Isosteviol |
| Stevioside | | | | | | | |
| Reb B | 803 | 3 | | | H- | Glcβ(1-2)[Glcβ(1- | Steviol |
| | | | | | | 3)]Glcβ1- | |
| Reb G | 803 | 3 | | | Glcβ1- | Glcβ(1-3)Glcβ1- | Steviol |
| Reb-KA | 803 | 3 | | | Glcβ(1-2)Glcβ1- | Glcβ1- | Steviol |
| SG-13 | 803 | 3 | | | Glcβ1- | Glcβ(1-2)Glcβ1- | Isomeric |
| | | | | | | | steviol |
| | | | | | | | (12α- |
| | | | | | | | hydroxy) |
| Stevioside | 803 | 3 | | | Glcβ1- | Glcβ(1-2)Glcβ1- | Steviol |
| Stevioside B | 803 | 3 | | | Glcβ(1-3)Glcβ1- | Glcβ1- | Steviol |
| (SG-15) | | | | | | | |
| Reb F | 935 | 3 | | 1 | Glcβ1- | Xylβ(1-2)[Glcβ(1- | Steviol |
| | | | | | | 3)]Glcβ1- | |
| Reb R | 935 | 3 | | 1 | Glcβ1- | Glcβ(1-2)[Glcβ(1- | Steviol |
| | | | | | | 3)]Xylβ1- | |
| SG-Unk2 | 935 | 3 | | 1 | — | — | Steviol |
| SG-Unk3 | 935 | 3 | | 1 | — | — | Steviol |
| Reb F3 | 935 | 3 | | 1 | Xylβ(1-6)Glcβ1- | Glcβ(1-2)Glcβ1- | Steviol |
| (SG-11) | | | | | | | |
| Reb F2 | 935 | 3 | | 1 | Glcβ1- | Glcβ(1-2)[Xylβ(l- | Steviol |
| (SG-14) | | | | | | 3)]Glcβ1- | |
| Reb C | 949 | 3 | 1 | | Glcβ1- | Rhaα(1-2)[Glcβ(1- | Steviol |
| | | | | | | 3)]Glcβ1- | |
| Reb C2/Reb | 949 | 3 | 1 | | Rhaα(1-2)Glcβ1- | Glcβ(1-2)Glcβ1- | Steviol |
| S | | | | | | | |
| Stevioside E | 949 | 3 | 1 | | Glcβ1- | 6-DeoxyGlcβ(1- | Steviol |
| (SG-9) | | | | | | 2)[Glcβ(1-3)]Glcβ1- | |
| Stevioside | 949 | 3 | 1 | | 6-DeoxyGlcβ1- | Glcβ(1-2)[Glcβ(1- | |
| E2 | | | | | | 3)]Glcβ1- | |
| SG-10 | 949 | 3 | 1 | | Glcβ1- | Glcα(1-3)Glcβ(1- | Steviol |
| | | | | | | 2)[Glcβ(1-3])Glcβ1- | |
| Reb L1 | 949 | 3 | 1 | | H- | Glcβ(1-3)Rhaα(1- | Steviol |
| | | | | | | 2)[Glcβ(1-3)]Glcβ1- | |
| SG-2 | 949 | 3 | 1 | | Glcβ1- | 6-deoxyGlcβ(1- | Steviol |
| | | | | | | 2)[Glcβ(1-3)]Glcβ1- | |
| Reb A3 | 965 | 4 (1 Fru) | | | Glcβ1- | Glcβ(1-2)[Fruβ(1- | |
| (SG-8) | | | | | | 3)]Glcβ1- | |
| Iso-Reb A | 965 | 4 | | | Glcβ1- | Glcβ(1-2)[Glcβ(1- | Isosteviol |
| | | | | | | 3)]Glcβ1- | |
| Reb A | 965 | 4 | | | Glcβ1- | Glcβ(1-2)[Glcβ(1- | Steviol |
| | | | | | | 3)]Glcβ1- | |
| Reb A2 | 965 | 4 | | | Glcβ1- | Glcβ(1-6)[Glcβ(1- | Steviol |
| (SG-7) | | | | | | 2)]Glcβ1- | |
| Reb E | 965 | 4 | | | Glcβ(1-2)Glcβ1- | Glcβ(1-2)Glcβ1- | Steviol |
| Reb H1 | 965 | 4 | | | H- | Glcβ(1-6)Glcβ(1- | Steviol |
| | | | | | | 3)[Glcβ1-3)]Glcβ1- | |
| Related | 981 | — | | | | | |
| SvGn#2 | | | | | | | |
| Related | 981 | — | | | | | |
| SvGn#5 | | | | | | | |
| RebU2 | 1097 | 4 | | 1 | Xylβ(l-2)[Glcβ(1- | Glcβ(1-2)Glcβ1- | |
| | | | | | 3)]Glcβ1- | | |
| Reb T | 1097 | 4 | | 1 | Xylβ(1-2)Glcβ1- | Glcβ(1-2)[Glcβ(1- | |
| | | | | | | 3)]Glcβ1- | |
| Reb W | 1097 | 4 | | 1 | Glcβ(1-2)[Araβ(l- | Glcβ(1-2)Glcβ1- | |
| | | | | | 3)]Glcβ1- | | |
| Reb W2 | 1097 | 4 | | 1 | Araβ(1-2)Glcβ1- | Glcβ(1-2)[Glcβ(1- | |
| | | | | | | 3)]Glcβ1- | |
| Reb W3 | 1097 | 4 | | 1 | Araβ(1-6)Glcβ1- | Glcβ(1-2)[Glcβ(1- | |
| | | | | | | 3)]Glcβ1- | |
| Reb U | 1097 | 4 | | 1 | Araα(1-2)-Glcβ1- | Glcβ(1-2)[Glcβ(1- | Steviol |
| | | | | | | 3)]Glcβ1- | |
| SG-12 | 1111 | 4 | 1 | | Rhaα(1-2)Glcβ1- | Glcβ(1-2)[Glcβ(1- | Steviol |
| | | | | | | 3)]Glcβ1- | |
| Reb H | 1111 | 4 | 1 | | Glcβ1- | Glcβ(1-3)Rhaα(1- | Steviol |
| | | | | | | 2)[Glcβ(1-3)]Glcβ1- | |
| Reb J | 1111 | 4 | 1 | | Rhaα(1-2)Glcβ1- | Glcβ(1-2)[Glcβ(1- | Steviol |
| | | | | | | 3)]Glcβ1- | |
| Reb K | 1111 | 4 | 1 | | Glcβ(1-2)Glcβ1- | Rhaα(1-2)[Glcβ(1- | Steviol |
| | | | | | | 3)]Glcβ1- | |
| Reb K2 | 1111 | 4 | 1 | | Glcβ(1-6)Glcβ1- | Rhaα(1-2)[Glcβ(1- | Steviol |
| | | | | | | 3)]Glcβ1- | |
| SG-Unk4 | 1111 | 4 | 1 | | — | — | Steviol |
| SG-Unk5 | 1111 | 4 | 1 | | — | — | Steviol |
| Reb D | 1127 | 5 | | | Glcβ(1-2)Glcβ1- | Glcβ(1-2)[Glcβ(1- | Steviol |
| | | | | | | 3)]Glcβ1- | |
| Reb I | 1127 | 5 | | | Glcβ(1-3)Glcβ1- | Glcβ(1-2)[Glcβ(1- | Steviol |
| | | | | | | 3)]Glcβ1- | |
| Reb L | 1127 | 5 | | | Glcβ1- | Glcβ(1-6)Glcβ(1- | Steviol |
| | | | | | | 2)[Glcβ(1-3)]Glcβ1- | |
| Reb I3 | 1127 | 5 | | | [Glcβ(1-2)Glcβ(1- | Glcβ(1-2)Glcβ1- | |
| | | | | | 6)]Glcβ1- | | |
| SG-Unk6 | 1127 | 5 | | | — | — | Steviol |
| Reb Q | 1127 | 5 | | | Glcβ1- | Glcα(1-4)Glcβ(1- | Steviol |
| (SG-5) | | | | | | 2)[Glcβ(1-3)]Glcβ1- | |
| Reb I2 | 1127 | 5 | | | Glcβ1- | Glcα(1-3)Glcβ1- | Steviol |
| (SG-6) | | | | | | 2[Glcβ1-3)]Glcβ1- | |
| Reb Q2 | 1127 | 5 | | | Glcα(1-2)Glcα(1- | Glcβ(1-2)Glcβ1- | |
| | | | | | 4)Glcβ1- | | |
| Reb Q3 | 1127 | 5 | | | Glcβ1- | Glcα(1-4)Glcβ(1- | |
| | | | | | | 3)[Glcβ(1-2)]Glcβ1- | |
| Reb Tl | 1127 | 5 (1 Gal) | | | Galβ(1-2)Glcβ1- | Glcβ(1-2)[Glcβ(1- | |
| | | | | | | 3)]Glcβ1- | |
| Related | 1127 | — | | | | | |
| SvGn#4 | | | | | | | |
| Reb V2 | 1259 | 5 | | 1 | Xylβ(1-2)[Glcβ(1- | Glcβ(1-2)[Glcβ(1- | Steviol |
| | | | | | 3)]-Glcβ1- | 3)]Glcβ1- | |
| Reb V | 1259 | 5 | | 1 | Glcβ(1-2)[Glcβ(1- | Xylβ(l-2)[Glcβ(1- | |
| | | | | | 3)]Glcβ1- | 3)]-Glcβ1- | |
| Reb Y | 1259 | 5 | | 1 | Glcβ(1-2)[Araβ(l- | Glcβ(1-2)[Glcβ(1- | |
| | | | | | 3)]Glcβ1- | 3)]Glcβ1- | |
| Reb N | 1273 | 5 | 1 | | Rhaα(1-2)[Glcβ(1- | Glcβ(1-2)[Glcβ(1- | Steviol |
| | | | | | 3)]Glcβ1- | 3)]Glcβ1- | |
| Reb M | 1289 | 6 | | | Glcβ(1-2)[Glcβ(1- | Glcβ(1-2)[Glcβ(1- | Steviol |
| | | | | | 3)]Glcβ1- | 3)]Glcβ1- | |
| 15α-OH Reb | 1305 | 6 | | | Glcβ1-2(Glcβ1- | Glcβ(1-2)[Glcβ1- | 15α- |
| M | | | | | 3)Glcβ1- | 3]Glcβ1- | Hydroxy- |
| | | | | | | | steviol |
| Reb O | 1435 | 6 | 1 | | Glcβ(1-3)Rhaα(1- | Glcβ(1-2)[Glcβ(1- | Steviol |
| | | | | | 2)[Glcβ(1-3)]Glcβ1- | 3)]Glcβ1- | |
| Reb O2 | 1435 | 6 | 1 | | Glcβ(1-4)Rhaα(1- | Glcβ(1-2)[Glcβ(1- | |
| | | | | | 2)[Glcβ(1-3)]Glcβ1- | 3)]Glcβ1- | |

Legend:
SG-1 to 16: SGs without a specific name; SG-Unk1-6: SGs without detailed structural proof; Glc: Glucose; Rha: Rhamnose; Xyl: Xylose; Ara: Arabinose.

As used herein, the term “high molecular weight” in regard to a SG refers to a SG having a molecular weight of greater than 965 daltons. In some embodiments, high molecular weight SGs have a molecular weight of greater than or equal to 1097 daltons. In some embodiments, high molecular weight SGs have a molecular weight of greater than or equal to 1128 daltons. In some embodiments, high molecular weight SGs have a molecular weight of greater than or equal to 1273 daltons. In some embodiments, high molecular weight SGs have a molecular weight of greater than or equal to 1305 daltons.

As used herein, the term “low molecular weight” in regard to a SG refers to a SG having a molecular weight of less than or equal to 965 daltons. In some embodiments, low molecular weight SGs have a molecular weight of less than or equal to 787 daltons.

The terms “glycosylated steviol glycoside” and “GSG” refer to a molecule that (1) contains a SG backbone and one or more additional sugar residues, and (2) is artificially produced by glycosylation, conversion, fermentation or chemical synthesis, including isomers therefrom. For example, GRB contains a RB backbone and may be produced by glycosylation of RB or by alkaline hydrolysis of GRA.

The terms “non-Steviol glycoside”, “non-SG”, including glycosylated forms thereof, are used with reference to glycosides that are not present in Stevia plants or Stevia extracts. Exemplary non-Steviol glycosides or glycosylated forms thereof include, but are not limited to sweet tea extracts, swingle extracts, glycosylated sweet tea extracts, glycosylated swingle extracts, glycosylated sweet tea glycosides, glycosylated mogrosides, glycyrrhizin, glycosylated glycyrrhizin, rubusoside from sweet tea extract, glycosylated rubusoside from sweet tea extract, suaviosides, glycosylated suaviosides, mogrosides, glycosylated mogrosides and sucralose. The phrases “natural non-Steviol glycoside sweetener”, “natural non-SG sweetener”, including glycosylated forms thereof, are more broadly used with reference to non-Steviol glycosides, as well as other natural sweeteners that are not derived from Stevia plants or extracts, including but not limited to thaumatin, xylitol, monellin, brazzein, miraculin, curculin, pentadin, and mabinlin, and combination thereof. The phrase “non-Stevia sweetener” is more broadly used with reference to both natural non-SG sweeteners, as well as synthetic and semi-synthetic sweeteners as further described herein.

The terms “sweet tea extract” and “STE” refer to an extract prepared from the sweet tea (ST) plant. It should also be understood that an STE can be purified and/or separated into one or more sweet tea components (STCs).

The terms “sweet tea component” and “STC” refer to a component of an STE.

The terms “sweet tea glycoside” and “STG” refer to a glycoside derived from sweet tea plants or known to be present in sweet tea plants. Examples of STGs include, but are not limited to, rubusoside, suaviosides such as SU-A, SU-B, SU-C1, SU-D1, SU-D2, SU-E, SU-F, SU-G, SU-H, SU-I, and SU-J, steviolmonoside, rebaudioside A, 13-O-β-D-glucosyl-steviol, isomers of rebaudioside B, isomers of stevioside, panicloside IV and sugeroside. Some STGs, such as rubusoside, are also present in Stevia plants and are steviol glycosides (SGs).

The term “glycosylated sweet tea component (GSTC)” refers to a STC that has been subjected to an exogenously preformed glycosylation process. A GSTC may be artificially produced by enzymatic conversion, fermentation or chemical synthesis.

The term “glycosylated sweet tea glycoside (GSTG)” refers to a molecule that (1) contains a STG backbone and one or more additional sugar residues, and (2) is artificially produced by enzymatic conversion, fermentation or chemical synthesis.

The terms “glycosylated rubusoside” “glycosylated RU” and “GRU” are used interchangeably with reference molecules having a RU backbone with additional sugar units added in a glycosylation reaction under man-made conditions. GRUs include, but are not limited to, molecules having a RU backbone and 1-50 additional sugar units. As used herein, the term “sugar unit” refers to a monosaccharide unit. As used herein, the term “RUx” refers to a composition that comprises (x-5) wt % to (x+5) wt % of RU, and the term “GRUx” refers to a composition prepared by glycosylation of RUx. For example, RU20 refers to a composition that contains 15-25 wt % of RU and GRU20 refers to the glycosylation product of RU20.

As used herein, the term “enzymatically catalyzed method” refers to a method that is performed under the catalytic action of an enzyme, in particular of a glycosidase or a glycosyltransferase. The method can be performed in the presence of said glycosidase or glycosyltransferase in isolated (purified, enriched) or crude form.

The term “glycosyltransferase” (GT) refers to an enzyme that catalyzes the formation of a glycosidic linkage to form a glycoside. As used herein, the term “glycosyltransferase” also includes variants, mutants and enzymatically active portions of glycosyltransferases. Likewise, the term “glycosidase” also includes variants, mutants and enzymatically active portions of glycosidases.

The term “monosaccharide” as used herein refers to a single unit of a polyhydroxyaldehyde forming an intramolecular hemiacetal the structure of which including a six-membered ring of five carbon atoms and one oxygen atom. Monosaccharides may be present in different diasteromeric forms, such as a or f3 anomers, and D or L isomers. An “oligosaccharide” consists of short chains of covalently linked monosaccharide units. Oligosaccharides comprise disaccharides which include two monosaccharide units, as well as trisaccharides which include three monosaccharide units. A “polysaccharide” consists of long chains of covalently linked monosaccharide units.

The acronym “G-X” or “GX” refers to the glycosylation products of a composition “X”, i.e., product prepared from an enzymatically catalyzed glycosylation process with X and one or more sugar donors as the starting materials. For example, GSG refers to the glycosylation product of a steviol glycoside (SG).

As used herein, the term “Maillard reaction” refers to a non-enzymatic reaction of (1) one or more reducing and/or non-reducing sugars, and (2) one or more amine donors in the presence of heat, wherein the non-enzymatic reaction produces a Maillard reaction product and/or a flavor. Thus, this term is used unconventionally, since it accommodates the use of non-reducing sweetening agents as substrates, which were not heretofore thought to serve as substrates for the Maillard reaction.

The term “reaction mixture” refers to a composition comprising at least one amine donor and one sugar donor, wherein the reaction mixture is to be subjected to a Maillard reaction; a “reaction mixture” is not to be construed as the reaction contents after a Maillard reaction has been conducted, unless otherwise noted.

The term “sugar,” as used herein, refers to a sweet-tasting, soluble carbohydrate, typically used in consumer food and beverage products.

The term “sugar donor,” as used herein, refers to a sweet-tasting compound or substance from natural or synthetic sources, which can participate as a substrate in a Maillard reaction with an amine group-containing donor molecule.

The term “amine donor,” as used herein, refers to a compound or substance containing a free amino group, which can participate in a Maillard reaction.

The term “Maillard reaction product” or “MRP” refers to any compound produced by a Maillard reaction between an amine donor and a sugar donor in the form of a reducing sugar, non-reducing sugar, or both. Preferably, the sugar donor includes at least one carbonyl group. In certain embodiments, the MRP comprises a compound that provides a flavor (“Maillard flavor”), a color (“Maillard color”), or both.

As used hereinafter, the term “standard MRP” or “conventional MRP (C-MRP)” refers to an MRP formed from a reaction mixture that contains (1) at least one reducing sugar as sugar donor and (2) one or more free amino acids as amine donor.

The terms “Stevia-MRP” refers to the product of a Maillard reaction, wherein the starting material of the Maillard reaction comprises a Stevia extract (SE), a steviol glycoside (SG), a glycosylated Stevia extract (GSE), a glycosylated steviol glycoside (GSG) or combinations thereof. Accordingly, Stevia-MRPs include, but are not limited to, SE-MRPs, SG-MRPs, GSE-MRPs and GSG-MRPs.

The terms “MRP composition,” “Maillard product composition” and “Maillard flavor composition” are used interchangeably and refer to a composition comprising one or more MRPs, including SG-MRPs, SE-MRPs, GSG-MRPs, G-SE-MRPs, C-MRPs, etc.

The term “thaumatin”, as used herein, is used generically with reference to thaumatin I, II, III, a, b, c, etc. and/or combinations thereof.

The term “non-volatile”, as used herein, refers to a compound having a negligible vapor pressure at room temperature, and/or exhibits a vapor pressure of less than about 2 mm of mercury at 20° C.

The term “volatile”, as used herein, refers to a compound having a measurable vapor pressure at room temperature, and/or exhibits a vapor pressure of, or greater than, about 2 mm of mercury at 20° C.

As used herein, the term “sweetener” or “sweetening agent” generally refers to a consumable product, which produces a sweet taste when consumed alone. Examples of sweeteners include, but are not limited to, high-intensity sweeteners (HIS) and derivatives thereof, bulk sweeteners, and low sweetness products produced by synthesis, fermentation or enzymatic conversion methods.

As used herein the term “high-intensity sweetener” or “HIS” refers to any synthetic sweetener, semi-synthetic sweetener, sweetener found in nature and derivatives thereof, that is sweeter than sucrose. High-intensity sweeteners are typically many times (e.g., 20 times and more, 30 times and more, 50 times and more or 100 times sweeter than sucrose). For example, sucralose is about 600 times sweeter than sucrose, sodium cyclamate is about 30 times sweeter, Aspartame is about 160-200 times sweeter, and thaumatin is about 2000 times sweeter then sucrose (the sweetness depends on the tested concentration compared with sucrose). High-intensity sweeteners are commonly used as sugar substitutes or sugar alternatives because they are many times sweeter than sugar but contribute only a few to no calories when added to foods. High-intensity sweeteners may also be used to regulate the flavor of foods. High-intensity sweeteners generally will not raise blood sugar levels.

As used herein, the term “natural high-intensity sweetener (NHIS)” refers to HIS found in nature, typically in plants, which may be in raw, extracted, purified, refined, or any other form, singularly or in combination thereof. A NHIS characteristically has higher sweetness potency, but fewer calories than sucrose, fructose, or glucose. Examples of NHIS include, but are not limited to, Stevia extracts, sweet tea extracts, swingle extracts, licorice extracts, steviol glycosides, suaviosides, mogrosides, glycyrrhizin and salts thereof.

As used herein, the term “derivatives of NHIS,” includes but is not limited to, (1) glycosylation products of NHIS, (2) Maillard reaction products of NHIS, and (3) Maillard reaction products of the glycosylation products NHIS.

As used herein, the term “synthetic high intensity sweetener (SHIS)” or “artificial high intensity sweetener (AHIS)” refers to high intensity sweeteners that are not found in nature. Examples of SHIS include, but are not limited to, sucralose, aspartame, acesulfame-K (Ace-K), neotame, saccharin and aspartame, glycyrrhizic acid ammonium salt, sodium cyclamate, saccharin, advantame, neohesperidin dihydrochalcone (NHDC), salts and derivatives thereof.

As used herein, the term “bulk sweetener” refers to a sweetener, which typically adds both bulk and sweetness to a confectionery composition and includes, but is not limited to, sugars, sugar alcohols, sucrose, commonly referred to as “table sugar,” fructose, commonly referred to as “fruit sugar,” honey, unrefined sweeteners, syrups, such as agave syrup or agave nectar, maple syrup, corn syrup and high fructose corn syrup (or HFCS).

As used herein, the term “sweetener enhancer” refers to a compound (or composition) capable of enhancing or intensifying sensitivity of the sweet taste. The term “sweetener enhancer” is synonymous with a “sweetness enhancer,” “sweet taste potentiator,” “sweetness potentiator,” and/or “sweetness intensifier.” A sweetener enhancer enhances the sweet taste, flavor, mouth feel and/or the taste profile of a sweetener without giving a detectable sweet taste by the sweetener enhancer itself at an acceptable use concentration. In some embodiments, the sweetener enhancer provided herein may provide a sweet taste at a higher concentration by itself. Certain sweetener enhancers provided herein may also be used as sweetening agents.

Sweetener enhancers can be used as food additives or flavors to reduce the amounts of sweeteners in foods while maintaining the same level of sweetness. Sweetener enhancers work by interacting with sweet receptors on the tongue, helping the receptor to stay switched “on” once activated by the sweetener, so that the receptors respond to a lower concentration of sweetener. These ingredients could be used to reduce the calorie content of foods and beverages, as well as save money by using less sugar and/or less other sweeteners. Examples of sweetener enhancers include, but are not limited to, brazzein, miraculin, curculin, pentadin, mabinlin, thaumatin, and mixtures thereof.

In some cases, sweeteners can be used as sweetener enhancers or flavors when their dosages in food and beverage are low. In some cases, sweetener enhancers can be utilized as sweeteners where their dosages in foods and beverages are higher than dosages regulated by FEMA, EF SA or other related authorities.

As used herein, the phrase “low sweetness products produced by synthesis, fermentation or enzymatic conversion” refers to products that have less sweetness or similar sweetness than sucrose. Examples of low sweetness products produced by extraction, synthesis, fermentation or enzymatic conversion method include, but are not limited to, sorbitol, xylitol, mannitol, erythritol, trehalose, raffinose, cellobiose, tagatose, DOLCIA PRIMA™ allulose, inulin, N--[N-[3-(3-hydroxy-4-methoxyphenyl)propyl]-alpha-aspartyl]-L-phenylalanine 1-methyl ester, glycyrrhizin, and mixtures thereof.

For example, “sugar alcohols” or “polyols” are sweetening and bulking ingredients used in manufacturing of foods and beverages. As sugar substitutes, they supply fewer calories (about a half to one-third fewer calories) than sugar, are converted to glucose slowly, and are not characterized as causing spiked increases in blood glucose levels.

Sorbitol, xylitol, and lactitol are exemplary sugar alcohols (or polyols). These are generally less sweet than sucrose, but have similar bulk properties and can be used in a wide range of food and beverage products. In some case, their sweetness profile can be fine-tuned by being mixed together with high-intensity sweeteners.

The terms “flavor” and “flavor characteristic” are used interchangeably with reference to the combined sensory perception of one or more components of taste, aroma, and/or texture.

The terms “flavoring agent”, “flavoring” and “flavorant” are used interchangeably with reference to a product added to food or beverage products to impart, modify, regulate or enhance the flavor of food. As used herein, these terms do not include substances having an exclusively sweet, sour, or salty taste (e.g., sugar, vinegar, and table salt).

The term “natural flavoring substance” refers to a flavoring substance obtained by physical processes that may result in unavoidable but unintentional changes in the chemical structure of the components of the flavoring (e.g., distillation and solvent extraction), or by enzymatic or microbiological processes, from material of plant or animal origin.

The term “synthetic flavoring substance” refers to a flavoring substance formed by chemical synthesis.

The term “regulate,” as used herein, includes reducing, enhancing or modifying the sensory perception of a flavor characteristic without changing the nature or quality thereof.

The term “enhance,” as used herein, includes augmenting, intensifying, accentuating, magnifying, and potentiating the sensory perception of a flavor characteristics.

Unless otherwise specified, the terms “modify” or “modified” as used herein, includes altering, varying, suppressing, depressing, fortifying and supplementing the sensory perception of a flavor characteristic where the quality or duration of such characteristic was deficient.

The phrase “sensory profile” or “taste profile” is defined as the temporal profile of all basic tastes of a sweetener. The onset and decay of sweetness when a sweetener is consumed, as perceived by trained human tasters and measured in seconds from first contact with a taster's tongue (“onset”) to a cutoff point (typically 180 seconds after onset), is called the “temporal profile of sweetness.” A plurality of such human tasters is called a “sensory panel”. In addition to sweetness, sensory panels can also judge the temporal profile of the other “basic tastes”: bitterness, saltiness, sourness, piquance (aka spiciness), and umami (aka savoriness or meatiness). The onset and decay of bitterness when a sweetener is consumed, as perceived by trained human tasters and measured in seconds from first perceived taste to the last perceived aftertaste at the cutoff point, is called the “temporal profile of bitterness”.

The phrase “sucrose equivalence” or “SugarE” is the amount of non-sucrose sweetener required to provide the sweetness of a given percentage of sucrose in the same food, beverage, or solution. For instance, a non-diet soft drink typically contains 12 grams of sucrose per 100 ml of water, i.e., 12% sucrose. This means that to be commercially accepted, diet soft drinks must generally have the same sweetness as a 12% sucrose soft drink, i.e., a diet soft drink must have a 12% SugarE. Soft drink dispensing equipment assume an SugarE of 12%, since such equipment is set up for use with sucrose-based syrups.

As used herein, the term “off-taste” refers to an amount or degree of taste that is not characteristically or usually found in a beverage product or a consumable product of the present disclosure. For example, an off-taste is an undesirable taste of a sweetened consumable to consumers, such as, a bitter taste, a licorice-like taste, a metallic taste, an aversive taste, an astringent taste, a delayed sweetness onset, a lingering sweet aftertaste, and the like, etc.

The term “orally consumable product” refers to a composition that can be drunk, eaten, swallowed, inhaled, ingested or otherwise in contact with the mouth or nose of man or animal, including compositions which are taken into and subsequently ejected from the mouth or nose. Orally consumable products are safe for human or animal consumption when used in a generally acceptable range.

As used herein, the term “salt” refers to a chemical compound consisting of an ionic assembly of positively charged cations and negatively charged anions, which results in a compound with no net electric charge. A common example is table salt, with positively charged sodium ions and negatively charged chloride ions. The salt in this specification means all edible salts, including but not limited to NaCl based salts such as table salt, kosher salt, Himalayan salt, sea salt, Hawaiian salt, flake salt, pickling salt and iodionized salt, MgCl₂, CaCl₂, KCl, and trisodium citrate.

Unless otherwise noted, the term “ppm” (parts per million) means parts per million on a v/v or wt/wt basis.

### II. Sweetner and Flavor Compositions of the Present Application

One aspect of the present application relates to a sweetener or flavor composition that comprises (1) a flavor/taste modifying agent; and (2) a sweetener comprising a high intensity sweetner (HIS) and/or a sugar, wherein the flavor/taste modifying agent is present at an amount sufficient to enhance a flavor and/or taste profile of the sweetener.

In some embodiments, the flavor/taste modifying agent comprises a glycosylated natural high intensity sweetner (NHIS).

In some embodiments, the flavor/taste modifying agent comprises a Maillaid reaction product of a NHIS or glycosylated NHIS.

In some embodiments, the flavor/taste modifying agent comprises one or more components selected from the group consisting of Stevia extracts (SEs), glycosylated Stevia extracts (G-SEs), Stevia extract-MRPs (SE-MRPs), glycosylated Stevia extract-MRPs (G-SE-MRPs), Stevia glycosides (SGs), glycosylated Stevia glycosides (GSGs), Stevia glycoside-MRPs (SG-MRPs), glycosylated Stevia glycoside-MRPs (GSG-MRPs), sweet tea extracts (STEs), glycosylated sweet tea extracts (G-STEs), sweet tea extract-MRPs (ST-MRPs), glycosylated sweet tea extract-MRPs (G-ST-MRPs), sweet tea glycosides (STGs), glycosylated sweet tea glycosides (G-STGs), sweet tea glycoside-MRPs (STG-MRPs), glycosylated sweet tea glycoside-MRPs (G-STG-MRPs), monk fruit extracts (MFEs), glycosylated monk fruit extracts (G-MFEs), monk fruit glycosides (MFGs), glycosylated monk fruit glycosides (G-MFG), monk fruit glycoside-MRPs (MFG-MRPs) and glycosylated monk fruit glycoside-MRPs (G-MFG-MRPs).

In some embodiments, the flavor/taste modifying agent comprises a SE or a GSE. In some embodiments, the flavor/taste modifying agent comprises a sweet tea extract or a glycosylated sweet tea extract. In some embodiments, the flavor/taste modifying agent comprises a rubusoside (RU) and/or a glycosylated rubusoside (GRU). In some embodiments, the flavor/taste modifying agent comprises RU20, GRU20, RU40, GRU40, RU90 or GRU90. In some embodiments, the flavor/taste modifying agent comprises a mogroside or a glycosylated mogroside.

In some embodiments, the flavor/taste modifying agent comprises one or more non-volatile substances selected from the group consisting of quercetin-pentoside, kaempferol-xylosyl-glucoside, quercetin-diglucoside-rhamnoside, and quercetin-dirhamnoside.

In some embodiments, the flavor/taste modifying agent comprises of the present application further comprises one or more flavonoid, isoflavone, saponin glycosides, phenol glycosides, cynophore glycosides, anthraquinone glycosides, cardiac glycosides, bitter glycosides, coumarin glycosides, or sulfur glycosides.

Exemplary flavonoids include, but are not limited to, anthocyanidins; anthoxanthins, including flavones, such as luteolin, apigenin, tangeritin; and flavonols, such as quercetin, kaempferol, myricetin, fisetin, galangin, isorhamnetin, pachypodol, rhamnazin, pyranoflavonols, furanoflavonols; flavanones, such as hesperetin, naringenin, eriodictyol, and homoeriodictyol; flavanonols, such as taxifolin (or dihydroquercetin) and dihydrokaempferol; and flavans, including flavanols, such as catechin, gallocatechin, catechin 3-gallate, gallocatechin 3-gallate, epicatechin, epigallocatechin (EGC), epicatechin 3-gallate, epigallocatechin 3-gallate, theaflavin, theaflavin-3′-gallate, theaflavin-3,3′-digallate, thearubigin, and proanthocyanidins, which are dimers, trimers, oligomers, or polymers of the flavanols, and glycosides thereof.

Exemplary isoflavonoids include isoflavones, such as genistein, daidzein, glycitein; isoflavanes, isoflavandiols, isoflavenes, coumestans, pterocarpans, and glycosides thereof.

In some embodiments, the flavor/taste modifying agent comprises of the present application further comprises one or more polyphenols. Exemplary polyphenols include gallic acid, ellagic acid, quercetin, isoquercitrin, rutin, citrus flavonoids, catechins, proanthocyanidins, procyanidins, anthocyanins, reservatrol, isoflavones, curcumin, hesperidin, naringin, and chlorogenic acid, and glycosides thereof.

In some embodiments, the flavor/taste modifying agent further comprises one or more tannins. Exemplary tannins include gallic acid esters, ellagic acid esters, ellagitannins, including rubusuaviins A, B, C, D, -E, and -F; punicalagins, such as pedunculagin and 1(β)-O-galloyl pedunculagin; strictinin, sanguiin H-5, sanguiin H-6, 1-desgalloyl sanguiin H-6. lambertianin A, castalagins, vescalagins, castalins, casuarictins, grandimins, punicalins, roburin A, tellimagrandin II, terflavin B; gallotannins, including digalloyl glucose and 1,3,6-trigalloyl glucose; flavan-3-ols, oligostilbenoids, proanthocyanidins, polyflavonoid tannins, catechol-type tannins, pyrocatecollic type tannins, flavolans, and glycosides thereof.

In some embodiments, the flavor/taste modifying agent further comprises one or more carotenoids. Exemplary carotenoids include carotenes, including α-, β-, γ-, δ-, and ε-carotenes, lycopene, neurosporene, phytofluene, phytoene; and xanthophylls, including canthaxanthin, cryptoxanthin, zeaxanthin, astaxanthin, lutein, rubixanthin, and glycosides thereof.

In some embodiments, the flavor/taste modifying agent further comprises one or more diterpenes, diterpenoids, triterpenes and/or triterpenoids. Exemplary diterpenes and diterpenoids include steviol, ent-16α,17-dihydroxy-kaurane-19-oic acid, ent-13-hydroxy-kaurane-16-en-19-oic acid, ent-16β,17-dihydroxy-kaurane-3-one, ent-16α,17-dihydroxy-kaurane-19-oic acid, ent-16α,17-dihydroxy-kaurane-3-one, ent-kaurane-3α,16β,17-3-triol, ent-13,17-dihydroxy-kaurane-15-en-19-oic acid, and glycosides thereof. Exemplary triterpenes and triterpenoids, include oleanolic acid, ursolic acid, saponin, and glycoside thereof.

In some embodiments, the HIS is a natural HIS (NHIS) selected from the group consisting of Stevia extracts (SEs), Stevia glycosides (SGs), sweet tea extracts (STEs), sweet tea glycosides (STGs), monk fruit extracts (MFEs), monk fruit glycosides (MFGs), licorice extracts, glycyrrhizin and salts thereof.

In some embodiments, the HIS is a synthetic HIS (SHIS) selected from the group consisting of sucralose, aspartame, acesulfame-K (Ace-K), neotame, saccharin, aspartame, glycyrrhizin, cyclamate, advantame, monellin, brazzein, miraculin, curculin, pentadin and mabinlin, neohesperidin dihydrochalcone (NHDC), N--[N-[3-(3-hydroxy-4-methoxyphenyl) propyl]-alpha-aspartyl]-L-phenylalanine 1-methyl ester (ANS9801), and salts thereof.

In some embodiments, the sweetener or flavor composition of the present application comprises a sugar selected from the group consisting of sucrose, fructose, maltose, dextrose, glucose, mannitol, arabinose, galactose, mannose, rhamnose, and xylose.

In some embodiments, the weight ratio (w/w) of the flavor/taste modifying agent to the sweetener ranges from about 99:1 to 1:2, 99:1 to 1:1, 99:1 to 2:1, 99:1 to 5:1, 99:1 to 10:1, 99:1 to 20:1, 99:1 to 40:1, 99:1 to 60:1, 99:1 to 80:1, 80:1 to 1:2, 80:1 to 1:1, 80:1 to 2:1, 80:1 to 5:1, 80:1 to 10:1,80:1 to 20:1, 80:1 to 40:1, 80:1 to 60:1, 60:1 to 1:2, 60:1 to 1:1, 60:1 to 2:1, 60:1 to 5:1, 60:1 to 10:1, 60:1 to 20:1, 60:1 to 40:1, 40:1 to 1:2, 40:1 to 1:1, 40:1 to 2:1, 40:1 to 5:1, 40:1 to 10:1, 40:1 to 20:1, 20:1 to 1:2, 20:1 to 1:1, 20:1 to 2:1, 20:1 to 5:1, 20:1 to 10:1, 10:1 to 1:2, 20:1 to 1:1, 20:1 to 2:1, 20:1 to 5:1, 20:1 to 10:1, 10:1 to 1:1, 10:1 to 2:1, 10:1 to 5:1, 5:1 to 1:2, 5:1 to 1:1, 5:1 to 2:1, 2:1 to 1:2, 2:1 to 1:1, or 1:1 to 1:2.

In some embodiments, the weight ratio (w/w) of the flavor/taste modifying agent to the sweetener ranges from about 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, 1:15, 1:20, 1:25, 1:30, 1:40, 1:50, 1:60, 1:80, 1:100, or any ratio derived from any two of the aforementioned integers.

In some embodiments, the sweetener or flavor composition of the present application comprises the flavor/taste modifying agent in an amount ranging from 1 ppm to 15,000 ppm, from 1 ppm to 10,000 ppm, from 1 ppm to 5,000 ppm, from 1 ppm to 2,000 ppm, from 1 ppm to 1,000 ppm from 10 ppm to 10,000 ppm, from 10 ppm to 5,000 ppm, from 10 ppm to 2,000, ppm from 10 ppm to 1,000 ppm, from 50 ppm to 900 ppm, from 50 ppm to 600 ppm, from 50 ppm to 500 ppm, from 50 ppm to 400 ppm, from 50 ppm to 300 ppm, from 50 ppm to 200 ppm, from 100 ppm to 600 ppm, from 100 ppm to 500 ppm, from 100 ppm to 400 ppm, from 100 ppm to 300 ppm, from 100 ppm to 200 ppm, from 125 ppm to 600 ppm, from 125 ppm to 500 ppm, from 125 ppm to 400 ppm, from 125 ppm to 300 ppm, from 125 ppm to 200 ppm, from 150 ppm to 600 ppm, from 150 ppm to 500 ppm, from 150 ppm to 500 ppm, from 150 ppm to 400 ppm, from 150 ppm to 300 ppm, from 150 ppm to 200 ppm, from 200 ppm to 600 ppm, from 200 ppm to 500 ppm, from 200 ppm to 400 ppm, from 200 ppm to 300 ppm, from 300 ppm to 600 ppm, from 300 ppm to 500 ppm, from 300 ppm to 400 ppm, from 400 ppm to 600 ppm, from 500 ppm to 600 ppm, from 20 ppm to 200 ppm, from 20 ppm to 180 ppm, from 20 ppm to 160 ppm, from 20 ppm to 140 ppm, from 20 ppm to 120 ppm, from 20 ppm to 100 ppm, from 20 ppm to 80 ppm, from 20 ppm to 60 ppm, from 20 ppm to 40 ppm, from 40 ppm to 150 ppm, from 40 ppm to 130 ppm, from 40 ppm to 100 ppm, from 40 ppm to 90 ppm, from 40 ppm to 70 ppm, from 40 ppm to 50 ppm, from 20 ppm to 100 ppm, from 40 ppm to 100 ppm, from 50 ppm to 100 ppm, from 60 ppm to 100 ppm, from 80 ppm to 100 ppm, from 5 ppm to 100 ppm, from 5 ppm to 95 ppm, from 5 ppm to 90 ppm, from 5 ppm to 85 ppm, from 5 ppm to 80 ppm, from 5 ppm to 75 ppm, from 5 ppm to 70 ppm, from 5 ppm to 65 ppm, from 5 ppm to 60 ppm, from 5 ppm to 55 ppm, from 5 ppm to 50 ppm, from 5 ppm to 45 ppm, from 5 ppm to 40 ppm, from 5 ppm to 35 ppm, from 5 ppm to 30 ppm, from 5 ppm to 25 ppm, from 5 ppm to 20 ppm, from 5 ppm to 15 ppm, from 5 ppm to 10 ppm.

In some embodiments, the sweetener or flavor composition of the present application comprises the sweetener, in an individual or total amount of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, 95-99 wt % of the composition.

In some embodiments, the sweetener or flavor composition of the present application comprises the sweetener in an individual or total amount of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt % of the composition.

The inventor found that brain response of the flavor/taste modifying agent of the present application could activate the similar brain areas as sugar. In addition, the composition of the present application could activate brain areas of middle fontal gyms (MFG), inferior parietal lobule, and/or precentral gyms. These areas are responsible for attention, emotion, memory, decision-making etc., therefore, it is important that the flavor/taste modifying agent of the present application have such unique function to improve the taste profile of high intensity sweeteners and/or sugar. Also obviously, the flavor/taste modifying agent of the present application activate postcentral (somatosensory) strongly to enhance the mouthfullness of high intensity sweeteners or sugar. Adding the flavor/taste modifying agent of the present application to sugar or a consumable product could enhance memory by additionally activating “hippocampus edge”, and enhance sugar's pleasureness by additionally activating “insula”.

When adding the flavor/taste modifying agent of the present application to sucralose, many interesting areas such as intensified postcentral (somatosensory), Rolandic operculum (gustatory), insula (pleasureness), superior temporal (multi-sensory integration) are activated, it showed that the flavor/taste modifying agent of the present application could filled the gap of taste profile for sucralose to mimic sugar.

The inventor found that the flavor/taste modifying agent of the present application impart the decision-making process. For example, the inventor found that adding the flavor/taste modifying agent of the present application to high intensity sweeteners such as sucralose helps brains to align the sucralose decision process to sucrose; reduce the ambiguity of the decision for sucralose; overriding the defect analysis for sucralose.

The inventor found that rewarding and second olfactory brain regions would be activated via retronasal cavity by taste stimuli. Lower sweetness of sweeteners in food and beverage could not activate sufficient rewarding brain area and also olfactory cortex via retronasal cavity. Adding the flavor/taste modifying agent of the present application could improve taste sensation, somatosensation and olfactory sensation in retronasal cavity, thus improve the pleasantness and likeness of food and beverage.

The inventor found retronasal cavity plays an important role for taste and flavor recognition. Unlike conventional knowledge that neuro-information of taste stimuli generated by tongue mainly in mouth, the taste stimuli could activate brain area of rewarding system and partially olfactory sensation via retronasal cavity first to form a primary frame-image of tasting stimuli, thus gives a quick indication to brain whether the tasting substances match the expectation by brain from experience and memory. Then brain gives instruction to sensory system how to taste and sense the tasting substances, the final image of taste perception is result of minimizing the gap error between expectation and reality of taste stimuli. Quick recognition of edibility and pleasantness of foods are important for humans' evolution. The sensation of food and beverage follows the similar principles of grouping by Gestalt laws, such as figure-ground, proximity, and similarity, closure, common fate, familiarity, continuity and perception constancy etc.

Taste substances could be sensed by both oral-cavity-only and retronasal-cavity-only. Brain regions of olfaction and rewarding system could be activated by retronasal-cavity-only signals, not oral-cavity-only signals. The retronasal-cavity-only signals is faster to be perceived by brain than oral-cavity-only signals, thus it generates the framework of overall flavor perception and initiates the top-down recognition mechanism, the later coming oral-cavity-only signals would complete the perception of actual flavor. The inventor hypothesized that taste modulators prepared by this specification could block and mask the off-taste and off-note. When adding the ingredients prepared by current specification into food and beverage products for tasting, the retronasal-cavity-only signals could form a pleasant and authentic framework of taste profile, thus the brain would not activate the defect searching mechanism and creates a pleasant perception of food and beverage.

Because taste could be sensed by both oral-cavity-only and retronasal-cavity-only. The inventor proposed that brain response region should not be classified by Gustatory, Olfactory and Somatosensory regions, but should be classified by Oral-Cavity-Only, Retronasal-Cavity-Only, Orthonasal-Cavity-Only and Touch-Only It is better to use the source of stimulated neurons instead of source of stimuli to classify the brain response regions.

In some embodiments, the sweetener or flavor composition of the present present application comprises one or more retronasal non-volatile substances, wherein the amount of retronasal non-volatile substances is sufficient to have impact on overall intensity of flavor of the food or beverage, wherein clip-nose on and off test shows flavor intensity is increased by 0.5%, 1%, 2%, or 10% or more.

### A. Glycosylated NHIS

In some embodiments, the flavor/taste modifying agent of the present application includes one or more glycosylated NHIS formed from a reaction mixture containing a NHIS. As used herein, a glycosylated NHIS may also be referred to as a derivative of NHIS.

Generally, the glycosylated NHIS of the present application is prepared as follows: (i) dissolving a sugar-donor material in water to form a liquefied sugar-donor material; (ii) adding a starting NHIS composition to liquefied sugar-donor material to obtain a mixture; and (iii) adding an effective amount of an enzyme to the mixture to form a reaction mixture, wherein the enzyme catalyzes the transfer of sugar moieties from the sugar-donor material to the SG in the starting NHIS composition; and (iv) incubating the reaction mixture at a desired temperature for a desired length of reaction time to glycosylate the NHIS in the starting NHIS composition with sugar moieties present in the sugar-donor molecule.

After achieving a desired ratio of glycosylated NHIS and residual NHIS (i.e., unreacted NHIS) contents, the reaction mixture can be heated to a sufficient temperature for a sufficient amount of time to inactivate the enzyme. In some embodiments, the enzyme is removed by filtration in lieu of inactivation. In other embodiments, the enzyme is removed by filtration following inactivation. In some embodiments the sugar is glucose and the sugar donor is a glucose donor. In some embodiments, the glucose donor is starch. In some embodiments the resulting solution comprising glycosylated NHIS, residual NHIS and dextrin is decolorized.

In some embodiments the resulting solution of glycosylated NHIS, including residual NHIS and dextrin is dried. In some embodiments, the drying is by spray drying. In some embodiments, step (i) comprises the substeps of (a) mixing a glucose-donor material with a desired amount of water to form a suspension, (b) adding a desired amount of enzyme to the suspension and (c) incubate the suspension at a desired temperature for a desired time to form liquefied glucose-donor material. Starch can be a suitable substitute for dextrin(s) and/or dextrin(s) can be obtained by the hydrolysis of starch. The unreacted NHIS, with or without dextrins, can be separated from glycosylated NHIS if necessary.

In some embodiments, the composition of the present application comprises one or more glycosylated NHIS in an amount of 0.001-99 wt %, 0.001-75 wt %, 0.001-50 wt %, 0.001-25 wt %, 0.001-10 wt %, 0.001-5 wt %, 0.001-2 wt %, 0.001-1 wt %, 0.001-0.1 wt %, 0.001-0.01 wt %, 0.01-99 wt %, 0.01-75 wt %, 0.01-50 wt %, 0.01-25 wt %., 0.01-10 wt %, 0.01-5 wt %, 0.01-2 wt %, 0.01-1 wt %, 0.1-99 wt %, 0.1-75 wt %, 0.1 wt-50 wt %, 0.1-25 wt %, 0.1-10 wt %, 0.1-5 wt %, 0.1-2 wt %, 0.1-1 wt %, 0.1-0.5 wt %, 1-99 wt %, 1-75 wt %, 1-50 wt %, 1-25 wt %, 1-10 wt %, 1-5 wt %, 5-99 wt %, 5-75 wt %, 5-50 wt %, 5-25 wt %, 5-10 wt %, 10-99 wt %, 10-75 wt %, 10-50 wt %, 10-25 wt %, 10-15 wt %, 20-99 wt %, 20-75 wt %, 20-50 wt %, 30-99 wt %, 30-75 wt %, 30-50 wt %, 40-99 wt %, 40-75 wt %, 40-50 wt %, 50-99 wt %, 50-75 wt %, 60-99 wt %, 60-75 wt %, 70-99 wt %, 70-75 wt %, 80-99 wt %, 80-90 wt %, 90-99 wt % of the composition.

In some embodiments, the glycosylated NHIS is a mono-glycosylated, di-glycosylated, tri-glycosylated, tetra-glycosylated, or penta-glycosylated glycosylation product of a NHIS.

### (i) Glycosylation Reaction

The glycosylated NHIS of the present application can be prepared by an enzyme-mediated or non-enzyme-mediated process in which one or more sugar residues are transferred from one or more sugar donors to a substrate to produce a glycosylated NHIS product, such as a GSG product. This process is referred to hereinafter as a glycosylation reaction.

In some embodiments, the glycosylated NHIS product is a GSG product. The GSGs of the present application can also be prepared by a enzyme-mediated or nonenzyme-mediated process in which one or more sugar residues are removed from a GSG substrate to produce a new GSG product. This process is referred to hereinafter as a conversion reaction. The substrate of a conversion reaction can be, for example, a GRA, GRB, GRC, GRD, GRE, GRF, GRI, GRM, GRN, GRO, glycosylated steviolmonoside, glycosylated steviolbioside, glycosylated dulcoside, glycosylated rubusoside or glycosylated stevioside.

In some embodiments, the glycosylated NHIS products described in the present application, such as the GSG products, are formed by an exogenous glycosylation reaction in the present of a glycosyltransferase.

As used herein, a “glycosyltransferase” refers to an enzyme that catalyzes the formation of a glycosidic linkage to form a glycoside. A glycoside is any molecule in which a sugar group is bonded through its anomeric carbon to another group via a glycosidic bond. Glycosides can be linked by an O- (an O-glycoside), N- (a glycosylamine), S- (a thioglycoside), or C- (a C-glycoside) glycosidic bond. The sugar group is known as the glycone and the non-sugar group is known as the aglycone. The glycone can be part of a single sugar group (monosaccharide) or several sugar groups (oligosaccharide). A glycosyltransferase according to the present application further embraces “glycosyltransferase variants” engineered for enhanced activities.

Glycosyltransferases utilize “activated” sugar phosphates as glycosyl donors, and catalyze glycosyl group transfer to an acceptor molecule comprising a nucleophilic group, usually an alcohol. A retaining glycosyltransferases is one which transfers a sugar residue with the retention of anomeric configuration. Retaining glycosyltransferase enzymes retain the stereochemistry of the donor glycosidic linkage after transfer to an acceptor molecule. An inverting glycosyltransferase, on the other hand, is one which transfers a sugar residue with the inversion of anomeric configuration. Glycosyltransferases are classified based on amino acid sequence similarities. Glycosyltransferases are classified by the Nomenclature Committee of the International Union of Biochemistry and Molecular Biology (NC-IUBMB) in the enzyme class of EC 2.4.1 on the basis of the reaction catalyzed and the specificity.

Glycosyltransferases can utilize a range of donor substrates. Based on the type of donor sugar transferred, these enzymes are grouped into families based on sequence similarities. Exemplary glycosyltransferases include glucanotransferases, N-acetylglucosaminyltransferases, N-acetylgalactosaminyltransferases, fucosyltransferases, mannosyltransferases, galactosyltransferases, sialyltransferases, galactosyltransferases, fucosyltransferase, Leloir glycosyltransferases, non-Leloir glycosyltransferases, and other glycosyltransferases in the enzyme class of EC 2.4.1. The Carbohydrate-Active Enzymes database (CAZy) provides a continuously updated list of the glycosyltransferase families.

In some embodiments, the glycosylated NHIS products are formed from a reaction mixture comprising an exogenous glycosyltransferase classified as an EC 2.4.1 enzyme, including but not limited to members selected from the group consisting of cyclomaltodextrin glucanotransferase (CGTase; EC 2.4.1.19), amylosucrase (EC 2.4.1.4), dextransucrase (EC 2.4.1.5), amylomaltase, sucrose: sucrose fructosyltransferase (EC 2.4.1.99), 4-α-glucanotransferase (EC 2.4.1.25), lactose synthase (EC 2.4.1.22), sucrose-1,6-α-glucan 3(6)-α-glucosyltransferase, maltose synthase (EC 2.4.1.139), alternasucrase (EC 2.4.1.140), including variants thereof.

Cyclomaltodextrin glucanotransferase, also known as CGTase, is an enzyme assigned with enzyme classification number EC 2.4.1.19, which is capable of catalyzing the hydrolysis and formation of (1→4)-α-D-glucosidic bonds, and in particular the formation of cyclic maltodextrins from polysaccharides as well as the disproportionation of linear oligosaccharides.

Dextransucrase is an enzyme assigned with enzyme classification number EC 2.4.1.5, and is also known as sucrose 6-glucosyltransferase, SGE, CEP, sucrose-1,6-α-glucan glucosyltransferase or sucrose: 1,6-α-D-glucan 6-α-D-glucosyltransferase. Dextransucrases are capable of catalyzing the reaction: sucrose+[(1→6)-α-D-glucosyl]n=D-fructose+[(1→6)-α-D-glucosyl]n+1. In addition, a glucosyltransferase (DsrE) from Leuconostoc mesenteroides, NRRL B-1299 has a second catalytic domain (“CD2”) capable of adding alpha-1,2 branching to dextrans (U.S. Pat. Nos. 7,439,049 and 5,141,858; U.S. Patent Appl. Publ. No. 2009-0123448; Bozonnet et al., J. Bacteria 184: 5753-5761, 2002).

Glycosyltransferases and other glycosylating enzymes for use in the present application may be derived from any source and may be used in a purified form, in an enriched concentrate or as a crude enzyme preparation.

In some embodiments, the glycosylation reaction is carried out by glycosylating an aglycone or glycoside substrate using e.g., a nucleotide sugar donor (e.g., sugar mono- or diphosphonucleotide) or “Leloir donor” in conjunction with a “Leloir glycosyltransferase” (after Nobel prize winner, Luis Leloir) that catalyzes the transfer of a monosaccharide unit from the nucleotide-sugar (“glycosyl donor’) to a “glycosyl acceptor”, typically a hydroxyl group in an aglycone or glycoside substrate.

Accordingly, in some embodiments the glycosylated NHIS products of the present application are formed from a reaction mixture comprising a nucleotide sugar.

In certain embodiments, the glycosylation reactions may involve the use of a specific Leloir glycosyltransferase in conjunction with a wide range of sugar nucleotides donors, including e.g., UDP-glucose, GDP-glucose, ADP-glucose, CDP-glucose, TDP-glucose or IDT-glucose in combination with a glucose-dependent glycosyltransferase (GDP-glycosyltransferases; GGTs), ADP-glucose-dependent glycosyltransferase (ADP-glycosyltransferases; AGTs), CDP-glucose-dependent glycosyltransferase (CDP-glycosyltransferases; CGTs), TDP-glucose-dependent glycosyltransferase (TDP-glycosyltransferases; TGTs) or IDP-glucose-dependent glycosyltransferase (IDP-glycosyltransferases; IGTs), respectively.

In particular embodiments, the exogenous glycosylation reaction is carried out using an exogenous Leloir-type UDP-glycosyltransferase enzyme of the classification EC 2.4.1.17, which catalyzes the transfer of glucose from UDP-α-D-glucuronate (also known as UDP-glucose) to an acceptor, releasing UDP and forming acceptor β-D-glucuronoside. In some embodiments, the glycosyltransferases include, but are not limited to, enzymes classified in the GT1 family. In certain preferred embodiment, the glycosylation reaction is catalyzed by an exogenous UDP-glucose-dependent glycosyltransferase. In some embodiments, the glycosylation reaction is catalyzed by a glycosyltransferase capable of transferring a non-glucose monosaccharide, such as fructose, galactose, ribose, arabinose, xylose, mannose, psicose, fucose and rhamnose, and derivative thereof, to the recipient.

U. S . Patent No. 9,567,619 describes several UDP-dependent glycosyltransferases that can be used to transfer monosaccharides to rubusoside, including UGT76G1 UDP glycosyltransferase, HV1 UDP-glycosyltransferase, and EUGT11, a UDP glycosyltransferase-sucrose synthase fusion enzyme. The EUGT11 fusion enzyme contains a uridine diphospho glycosyltransferase domain coupled to a sucrose synthase domain and can exhibit 1,2-β glycosidic linkage and 1,6-β glycosidic linkage enzymatic activities, as well as sucrose synthase activity. Of the foregoing enzymes, UGT76G1 UDP glycosyltransferase contains a 1,3-O-glucose glycosylation activity which can transfer a second glucose moiety to the C-3′ of 13-O-glucose of rubusoside to produce rebaudioside G (“Reb G”); HV1 UDP-glycosyltransferase contains a 1,2-O-glucose glycosylation activity which can transfer a second glucoside moiety to the C-2′ of 19-O-glucose of rubusoside to produce rebaudioside KA (“Reb KA”); and the EUGT11 fusion enzyme contains a 1,2-O-glucose glycosylation activity which transfers a second glucose moiety to the C-2′ of 19-O-glucose of rubusoside to produce rebaudioside KA or transfer a second glucose moiety to the C-2′ of 13-O-glucose of rubusoside to produce stevioside. In addition, HV1 and EUGT11 can transfer a second sugar moiety to the C-2′ of 19-O-glucose of rebaudioside G to produce rebaudioside V (“Reb V”) and can additionally transfer a second glucose moiety to the C-2′ of 13-O-glucose of rebaudioside KA to produce rebaudioside E (“Reb E”). Furthermore, when used singly or in combination, these enzymes can be used to generate a variety of steviol glycosides known to be present in Stevia rebaudiana, including rebaudioside D (“Reb D”) and rebaudioside M (“Reb M”).

In some embodiments, monosaccharides that can be transferred to a saccharide or monosaccharide acceptor include, but are not limited to glucose, fructose, galactose, ribose, arabinose, xylose, mannose, psicose, fucose and rhamnose, and derivative thereof, as well as acidic sugars, such as sialic acid, glucuronic acid and galacturonic acid.

In some embodiments, glycosylation of SGs is driven by an exogenous glycosyl hydrolase (GH). GHs normally cleave a glycosidic bond. However, they can be used to form glycosides by selecting conditions that favor synthesis via reverse hydrolysis. Reverse hydrolysis is frequently applied e.g., in the synthesis of aliphatic alkylmonoglucosides.

Glycosyl hydrolases have a wide range of donor substrates employing usually monosaccharides, oligosaccharides or/and engineered substrates (i.e., substrates carrying various functional groups). They often display activity towards a large variety of carbohydrate and non-carbohydrate acceptors. Glycosidases usually catalyze the hydrolysis of glycosidic linkages with either retention or inversion of stereochemical configuration in the product.

In some embodiments, the GRGs of the present application are formed from a reaction mixture comprising an exogenous glycosyl hydrolase, classified as an EC 3.2.1 enzyme, including but not limited to alpha-glucosidase, beta-glucosidase and beta-fructofuranosidase.

Exemplary glycosyl hydrolases for use in the present application include, but are not limited to α—amylases (EC 3.2.1.1), α-glucosidases (EC 3.2.1.20), β-glucosidases (EC 3.2.1.21), α-galactosidases (EC 3.2.1.22), β-galactosidases (EC 3.2.1.23), α-mannosidase (EC 3.2.1.24), β-mannosidase (EC 3.2.1.25), β-fructofuranosidase (EC 3.2.1.26), amylo-1,6-glucosidases (EC 3.2.1.33), β-D-fucosidases (EC 3.2.1.38), α-L-rhamnosidases (EC 3.21.40), glucan 1,6-α-glucosidases (EC 3.2.70), and variants thereof.

In some embodiments, the GRGs of the present application are formed using a class of glycoside hydrolases or glycosyltransferases known as “transglycosylases.” As used herein, the term “transglycosylase” and “transglycosidase” (TG) are used interchangeably with reference to a glycoside hydrolase (GH) or glycosyltransferase (GT) enzyme capable of transferring a monosaccharide moiety from one molecule to another. Thus, a GH can catalyze the formation of a new glycosidic bond either by transglycosylation or by reverse hydrolysis (i.e., condensation).

The acceptor for transglycosylase reaction acceptor can be saccharide acceptor or a monosaccharide acceptor. Thus, a transglycosidase can transfer a monosaccharide moiety to a diverse set of aglycones, including e.g., monosaccharide acceptors, such as aromatic and aliphatic alcohols. Transglycosidases can transfer a wide variety of monosaccharides (D- or L-configurations) to saccharide acceptors, including glycosides, as well as monosaccharide acceptors, including a wide variety of flavonoid aglycones, such as naringenin, quercetin, hesperetin.

Monosaccharides that can be transferred to a saccharide or monosaccharide acceptor include, but are not limited to glucose, fructose, galactose, ribose, arabinose, xylose, mannose, psicose, fucose and rhamnose, and derivative thereof, as well as acidic sugars, such as sialic acid, glucuronic acid and galacturonic acid. The term “transglucosidase” is used when the monosaccharide moiety is a glucose moiety.

Transglycosidases include GHs or GTs from the enzyme classes of EC 3.2.1 or 2.4.1, respectively. In spite of the inclusion of certain glycosyltransferases as transglycosidases, TGs are classified into various GH families on the basis of sequence similarity. A large number of retaining glycosidases catalyze both hydrolysis and transglycosylation reactions. In particular, these enzymes catalyze the intra- or intermolecular substitution of the anomeric position of a glycoside. Under kinetically controlled reactions, retaining glycosidases can be used to form glycosidic linkages using a glycosyl donor activated by a good anomeric leaving group (e.g., nitrophenyl glycoside). In contrast, thermodynamically controlled reverse hydrolysis uses high concentrations of free sugars.

Transglycosidases corresponding to any of the GH families with notable transglycosylase activity may be used in the present application, and may include the use of e.g., members of the GH2 family, including LacZ 0-galactosidase, which converts lactose to allolactose; GH13 family, which includes cyclodextran glucanotransferases that convert linear amylose to cyclodextrins, glycogen debranching enzyme, which transfers three glucose residues from the four-residue glycogen branch to a nearby branch, and trehalose synthase, which catalyzes the interconversion of maltose and trehalose; GH16 family, including xyloglucan endotransglycosylases, which cuts and rejoins xyloglucan chains in the plant cell wall; GH31, for example, α-transglucosidases, which catalyze the transfer of individual glucosyl residues between α-(1→4)-glucans; GH70 family, for example, glucansucrases, which catalyze the synthesis of high molecular weight glucans, from sucrose; GH77 family, for examples amylomaltase, which catalyzes the synthesis of maltodextrins from maltose; and the GH23, GH102, GH103, and GH104 families, which include lytic transglycosylases that convert peptidoglycan to 1,6-anhydrosugars.

In one embodiment, the glycosyltransferase is a transglucosylase from the glycoside hydrolase 70 (GH70) family. GH70 enzymes are transglucosylases produced by lactic acid bacteria from, e.g., Streptococcus, Leuconostoc, Weisella or Lactobacillus genera. Together with the families GH13 and GH77 enzymes, they form the clan GH-H. Most of the enzymes classified in this family use sucrose as the D-glucopyranosyl donor to synthesize α-D-glucans of high molecular mass (>106 Da) with the concomitant release of D-fructose. They are also referred to as glucosyltransferases or glucansucrases.

A wide range of α-D-glucans, varying in size, structure, degree of branching and spatial arrangements can thus be produced by GH70 family members. For example, GH70 glucansucrases can transfer D-glucosyl units from sucrose onto hydroxyl acceptor groups. Glucansucrases catalyze the formation of linear as well as branched α-D-glucan chains with various types of glycosidic linkages, namely α-1,2; α-1,3; α-1,4; and/or α-1,6.

In addition, sucrose analogues such as α-D-glucopyranosyl fluoride, p-nitrophenyl α-D-glucopyranoside, α-D-glucopyranosyl α-L-sorofuranoside and lactulosucrose can be utilized as D-glucopyranosyl donors. A large variety of acceptors may be recognized by glucansucrases, including carbohydrates, alcohols, polyols or flavonoids to yield oligosaccharides or gluco-conjugates.

Exemplary glucansucrases for use in the present application include e.g., dextransucrase (sucrose:1,6-α-D-glucosyltransferase; EC 2.4.1.5), alternansucrase (sucrose:1,6(1,3)-α-D-glucan-6(3)-α-D-glucosyltransferase, EC 2.4.1.140), mutansucrase (sucrose:1,3-α-D-glucan-3-α-D-glucosyltransferase; EC 2.4.1.125), and reuteransucrase (sucrose:1,4(6-α-D-glucan-4(6)-α-D-glucosyltransferase; EC 2.4.1.-). The structure of the resultant glucosylated product is dependent upon the enzyme specificity.

In some embodiments, a fructosyltransferase may be used to catalyze the transfer of one or more fructose units, optionally comprising terminal glucose, of the following sequence: (Fru)n-Glc consisting of one or more of: β 2,1, β 2,6, α 1,2 and β-1,2 glycosidic bonds, wherein n typically is 3-10. Variants include Inulin type β-1,2 and Levan type β-2,6 linkages between fructosyl units in the main chain. Exemplary fructosytransferase for use in the present application include e.g., β-fructofuranosidase (EC 3.2.1.26), inulosucrase (EC 2.4.1.9) levansucrase (EC 2.4.1.10), or endoinulinase.

In some embodiments, a galactosyltransferase or β-galactosidase may be used to catalyze the transfer of multiple saccharide units, in which one of the units is a terminal glucose and the remaining units are galactose and disaccharides comprising two units of galactose. In certain embodiments, the resulting structure includes a mixture of galactopyranosyl oligomers (DP=3-8) linked mostly by β-(1,4) or β-(1,6) bonds, although low proportions of β-(1,2) or β-(1,3) linkages may also be present. Terminal glucosyl residues are linked by β-(1,4) bonds to galactosyl units. These structures may be synthesized by the reverse action of β-galactosidases (EC 3.2.1.23) on lactose at relatively high concentrations of lactose.

In some embodiments, the transglycosidase is an enzyme having trans-fucosidase, trans-sialidase, trans-lacto-N-biosidase and/or trans-N-acetyllactosaminidase activity.

In some embodiments, the glycosylation reactions may utilize a combination of any of glycosyltransferases described herein in combination with any one of the glycosyl hydrolases or transglycosidases described herein. In these reactions, the transglycosylase and the glycosyl hydrolase or transglycosidase may be present in a range of ratios (w/w), wherein the transglycosylase/glycosyl hydrolase ratio (w/w) ranges from 100:1, 80:1, 60:1, 40:1, 30:1, 25:1, 20:1, 15:1, 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, 1:15, 1:20, 1:25, 1:30, 1:40, 1:50, 1:60, 1:80, 1:100, or any ratio derived from any two of the aforementioned integers.

In some embodiments, the sugar donor in the glycosylation reaction is a glucose-based donor. Examples of glucose-based donors include, but are not limited to, glucose, dextrin, and maltodextrin.

In some embodiments, the sugar donor in the glycosylation reaction is a non-glucose-based sugar. Examples of non-glucose-based sugars include, but are not limited to, arabinose, fructose, galactose, lactose, mannose, rhamnose and xylose.

In some embodiments, a glycosylation reaction is performed with a combination of different sugars a sugar donor.

In some embodiments, multiple rounds of glycosylation reaction are performed with a different sugar donor in each round.

In some embodiments, the substrate of the glycosylation reaction is a SG, such as RA, RB, RC, RD, RE, RF, RI, RM, RN, RO, steviolmonoside, steviolbioside, dulcoside A, dulcoside B, rubusoside and stevioside.

In some embodiment, the substrate of the glycosylation reaction is a GSG, such as GRA, GRB, GRC, GRD, GRE, GRF, GRI, GRM, GRN, GRO, glycosylated steviolmonoside, glycosylated steviolbioside, glycosylated dulcoside, glycosylated rubusoside and glycosylated stevioside.

In some embodiments, the glycosylation reaction is performed with substrate-to-sugar donor weight ratio in the range of 99:1 to 1:99, 90:1 to 1:99, 80:1 to 1:99, 70:1 to 1:99, 60:1 to 1:99, 50:1 to 1:99, 40:1 to 1:99, 30:1 to 1:99, 20:1 to 1:99, 10:1 to 1:99, 1:1 to 1:99, 99:1 to 1:90, 90:1 to 1:90, 80:1 to 1:90, 70:1 to 1:90, 60:1 to 1:90, 50:1 to 1:90, 40:1 to 1:90, 30:1 to 1:90, 20:1 to 1:90, 10:1 to 1:90, 1:1 to 1:90, 99:1 to 1:60, 90:1 to 1:60, 80:1 to 1:60, 70:1 to 1:60, 60:1 to 1:60, 50:1 to 1:60, 40:1 to 1:60, 30:1 to 1:60, 20:1 to 1:60, 10:1 to 1:60, 1:1 to 1:60, 99:1 to 1:30, 90:1 to 1:30, 80:1 to 1:30, 70:1 to 1:30, 60:1 to 1:30, 50:1 to 1:30, 40:1 to 1:30, 30:1 to 1:30, 20:1 to 1:30, 10:1 to 1:30, 1:1 to 1:30, 99:1 to 1:10, 90:1 to 1:10, 80:1 to 1:10, 70:1 to 1:10, 60:1 to 1:10, 50:1 to 1:10, 40:1 to 1:10, 30:1 to 1:10, 20:1 to 1:10, 10:1 to 1:10, 1:1 to 1:10.

The glycosylating enzyme may be dissolved in the reaction mixture or immobilized on a solid support which is contacted with the reaction mixture. If the enzyme is immobilized, it may be attached to an inert carrier. Suitable carrier materials are known in the art. Examples for suitable carrier materials are clays, clay minerals such as kaolinite, diatomeceous earth, perlite, silica, alumina, sodium carbonate, calcium carbonate, cellulose powder, anion exchanger materials, synthetic polymers, such as polystyrene, acrylic resins, phenol formaldehyde resins, polyurethanes and polyolefins, such as polyethylene and polypropylene. For preparing carrier-bound enzymes the carrier materials usually are used in the form of fine powders, wherein porous forms are preferred. The particle size of the carrier material usually does not exceed 5 mm, in particular 2 mm. Further, suitable carrier materials are calcium alginate and carrageenan. Enzymes may directly be linked by glutaraldehyde. A wide range of immobilization methods are known in the art. Ratio of reactants can be adjusted based on the desired performance of the final product. The temperature of the glycosylation reaction can be in the range of 1-100° C., preferably 40-80° C., more preferably 50-70° C.

In certain embodiments, the GSG used in the present application are prepared as follows: (i) mixing a starting SG composition (e.g., a rubusoside) with a sugar-donor material to obtain a mixture; and (ii) adding an effective amount of an enzyme to the mixture to form a reaction mixture, where the enzyme catalyzes the transfer of sugar moieties from the sugar-donor material to the SG molecules in the starting SG composition; and (iii) incubating the reaction mixture at a desired temperature for a desired length of reaction time to glycosylate the SG molecules with sugar moieties present in the sugar-donor molecule to generate GSG. In some embodiments, after achieving a desired ratio of GSG to residual SG contents, the reaction mixture can be heated to a sufficient temperature for a sufficient amount of time to inactivate the enzyme. In some embodiments, the enzyme is removed by filtration in lieu of inactivation. In other embodiments, the enzyme is removed by filtration following inactivation, resulting a solution comprising GSG, residual SG from the starting SG composition and residual sugar donor. In some embodiments the resulting solution comprising GSG, residual SG and residue sugar donor is decolorized.

Examples of sugar donors include, but are not limited to, dextrin, maltodextin, glucose, fructose, galactose, lactose, mannose, fruit juice, vegetable juice and honey.

In some embodiments, the GSG used in the present application are prepared as follows: (i) dissolving a glucose-donor material in water to form a liquefied glucose-donor material; (ii) adding a starting SG composition to liquefied glucose-donor material to obtain a mixture; and (iii) adding an effective amount of an enzyme to the mixture to form a reaction mixture, wherein the enzyme catalyzes the transfer of glucose moieties from the glucose-donor material to the SG molecules in the starting SG composition; and (iv) incubating the reaction mixture at a desired temperature for a desired length of reaction time to glycosylate the SG molecules with glucose moieties present in the glucose-donor molecule. In some embodiments, after achieving a desired ratio of GSG and SG contents, the reaction mixture is heated to a sufficient temperature for a sufficient amount of time to inactivate the enzyme. In some embodiments, the enzyme is removed by filtration in lieu of inactivation. In other embodiments, the enzyme is removed by filtration following inactivation. In some embodiments the resulting solution comprising GSGs, residual SGs and dextrin is decolorized. In certain embodiments the resulting solution of GSGs, including residual SGs and dextrin is dried. In some embodiments, the drying is by spray drying. In some embodiments, step (i) comprises the substeps of (a) mixing a glucose-donor material with a desired amount of water to form a suspension, (b) adding a desired amount of enzyme to the suspension and (c) incubate the suspension at a desired temperature for a desired time to form liquefied glucose-donor material. Starch can be a suitable substitute for dextrin(s) and/or dextrin(s) can be obtained by the hydrolysis of starch.

The enzymatically catalyzed reaction can be carried out batch wise, semi-batch wise or continuously. Reactants can be supplied at the start of reaction or can be supplied subsequently, either semi-continuously or continuously. The catalytic amount of glycosidase or glycosyltransferase required for the method of the invention depends on the reaction conditions, such as temperature, solvents and amount of substrate.

The reaction can be performed in aqueous media such as buffer. A buffer adjusts the pH of the reaction mixture to a value suitable for effective enzymatic catalysis. Typically the pH is in the range of about pH 4 to about pH 9, for example, of about pH 5 to about pH 7. Suitable buffers comprise, but are not limited to, sodium acetate, tris(hydroxymethyl) aminomethane (“Tris”) and phosphate buffers.

Optionally, the reaction may take place in the presence of a solvent mixture of water and a water miscible organic solvent at a weight ratio of water to organic solvent of from 0.1:1 to 9:1, for example, from 1:1 to 3:1. The organic solvent is not primary or secondary alcohol and, accordingly, is non-reactive towards the polysaccharide. Suitable organic solvents comprise alkanones, alkylnitriles, tertiary alcohols and cyclic ethers, and mixtures thereof, for example, acetone, acetonitrile, t-pentanol, t-butanol, 1,4-dioxane and tetrahydrofuran, and mixtures thereof. Generally, the use of organic solvents is not preferred.

The final product of the glycosylation reaction, such as glycosylated rubusoside and glycosylated stevioside, may be further purified to remove residual sugar donor, such as maltodextrin.

In some embodiments, a GSG, such as glycosylated rubusoside is subjected to enzyme treatment (e.g., α-amylase treatment) to produce a GSG with reduced level of glycosylation (e.g., GSG with shortened side chains at the glycosylation sites) compared to the pre-treatment GSG.

In some embodiments, a GSG, such as glycosylated rubusoside, is subjected to another glycosylation reaction to produce GSGs with increased level of glycosylation (e.g., elongated side chains at the glycosylation sites) compared to the pre-treatment GSG.

### (ii) Conversion Reactions

### (a) Enzyme-Mediated (Or Enzymatic) Conversion

In some embodiments, the glycosylated NHIS, such as GSGs, of the present application are formed by an exogenous conversion reaction in the present of a glycosyl hydrolase (GH), which cleaves a glycosidic bond and is thus capable of converting a GSG, such as glycosylated stevioside to another GSG, such as glycosylated rubusoside, by removing a glucose at the C-13 position of the stevioside.

### (b) Non-Enzyme-Mediated (Non-Enzymatic) Conversion

In some embodiments, the glycosylated NHIS, such as GSGs, of the present application are formed by non-enzymatic hydrolysis. The non-enzymatic hydrolysis can be carried out under alkaline or acid conditions. Table C shows an exemplary list of hydrolysis products from natural diterpene glycoside.

In some embodiments, a GSG of the present application are produced by converting an original GSG into another GSG or GSGs by alkaline or acid hydrolysis.

In some embodiments, glycosylated steviolbioside of the present application is produced from glycosylated stevioside. For examples, glycosylated stevioside can be hydrolyzed to remove a glucose unit from the glycoside chain on the C19 carbon of glycosylated stevioside, which converts glycosylated steviolside to glycosylated steviolbioside.

In some embodiments, glycosylated steviolmonoside of the present application is produced from glycosylated rubusoside. For example, glycosylated rubusoside, can be hydrolyzed to remove a glucose unit from the glycoside chain on the C19 carbon of glycosylated rubusoside, which converts glycosylated rubusoside to glycosylated steviolmonoside.

In some embodiments, glycosylated dulcoside B of the present application is produced from GRC. For example, GRC can be hydrolyzed to remove a glucose unit from the glycoside chain on the C19 carbon of GRC, which converts GRC to glycosylated dulcoside B.

TABLE C
Compounds reported as degradation products from natural
diterpene glycosides by alkaline or acid conditions.

| | Oligosaccharide Moieties | | | Chemical | Starting |
|---|---|---|---|---|---|
| Common Name | C-13 | C-19 | AS | Formula | Material |
| — | Xylβ(1-2)Glcβ₁- | — | I | C₃₁H₄₈O₁₂ | a |
| Dulcoside A₁ | Rhaα(1-2)Glcβ₁- | — | I | C₃₂H₅₀O₁₂ | Dulcoside A |
| Rebaudioside G₁ | Glcβ(1-3)Glcβ₁- | — | I | C₃₂H₅₀O₁₃ | Rebaudioside G |
| Rebaudioside F₁ | Xylβ(1-2)[Glcβ(1- | — | I | C₃₇H₅₈O₁₇ | Rebaudioside F |
| | 3)]Glcβ₁- | | | | |
| Rebaudioside R₁ | Glc(1-2)[Glcβ(1- | — | I | C₃₇H₅₈O₁₇ | Rebaudioside R |
| | 3)]Xylβ1- | | | | |
| Rebaudioside Z₁ | Glcβ(1-6)[Glcβ(1- | — | I | C₃₈H₆₀O₁₈ | Rebaudioside Z |
| | 2)]Glcβ₁- | | | | |
| — | Glcβ(1-2)[Glcβ(1- | | II | C₃₈H₆₀O₁₈ | — |
| | 3)]Glcβ₁- | | | | |
| — | 6-deoxyGlcβ(1- | — | I | C₃₈H₆₀O₁₇ | b |
| | 2)[Glcβ(1-3)]Glcβ₁- | | | | |
| Rebaudioside H₁ | Glcβ(1-6)Glcβ(1- | — | I | C₄₄H₇₀O₂₃ | Rebaudioside H |
| | 3)[Glcβ(1-3)]Glcβ₁- | | | | |
| Rebaudioside L₁ | Glcβ(1-3)Rhaα(1- | — | I | C₄₄H₇₀O₂₃ | Rebaudioside L |
| | 2)[Glcβ(1-3)]Glcβ₁- | | | | |
| Isosteviol | — | — | III | C₂₀H₃₀O₃ | Rebaudioside |
| | | | | | A/Stevioside |
| Endo-steviol | — | — | IV | C₂₀H₃₀O₃ | Rebaudioside |
| | | | | | A/Stevioside |
| Endo-steviolmonoside | Glcβ₁- | — | IV | C₂₆H₄₀O₈ | Rebaudioside |
| | | | | | A/Rubusoside |
| Endo-rebaudioside G₁ | Glcβ(1-3)Glcβ₁- | — | IV | C₃₂H₅₀O₁₃ | Rebaudioside A |
| Endo-steviolbioside | Glcβ(1-2)Glcβ₁- | — | IV | C₃₂H₅₀O₁₃ | Rebaudioside A |
| Endo-rubusoside | Glcβ₁- | Glcβ₁- | IV | C₃₂H₅₀O₁₃ | Rebaudioside |
| | | | | | A/Rubusoside |
| Iso-stevioside/Endo- | Glcβ(1-2)Glcβ₁- | Glcβ₁- | IV | C₃₈H₆₀O₁₈ | Rebaudioside A |
| stevioside | | | | | |
| Iso-rebaudioside | Glcβ(1-2)[Glcβ(1-3)]- | — | IV | C₃₈H₆₀O₁₈ | Rebaudioside A |
| β/Endo-rebaudioside B | Glcβ₁- | | | | |
| — | — | Glcβ(1- | III | C₃₈H₆₀O₁₈ | Rebaudioside M |
| | | 2)[Glcβ(1- | | | |
| | | 3)]Glcβ₁- | | | |
| Iso-rebaudioside AEndo- | Glcβ(1-2)[Glcβ(1- | Glcβ₁- | IV | C₄₄H₇₀O₂₃ | Rebaudioside A |
| rebaudioside A | 3)]Glcβ₁- | | | | |
| — | Glcβ(1-2)[Glcβ(1- | Glcβ(1- | IV | C₅₆H₉₀O₃₃ | Rebaudioside M |
| | 3)]Glcβ₁- | 2)[Glcβ(1- | | | |
| | | 3)]Glcβ₁- | | | |
| — | Glcβ(1-2)[Glcβ(1- | Glcβ(1- | V | C₅₆H₉₂O₃₄ | Rebaudioside M |
| | 3)]Glcβ₁- | 2)[Glcβ(1- | | | |
| | | 3)]Glcβ₁- | | | |

a 13-[(2-O-β-D-xylopyranosyl-β-D-glucopyranosyl-)oxy]ent-kaur-16-en-19-oic acid β-D-glucopyranosyl ester;
b 13-[(2-O-6-deoxy-β-D-glucopyranosyl-3-O-β-D-glucopyranosyl-β-D-glucopyranosyl)oxy]ent-kaur-16-en-19-oic acid β-D-glucopyranosyl ester.

In some embodiments, alkaline hydrolysis of the starting or raw material is preferred for simplicity and economics. Sodium hydroxide is the preferred alkali to use for hydrolysis of GRA, GRC, glycosylated stevioside or glycosylated rubusoside, but potassium hydroxide and other well-known alkali used in food processing can also be used.

In some embodiments, the starting or raw materials can include 50 wt % or greater, 55 wt % or greater, 60 wt % or greater, 65 wt % or greater, 70 wt % or greater, 75 wt % or greater, 80 wt % or greater, 85 wt % or greater, 90 wt % or greater, 95 wt % or greater, or 99 wt % or greater of GRA, GRC, glycosylated stevioside or glycosylated rubusoside.

In some embodiments, a GSG starting material is dissolved in water (preferably potable water) to form a solution, alkali is then added to the solution , and the solution temperature is raised preferably to 85° C. to 95° C., and more preferably to 90° C. to start alkaline hydrolysis. If the alkaline hydrolysis is conducted at temperatures lower than 85° C., the reaction proceeds slowly until the alkali is exhausted. The solution is stirred and is maintained at the selected temperature for a duration that provides the desired concentrations of the hydrolysis products in the solution or until the alkali is exhausted. The preferred duration of alkaline hydrolysis at commercial scale is a minimum 30 minutes; shorter durations typically do not exhaust the amounts of alkali used in commercial production. The final product solution (containing both the unhydrolyzed GSG starting material such as GRA, also referred to as “residual GSG”, and the hydrolysis product such as GRB) is typically very close to pH 7.0, but pH can be adjusted (typically by adding HCl or NaOH).

The product solution produced as described above may be brown in color, has a faint “burnt sugar” smell, and has a weak “caramel” taste. Brown color, burnt sugar smell, and caramel taste can be removed by column chromatography such as an activated charcoal column, a polymer resin adsorption column or with an ion exchange column as the chromatography matrix, binding the caramel components to the be column while letting the steviol glycosides pass through. Depending upon the use of the sweetener or flavoring agent of the present application, the brown color, burnt sugar smell, and caramel taste may be desirable, or unnoticeable, in either case avoiding the need to remove the brown color, burnt sugar smell, and caramel taste.

The alkaline hydrolysis products can be kept in solution as a syrup ready for distribution as a liquid sweetener, or dried for distribution as a dry sweetener. Drying is by spray-drying, lyophilization, oven drying, and other drying processes well-known in the art of sweeteners.

(iii) Glycosylation and Conversion Products

In some embodiments, the GSG of the present application is a GSG composition obtained from a glycosylation reaction or conversion reaction. In some embodiments, the GSG composition comprises GSGs in an individual or total amount that equals to, or is greater than, 20 wt %, 30 wt %, 40 wt %, 50 wt %, 60 wt %, 70 wt %, 80 wt %, 90 wt % or 95 wt % of the GSG composition. The GSGs may be the glycosylation product of a single SG (e.g., RA, RB, RC, RD, RE, RI, RI, RM, RN, RO, RU, STV, STB, STM, DA etc.) with different levels of glycosylation, or the glycosylation product of multiple SGs with different levels of glycosylation.

In some embodiments, the GSG composition further comprises one or more unreacted residual SGs in an individual or total amount that equals to, or is less than 0.01 wt %, 0.1 wt %, 1 wt %, 2 wt %, 5 wt %, 10 wt %, 20 wt %, 30 wt %, 40 wt % or 50 wt % of the GSG composition.

In some embodiments, the GSG composition further comprises unreacted residual dextrins and/or maltodextrin in an individual or total amount that equals to, or is less than 0.01 wt %, 0.1 wt %, 1 wt %, 2 wt %, 5 wt %, 10 wt %, 20 wt %, 30 wt %, 40 wt % or 50 wt % of the GSG composition.

In some embodiments, the GSG composition comprises one or more unreacted SGs in an individual or total amount that equals to, or is less than 0.01 wt %, 0.1 wt %, 1 wt %, 2 wt %, 5 wt %, 10 wt %, 20 wt %, 30 wt %, 40 wt % or 50 wt % of the GSG composition.

In some embodiments, the GSG composition comprises unreacted dextrins and/or maltodextrin in an amount that equals to, or is less than 0.01 wt %, 0.1 wt %, 1 wt %, 2 wt %, 5 wt %, 10 wt %, 20 wt %, 30 wt %, 40 wt % or 50 wt % of the GSG composition.

In some embodiments, the GSG composition is a GRA, GRB, GRC, GRD, GRE, GRF, GRM, GRN, GRU, GDA, GSTV, GSTB or GSTM composition.

The glycosylation product of the present application may comprise both reacted and unreacted components from the starting materials (i.e., the mixture of materials before the initiation of the glycosylation reaction). In some embodiments, the glycosylation reaction product of the present application comprises GRA, GRB, GRC, GRD, GRE, GRF, GRM, GRN, GRU, GDA, GSTV, GSTB or GSTM in a range between 1-99.5 wt %, 1-5 wt %, 1-10 wt %, 1-20 wt %, 1-30 wt %, 1-40 wt %, 1-50 wt %, 1-60 wt %, 1-70 wt %, 1-80 wt %, 1-90 wt %, 1-99 wt %, 5-10 wt %, 5-20 wt %, 5-30 wt %, 5-40 wt %, 5-50 wt %, 5-60 wt %, 5-70 wt %, 5-80 wt %, 5-90 wt %, 5-99 wt %, 10-20 wt %, 10-30 wt %, 10-40 wt %, 10-50 wt %, 10-60 wt %, 10-70 wt %, 10-80 wt %, 10-90 wt %, 10-99 wt %, 20-30 wt %, 20-40 wt %, 20-50 wt %, 20-60 wt %, 20-70 wt %, 20-80 wt %, 20-90 wt %, 20-99 wt %, 30-40 wt %, 30-50 wt %, 30-60 wt %, 30-70 wt %, 30-80 wt %, 30-90 wt %, 30-99 wt %, 40-50 wt %, 40-60 wt %, 40-70 wt %, 40-80 wt %, 40-90 wt %, 40-99 wt %, 50-60 wt %, 50-70 wt %, 50-80 wt %, 50-90 wt %, 50-99 wt %, 60-70 wt %, 60-80 wt %, 60-90 wt %, 60-99 wt %, 70-80 wt %, 70-90 wt %, 70-99 wt %, 80-90 wt %, 80-99 wt %, 90-99 wt % of the of the glycosylation reaction product.

In some embodiments, GRA, GRB, GRC, GRD, GRE, GRF, GRM, GRN, GRU, GDA, GSTV, GSTB or GSTM is present in the glycosylation reaction product in an amount that equals to, or is greater than, 0.01 wt %, 0.1 wt %, 1 wt %, 2 wt %, 5 wt %, 10 wt %, 20 wt %, 30 wt %, 40 wt %, 50 wt %, 60 wt %, 70 wt %, 80 wt %, 90 wt %, 95 wt %, or 99 wt % of the glycosylation reaction product.

In some embodiments, unreacted RA, RB, RC, RD, RE, RF, RM, RN, RU, DA, STV, STB or STM is present in the glycosylation reaction product in an amount that equals to, or less than 0.01 wt %, 0.1 wt %, 1 wt %, 2 wt %, 5 wt %, 10 wt %, 20 wt %, 30 wt %, 40 wt %, 50 wt % or 60 wt % of the glycosylation reaction product.

In some embodiments, the glycosylation reaction product includes GSG and residual SGs at a GSG:residual SG weight ratio of 99:1 to 1:99, 90:1 to 1:99, 80:1 to 1:99, 70:1 to 1:99, 60:1 to 1:99, 50:1 to 1:99, 40:1 to 1:99, 30:1 to 1:99, 20:1 to 1:99, 10:1 to 1:99, 1:1 to 1:99, 99:1 to 1:90, 90:1 to 1:90, 80:1 to 1:90, 70:1 to 1:90, 60:1 to 1:90, 50:1 to 1:90, 40:1 to 1:90, 30:1 to 1:90, 20:1 to 1:90, 10:1 to 1:90, 1:1 to 1:90, 99:1 to 1:60, 90:1 to 1:60, 80:1 to 1:60, 70:1 to 1:60, 60:1 to 1:60, 50:1 to 1:60, 40:1 to 1:60, 30:1 to 1:60, 20:1 to 1:60, 10:1 to 1:60, 1:1 to 1:60, 99:1 to 1:30, 90:1 to 1:30, 80:1 to 1:30, 70:1 to 1:30, 60:1 to 1:30, 50:1 to 1:30, 40:1 to 1:30, 30:1 to 1:30, 20:1 to 1:30, 10:1 to 1:30, 1:1 to 1:30, 99:1 to 1:10, 90:1 to 1:10, 80:1 to 1:10, 70:1 to 1:10, 60:1 to 1:10, 50:1 to 1:10, 40:1 to 1:10, 30:1 to 1:10, 20:1 to 1:10, 10:1 to 1:10, 1:1 to 1:10.

The glycosylation product of the present application may comprise both reacted and unreacted components from the starting materials (i.e., the mixture of materials before the initiation of the glycosylation reaction). In some embodiments, the glycosylation reaction product of the present application comprises GSG in a range between 1-99.5 wt %, 1-5 wt %, 1-10 wt %, 1-20 wt %, 1-30 wt %, 1-40 wt %, 1-50 wt %, 1-60 wt %, 1-70 wt %, 1-80 wt %, 1-90 wt %, 1-99 wt %, 5-10 wt %, 5-20 wt %, 5-30 wt %, 5-40 wt %, 5-50 wt %, 5-60 wt %, 5-70 wt %, 5-80 wt %, 5-90 wt %, 5-99 wt %, 10-20 wt %, 10-30 wt %, 10-40 wt %, 10-50 wt %, 10-60 wt %, 10-70 wt %, 10-80 wt %, 10-90 wt %, 10-99 wt %, 20-30 wt %, 20-40 wt %, 20-50 wt %, 20-60 wt %, 20-70 wt %, 20-80 wt %, 20-90 wt %, 20-99 wt %, 30-40 wt %, 30-50 wt %, 30-60 wt %, 30-70 wt %, 30-80 wt %, 30-90 wt %, 30-99 wt %, 40-50 wt %, 40-60 wt %, 40-70 wt %, 40-80 wt %, 40-90 wt %, 40-99 wt %, 50-60 wt %, 50-70 wt %, 50-80 wt %, 50-90 wt %, 50-99 wt %, 60-70 wt %, 60-80 wt %, 60-90 wt %, 60-99 wt %, 70-80 wt %, 70-90 wt %, 70-99 wt %, 80-90 wt %, 80-99 wt %, 90-99 wt % of the of the total GRA.

In some embodiments, GSG is present in the glycosylation reaction product in an amount that equals to, or is greater than, 0.01 wt %, 0.1 wt %, 1 wt %, 2 wt %, 5 wt %, 10 wt %, 20 wt %, 30 wt %, 40 wt %, 50 wt %, 60 wt %, 70 wt %, 80 wt %, 90 wt %, 95 wt %, or 99 wt % of the glycosylation reaction product.

In some embodiments, unreacted SG is present in the glycosylation reaction product in an amount that equals to, or less than 0.01 wt %, 0.1 wt %, 1 wt %, 2 wt %, 5 wt %, 10 wt %, 20 wt %, 30 wt %, 40 wt %, 50 wt % or 60 wt % of the glycosylation reaction product.

In some embodiments, unreacted dextrin and/or maltodextrin is present in the glycosylation reaction product in an amount that equals to, or less than 0.01 wt %, 0.1 wt %, 1 wt %, 2 wt %, 5 wt %, 10 wt %, 20 wt % or 30 wt % of the glycosylation reaction product.

The GSG molecules of the present application include GSG molecules with different levels of glycosylation. In some embodiments, the GSG molecules of the present application comprise 1-20 additional monosaccharide units that are added to the SG backbone during a man-made glycosylation reaction. In some embodiments, the additional monosaccharide units are glucose units. In some embodiments, the additional monosaccharide units are non-glucose units, such as fructose, xylose and galactose units. In some embodiments, the additional monosaccharide units are a mixture of glucose units and non-glucose units. In some embodiments, the GSG of the present application comprises mono-glycosylated SG, di-glycosylated SG, tri-glycosylated SG, tetra-glycosylated SG and/or penta-glycosylated SG.

In some embodiments, the GSG composition of the present application contains mono-glycosylated SG, di-glycosylated SG, tri-glycosylated SG, tetra-glycosylated SG and/or penta-glycosylated SG, individually or in combination, in an amount of less than 99 wt %, 90 wt %, 80 wt %, 70 wt %, 65 wt %, 60 wt %, 55 wt %, 50 wt %, 45 wt %, 40 wt %, 35 wt %, 30 wt %, 25 wt %, 20 wt %, 15 wt %, 10 wt %, 5 wt %, 2 wt %, or 1 wt % of mono-glycosylated SG.

In some embodiments, the GSG composition of the present application contains mono-glycosylated SG, di-glycosylated SG, tri-glycosylated SG, tetra-glycosylated SG and/or penta-glycosylated SG, individually or in combination, in an amount that equals to, or is greater than, 1 wt %, 2 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt % or 80 wt % of the total GSG.

In some embodiments, the GSG composition of the present application contains mono-glycosylated SG, di-glycosylated SG, tri-glycosylated SG, tetra-glycosylated SG and/or penta-glycosylated SG, individually or in combination, in an amount that is in the range of 1-99 wt %, 1-95 wt %, 1-90 wt %, 1-85 wt %, 1-80 wt %, 1-75 wt %, 1-70 wt %, 1-65 wt %, 1-60 wt %, 1-55 wt %, 1-50 wt %, 1-45 wt %, 1-40 wt %, 1-35 wt %, 1-30 wt %, 1-25 wt %, 1-20 wt %, 1-15 wt %, 1-10 wt %, 1-5 wt %, 1-2 wt %, 2-99 wt %, 2-95 wt %, 2-90 wt %, 2-85 wt %, 2-80 wt %, 2-75 wt %, 2-70 wt %, 2-65 wt %, 2-60 wt %, 2-55 wt %, 2-50 wt %, 2-45 wt %, 2-40 wt %, 2-35 wt %, 2-30 wt %, 2-25 wt %, 2-20 wt %, 2-15 wt %, 2-10 wt %, 2-5 wt %, 5-99 wt %, 5-95 wt %, 5-90 wt %, 5-85 wt %, 5-80 wt %, 5-75 wt %, 5-70 wt %, 5-65 wt %, 5-60 wt %, 5-55 wt %, 5-50 wt %, 5-45 wt %, 5-40 wt %, 5-35 wt %, 5-30 wt %, 5-25 wt %, 5-20 wt %, 5-15 wt %, 5-10 wt %, 10-99 wt %, 10-95 wt %, 10-90 wt %, 10-85 wt %, 10-80 wt %, 10-75 wt %, 10-70 wt %, 10-65 wt %, 10-60 wt %, 10-55 wt %, 10-50 wt %, 10-45 wt %, 10-40 wt %, 10-35 wt %, 10-30 wt %, 10-25 wt %, 10-20 wt %, 10-15 wt %, 15-99 wt %, 15-95 wt %, 15-90 wt %, 15-85 wt %, 15-80 wt %, 15-75 wt %, 15-70 wt %, 15-65 wt %, 15-60 wt %, 15-55 wt %, 15-50 wt %, 15-45 wt %, 15-40 wt %, 15-35 wt %, 15-30 wt %, 15-25 wt %, 15-20 wt %, 20-99 wt %, 20-95 wt %, 20-90 wt %, 20-85 wt %, 20-80 wt %, 20-75 wt %, 20-70 wt %, 20-65 wt %, 20-60 wt %, 20-55 wt %, 20-50 wt %, 20-45 wt %, 20-40 wt %, 20-35 wt %, 20-30 wt %, 20-25 wt %, 25-99 wt %, 25-95 wt %, 25-90 wt %, 25-85 wt %, 25-80 wt %, 25-75 wt %, 25-70 wt %, 25-65 wt %, 25-60 wt %, 25-55 wt %, 25-50 wt %, 25-45 wt %, 25-40 wt %, 25-35 wt %, 25-30 wt %, 30-99 wt %, 30-95 wt %, 30-90 wt %, 30-85 wt %, 30-80 wt %, 30-75 wt %, 30-70 wt %, 30-65 wt %, 30-60 wt %, 30-55 wt %, 30-50 wt %, 30-45 wt %, 30-40 wt %, 30-35 wt %, 35-99 wt %, 35-95 wt %, 35-90 wt %, 35-85 wt %, 35-80 wt %, 35-75 wt %, 35-70 wt %, 35-65 wt %, 35-60 wt %, 35-55 wt %, 35-50 wt %, 35-45 wt %, 35-40 wt %, 40-99 wt %, 40-95 wt %, 40-90 wt %, 40-85 wt %, 40-80 wt %, 40-75 wt %, 40-70 wt %, 40-65 wt %, 40-60 wt %, 40-55 wt %, 40-50 wt %, 40-45 wt %, 45-99 wt %, 45-95 wt %, 45-90 wt %, 45-85 wt %, 45-80 wt %, 45-75 wt %, 45-70 wt %, 45-65 wt %, 45-60 wt %, 45-55 wt %, 45-50 wt %, 50-99 wt %, 50-95 wt %, 50-90 wt %, 50-85 wt %, 50-80 wt %, 50-75 wt %, 50-70 wt %, 50-65 wt %, 50-60 wt %, 50-55 wt %, 55-99 wt %, 55-95 wt %, 55-90 wt %, 55-85 wt %, 55-80 wt %, 55-75 wt %, 55-70 wt %, 55-65 wt %, 55-60 wt %, 60-99 wt %, 60-95 wt %, 60-90 wt %, 60-85 wt %, 60-80 wt %, 60-75 wt %, 60-70 wt %, 60-65 wt %, 65-99 wt %, 65-95 wt %, 65-90 wt %, 65-85 wt %, 65-80 wt %, 65-75 wt %, 65-70 wt %, 70-99 wt %, 70-95 wt %, 70-90 wt %, 70-85 wt %, 70-80 wt %, 70-75 wt %, 75-99 wt %, 75-95 wt %, 75-90 wt %, 75-85 wt %, 75-80 wt %, 80-99 wt %, 80-95 wt %, 80-90 wt %, 80-85 wt %, 85-99 wt %, 85-95 wt %, 85-90 wt %, 90-99 wt %, 90-95 wt % or 95-99 wt % of the total GSG.

In some embodiments, the GSG composition contains less than 60 wt %, 50 wt %, 40 wt %, 30 wt %, 20 wt %, 15 wt %, 10 wt %, 5 wt % or 2 wt % of mono-glycosylated SG. In some embodiments, the GSG contains greater than 5 wt %, 10 wt %, 15 wt %, 20 wt %, 30 wt %, 40 wt %, 50 wt % or 60 wt % of mono-glycosylated SG. In some embodiments, the GSG contain about 5 wt %, 10 wt %, 15 wt %, 20 wt %, 30 wt %, 40 wt %, 50 wt % or 60 wt % of mono-glycosylated SG.

In some embodiments, the GSG composition contains less than 60 wt %, 50 wt %, 40 wt %, 30 wt %, 20 wt %, 15 wt %, 10 wt %, 5 wt % or 2 wt % of di-glycosylated SG. In some embodiments, the GSG contains greater than 5 wt %, 10 wt %, 15 wt %, 20 wt %, 30 wt %, 40 wt %, 50 wt % or 60 wt % of di-glycosylated SG. In some embodiments, the GSG contain about 5 wt %, 10 wt %, 15 wt %, 20 wt %, 30 wt %, 40 wt %, 50 wt % or 60 wt % of di-glycosylated SG.

In some embodiments, the GSG composition contains less than 60 wt %, 50 wt %, 40 wt %, 30 wt %, 20 wt %, 15 wt %, 10 wt %, 5 wt % or 2 wt % of tri-glycosylated SG. In some embodiments, the GSG contains greater than 5 wt %, 10 wt %, 15 wt %, 20 wt %, 30 wt %, 40 wt %, 50 wt % or 60 wt % of tri-glycosylated SG. In some embodiments, the GSG contain about 5 wt %, 10 wt %, 15 wt %, 20 wt %, 30 wt %, 40 wt %, 50 wt % or 60 wt % of tri-glycosylated SG.

In some embodiments, the GSG composition contains less than 60 wt %, 50 wt %, 40 wt %, 30 wt %, 20 wt %, 15 wt %, 10 wt %, 5 wt % or 2 wt % of tetra-glycosylated SG. In some embodiments, the GSG contains greater than 5 wt %, 10 wt %, 15 wt %, 20 wt %, 30 wt %, 40 wt %, 50 wt % or 60 wt % of tetra-glycosylated SG. In some embodiments, the GSG contains about 5 wt %, 10 wt %, 15 wt %, 20 wt %, 30 wt %, 40 wt %, 50 wt % or 60 wt % of tetra-glycosylated SG. In some embodiments, the GSG composition contains less than 60 wt %, 5

0 wt %, 40 wt %, 30 wt %, 20 wt %, 15 wt %, 10 wt %, 5 wt % or 2 wt % of penta-glycosylated SG. In some embodiments, the GSG contains greater than 5 wt %, 10 wt %, 15 wt %, 20 wt %, 30 wt %, 40 wt %, 50 wt % or 60 wt % of penta-glycosylated SG. In some embodiments, the GSG contain about 5 wt %, 10 wt %, 15 wt %, 20 wt %, 30 wt %, 40 wt %, 50 wt % or 60 wt % of penta-glycosylated SG.

In some embodiments, the GSG composition is a glycosylation product with glucose as sugar donor (glucosylation product). In some embodiments, the GSG composition is a glycosylation product with arabinose as sugar donor (arabinosylation product). In some embodiments, the GSG composition is a glycosylation product with fructose as sugar donor (fructosylation product). In some embodiments, the GSG composition is a glycosylation product with galactose as sugar donor (galactosylation product). In some embodiments, the GSG composition is a glycosylation product with lactose as sugar donor (lactosylation product). In some embodiments, the GSG composition is a glycosylation product with mannose as sugar donor (mannosylation product). In some embodiments, the GSG composition is a glycosylation product with rhamnose as sugar donor (rhamnosylation product). In some embodiments, the GSG composition is a glycosylation product with xylase as sugar donor (xylosylation product).

In some embodiments, the GSG of the present application comprise a mixture of two, three or more glycosylation products selected from the group consisting of glucosylation products, arabinosylation products, fructosylation products, galactosylation products, lactosylation products, mannosylation products, rhamnosylation products, and xylosylation products. In some embodiments, the GSG of the present application comprise two glycosylation products mixed at a weight ratio of in the range of 99:1 to 1:99, 90:1 to 1:99, 80:1 to 1:99, 70:1 to 1:99, 60:1 to 1:99, 50:1 to 1:99, 40:1 to 1:99, 30:1 to 1:99, 20:1 to 1:99, 10:1 to 1:99, 1:1 to 1:99, 99:1 to 1:90, 90:1 to 1:90, 80:1 to 1:90, 70:1 to 1:90, 60:1 to 1:90, 50:1 to 1:90, 40:1 to 1:90, 30:1 to 1:90, 20:1 to 1:90, 10:1 to 1:90, 1:1 to 1:90, 99:1 to 1:60, 90:1 to 1:60, 80:1 to 1:60, 70:1 to 1:60, 60:1 to 1:60, 50:1 to 1:60, 40:1 to 1:60, 30:1 to 1:60, 20:1 to 1:60, 10:1 to 1:60, 1:1 to 1:60, 99:1 to 1:30, 90:1 to 1:30, 80:1 to 1:30, 70:1 to 1:30, 60:1 to 1:30, 50:1 to 1:30, 40:1 to 1:30, 30:1 to 1:30, 20:1 to 1:30, 10:1 to 1:30, 1:1 to 1:30, 99:1 to 1:10, 90:1 to 1:10, 80:1 to 1:10, 70:1 to 1:10, 60:1 to 1:10, 50:1 to 1:10, 40:1 to 1:10, 30:1 to 1:10, 20:1 to 1:10, 10:1 to 1:10, 1:1 to 1:10. In some embodiments, the two glycosylation products are fructosylation product and glucosylation product.

B. Maillard Reaction Product Prepared from NHIS and Glycosylated NHIS

In some embodiments, the flavor/taste modifying agent of the present application includes a Maillard reaction product (MRP) of a NHIS and/or a glycosylated NHIS. In some embodiments, the MRP is formed from a reaction mixture containing (1) a NHIS and/or a glycosylated NHIS, and (2) an amine donor, wherein the NHIS and/or glycosylated NHIS under go Maillard reaction with the amine donor.

### (i) The Maillard Reaction

The Maillard reaction generally refers to a non-enzymatic browning reaction of a sugar donor with an amine donor in the presence of heat which produces flavor.

### (a) Amine Donor of a Maillard Reaction

The amine donor can be any compound or substance that contains a free amino group and that can participate in a Maillard reaction. Amine containing reactants include amino acids, peptides (including dipeptides, tripeptides, and oligopeptides), proteins, proteolytic or nonenzymatic digests thereof, and other compounds that react with reducing sugars and similar compounds in a Maillard reaction, such as phospholipids, chitosan, lipids, etc. In some embodiments, the amine donor also provides one or more sulfur-containing groups. Exemplary amine donors include amino acids, peptides, proteins, protein extracts.

Exemplary amino acids include, for example, nonpolar amino acids, such as alanine, glycine, isoleucine, leucine, methionine, tryptophan, phenylalanine, proline, valine; polar amino acids, such as cysteine, serine, threonine, tyrosine, asparagine, and glutamine; polar basic (positively charged) amino acids, such as histidine and lysine; and polar acidic (negatively charged) amino acids, such as aspartate and glutamate.

Exemplary peptides include, for example, hydrolyzed vegetable proteins (HVPs) and mixtures thereof.

Exemplary proteins include, for example, sweet taste-modifying proteins, soy protein, sodium caseinate, whey protein, wheat gluten or mixtures thereof. Exemplary sweet taste-modifying proteins include, for example, thaumatin, monellin, brazzein, miraculin, curculin, pentadin, mabinlin, and mixtures thereof. In certain embodiments, the sweet-taste modifying proteins may be used interchangeably with the term “sweetener enhancer.”

Exemplary protein extracts include yeast extracts, plant extracts, bacterial extracts and the like.

The nature of the amino donor can play an important role in accounting for the many flavors produced from a Maillard reaction. In some embodiments, the amine donor may account for one or more flavors produced from a Maillard reaction. In some embodiments, a flavor may be produced from a Maillard reaction by using one or more amine donors, or a particular combination of an amine donor and sugar donor.

In certain embodiments, the amine donor is present in the compositions described herein in a range of from about 1 to about 99 weight percent, from about 1 to about 50 weight percent, from about 1 to about 10 weight percent, from about 2 to about 9 weight percent, from about 3 to about 8 weight percent, from about 4 to about 7 weight percent, from about 5 to about 6 weight percent and all values and ranges encompassed over the range of from about 1 to about 50 weight percent. In some embodiments, the amine donor is from a plant source, such as vegetable juice, fruit juice, berry juice, etc.

### (b) Sugar Donor of a Maillard Reaction

In some embodiments, the sugar donor is a reducing sugar. Reducing sugars for use in the present application include, for example, all monosaccharides and some disaccharides, which can be aldose reducing sugars or ketose reducing sugars. Typically, the reducing sugar may be selected from the group consisting of aldotetrose, aldopentose, aldohexose, ketotetrose, ketopentose, and ketohexose reducing sugars. Suitable examples of aldose reducing sugars include erythrose, threose, ribose, arabinose, xylose, lyxose, allose, altrose, glucose, mannose, gulose, idose, galactose and talose. Suitable examples of ketose reducing sugars include erythrulose, ribulose, xylulose, psicose, fructose, sorbose and tagatose. The aldose or the ketose may also be a deoxy-reducing sugar, for example, a 6-deoxy reducing sugar, such as fucose or rhamnose.

Specific monosaccharide aldoses include, for example, reducing agents include, for example, where at least one reducing sugar is a monosaccharide, or the one or more reducing sugars are selected from a group comprising monosaccharide reducing sugars, typically at least one monosaccharide reducing sugar is an aldose or a ketose.

Where the reducing sugar is a monosaccharide, the monosaccharide may be in the D- or L-configuration, or a mixture thereof. Typically, the monosaccharide is present in the configuration in which it most commonly occurs in nature. For example, the one or more reducing sugars may be selected from the group consisting of D-ribose, L-arabinose, D-xylose, D-lyxose, D-glucose, D-mannose, D-galactose, D-psicose, D-fructose, L-fucose and L-rhamnose. In a more particular embodiment, the one or more reducing sugars are selected from the group consisting of D-xylose, D-glucose, D-mannose, D-galactose, L-rhamnose and lactose.

Specific reducing sugars include ribose, glucose, fructose, maltose, lyxose, galactose, mannose, arabinose, xylose, rhamnose, rutinose, lactose, maltose, cellobiose, glucuronolactone, glucuronic acid, D-allose, D-psicose, xylitol, allulose, melezitose, D-tagatose, D-altrose, D-alditol, L-gulose, L-sorbose, D-talitol, inulin, stachyose, including mixtures and derivatives therefrom.

Exemplary disaccharide reducing sugars for use in the present application include maltose, lactose, lactulose, cellubiose, kojibiose, nigerose, sophorose, laminarbiose, gentiobiose, turanose, maltulose, palantinose, gentiobiulose, mannobiose, melibiose, melibiulose, rutinose, rutinulose or xylobiose.

Mannose and glucuronolactone or glucuronic acid can be used as sugar donors under Maillard reaction conditions, although they have seldom been used. Maillard reaction products of mannose, glucuronolactone or glucuronic acid provide yet another unique approach to provide new taste profiles with the sweetener agents described throughout the specification alone or in combination with additional natural sweeteners, synthetic sweeteners, and/or flavoring agents described herein.

In some embodiments, one or more carbohydrate sweeteners may be added to a reaction mixture subjected to the Maillard reaction. In other embodiments, one or more carbohydrate sweeteners may be added to an MRP composition after Maillard reaction. Non-limiting examples of carbohydrate sweeteners for use in the present application include caloric sweeteners, such as, sucrose, fructose, glucose, D-tagatose, trehalose, galactose, rhamnose, cyclodextrin (e.g., α-cyclodextrin, β-cyclodextrin, and γ-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, sugar alcohols, such as erythritol, xylitol, mannitol, sorbitol, maltitol, lactitol, mannitol, and inositol; xylo-oligosaccharides (xylotriose, xylobiose and the like), gentio-oligoscaccharides (gentiobiose, gentiotriose, gentiotetraose and the like), galacto-oligosaccharides, sorbose, nigero-oligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (containing fructose and glucose, e.g., HFCS55, HFCS42, or HFCS90), coupling sugars, soybean oligosaccharides, and glucose syrup. Additionally, the above carbohydrates may be in either the D- or L-configuration.

It should be noted, however, that not all carbohydrate sweeteners are reducing sugars. Sugars having acetal or ketal linkages are not reducing sugars, as they do not have free aldehyde chains. They therefore do not react with reducing-sugar test solutions (e.g., in a Tollens' test or Benedict's test). However, a non-reducing sugar can be hydrolyzed using diluted hydrochloric acid.

In some embodiments, the sugar donor is a non-reducing sugar that does not contain free aldehyde or free keto groups. Exemplary non-reducing sugars include, but are not limited to, sucrose, trehalose, xylitol, and raffinose. In some embodiments, the sugar donor comprises both reducing sugar and non-reducing sugar. In some embodiments, the sugar donor is derived from a food ingredient, such as sugar, flour, starch, vegetable and fruits.

In some embodiments, the sugar donor is derived from a plant source. For example, in some embodiments, the sugar donor comprises a fruit juice, berry juice, vegetable juice, syrup, plant extract, vegetable extract etc.

In some embodiments, the sugar donor is orange juice, cranberry juice, apple juice, peach juice, watermelon juice, pineapple juice, grape juice and concentrated products thereof.

In some embodiments, the fruit juice, berry juice or vegetable juice serves as both amine donor and sugar donor.

Reducing sugars can be derived from various sources for use as sugar donors in the Maillard reaction. For example, a sugar syrup may be extracted from a natural source, such as Monk fruit, fruit juice or juice concentrate (e.g., grape juice, apple juice, etc.), vegetable juice (e.g., onion etc.), or fruit (e.g., apples, pears, cherries, etc.) for use as a sugar donor.

The syrup may include any type of juice regardless of whether there is any ingredient being isolated from juice, such as purified apple juice with trace amounts of malic acid etc. The juice can be in the form of liquid, paste or solid. Sugar donors may also be extracted from Stevia, sweet tea, luohanguo, etc. after isolation of high intensity sweetener agents described herein (containing non-reducing sugars) from crude extracts and mixtures thereof. Extracts from any part of plant containing reducing sugars can be used as sugar donors in Maillard reactions with or without other additional reducing sugars. In some embodiments, the MRPs are prepared using a plant extract as a sugar donor.

In some embodiments, the sugar donor and amino donor are present in the reaction mixture in a molar ratio of 10:1 to 1:10, 8:1 to 1:8, 6:1 to 1:6, 4:1 to 1:4, 3:1 to 1:3 or 2:1 to 1:2. In some embodiments, the sugar donor and amino donor are present in the reaction mixture in a molar ratio of 10:1, 9:1, 8:1, 7:1, 6:1, 5:1, 4:1, 3:1, 2:1, 1:1, 1:2, 1:3, 1:4, 1:5, 1:6, 1:7, 1;8, 1:9 or 1:10.

In some embodiments, the sugar donor and amino donor are present in the reaction mixture in a sugar donor:amino donor weight ratio of 10:1 to 1:10, 8:1 to 1:8, 6:1 to 1:6, 4:1 to 1:4, 3:1 to 1:3 or 2:1 to 1:2. In some embodiments, the sugar donor and amino donor are present in the reaction mixture in a molar ratio of 10:1, 9:1, 8:1, 7:1, 6:1, 5:1, 4:1, 3:1, 2:1, 1:1, 1:2, 1:3, 1:4, 1:5, 1:6, 1:7, 1;8, 1:9 or 1:10.

In some embodiments, the sugar donor in the MRP reaction comprises one or more members selected from the group consisting of fructose, arabinose, maltose, high maltose syrup, dextrin, maltodextrin, fructose, high fructose syrup, glucose, and high glucose syrup.

In some embodiments, the sugar donor in the MRP reaction comprises a monosaccharide or a disaccharide. In some embodiments, the sugar donor in the MRP reaction comprises a fruit juice, a vegetable juice or honey.

### (c) Additional Components in the Reaction Mixture of Maillard Reaction

In some embodiments, the reactants for the Maillard reaction include a number of different raw materials for producing the MRP compositions of the present application. The raw materials may be categorized into the following groups comprising the following exemplary materials:

### (1) Protein Nitrogen Sources

Protein nitrogen containing foods (meat, poultry, eggs, dairy products, cereals, vegetable products, fruits, yeasts), extracts thereof and hydrolysis products thereof, autolyzed yeasts, peptides, amino acids and/or their salts.

### (2) Carbohydrate Sources

Foods containing carbohydrates (cereals, vegetable products and fruits) and their extracts; mono-, di- and polysaccharides (sugars, dextrins, starches and edible gums), and hydrolysis products thereof.

### (3) Fat or Fatty Acid Sources

Foods containing fats and oils, edible fats and oil from animal, marine or vegetable origin, hydrogenated, trans-esterified and/or fractionated fats and oils, and hydrolysis products thereof.

### 4) Miscellaneous List of Additional Ingredients

Foodstuffs, herbs, spices, their extracts and flavoring agents identified therein
Water
Thiamine and its hydrochloric salt
Ascorbic, Citric, Lactic, Fumaric, Malic, Succinic, Tartaric and the Na, K, Ca, Mg and NH4 salts of these acids
Guanylic acid and inosinic acid and its Na, K and Ca salts
Inositol
Sodium, potassium and ammonium sulphides, hydrosulphides and polysulphides
Lecithin
Acids, bases and salts as pH regulators:
Acetic, hydrochloric, phosphoric and sulphuric acids
Sodium, potassium, calcium and ammonium hydroxide.
Salts of the above acids and bases
Polymethylsiloxane as antifoaming agent.

In another aspect, the present application contemplates the use of any one of a number of raw materials exemplified below to produce NATURAL PRODUCTS:

Sugar Syrups: Xylose syrup, arabinose syrup and rhamnose syrup manufactured from beech wood. Ardilla Technologies supply these along with natural crystalline L-xylose, L-arabinose and L-rhamnose. Xylose syrup may also be obtained from natural sources, such as the xylan-rich portion of hemicellulose, mannose syrup from ivory nut, etc. These and other types of syrup described herein can be used as sugar donors in the compositions described herein.

Hydrolyzed gum arabic: Thickeners, such as gum arabic can be hydrolyzed with an organic acid or by enzyme hydrolysis to produce a mixture containing arabinose. Arabinose could also be obtained from other wood-based or biomass hydrolysate. Cellulose enzymes can also be used.

Meat Extracts: Commercially available from a number of companies, such as Henningsens (Chicken skin and meat), which gives excellent chicken notes.

Jardox: Meat and poultry extracts and stocks.

Kanegrade: Fish powders, anchovy, squid, tuna and others.

Vegetable Powders: onion and garlic powders, celery, tomato and leek powders are effective flavor contributors to reaction flavors.

Egg Yolk: Contains 50% fat and 50% protein. The fat contains phospholipids and lecithin. The proteins are coagulating proteins and their activity must be destroyed by hydrolysis with acid or by the use of proteases prior to use. This will also liberate amino acids and peptides useful in reaction flavors (Allergen activity).

Vegetable oils: Peanut (groundnut) oil—Oleic acid 50%, Linoleic acid 32%—beef and lamb profile. Sunflower—linoleic acid 50-75%, oleic 25%—chicken profile. Canola (rapeseed)—oleic 60%, linoleic 20%, alpha-linoleic 10%, gadoleic 12%.

Sauces: Fish sauce, soy sauce, oyster sauce, miso.

Enzyme Digests: Beef heart digest—rich in phospholipids. Liver digest—at low levels <5% gives a rich meaty character. Meat digests can also add authenticity but they are usually not as powerful as yeast extracts and HVPs.

Enzyme enhanced umami products—shitake or porcini mushrooms, kombu, etc. Enzyme digested fats—beef, lamb, etc.

All of the components of the compositions disclosed herein can be purchased or made by processes known to those of ordinary skill in the art and combined (e.g., precipitation/co-precipitation, mixing, blending, grounding, mortar and pestle, microemulsion, solvothermal, sonochemical, etc.) or treated as defined by the current invention.

### (d) Solvent

The Maillard reaction is conducted with a suitable solvent or carrier. Examples of suitable solvents or carriers include but are not limited to water, alcohols such as low molecular weight alcohols (e.g., methanol, ethanol, propanol, butanol, pentanol, hexanol, ethylene glycol, propylene glycol, butyl glycol, etc.), acetone, benzyl alcohol, 1,3-butylene glycol, carbon dioxide, castor oil, citric acid esters of mono- and di-glycerides, ethyl acetate, ethyl alcohol, ethyl alcohol denatured with methanol, glycerol (glycerin), glyceryl diacetate, glyceryl triacetate (triacetin), glyceryl tributyrate (tributyrin), hexane, isopropyl alcohol, methyl alcohol, methyl ethyl ketone (2-butanone), methylene chloride, monoglycerides and diglycerides, monoglyceride citrate, 1,2-propylene glycol, propylene glycol mono-esters and diesters, triethyl citrate, and mixtures thereof.

Although recognizing that other suitable solvents may be used for flavoring agents, The International Organization of the Flavor Industry (IOFI) Code of Practice (Version 1.3, dated Feb. 29, 2012) lists the following solvents as being appropriate for use in flavoring agents: acetic acid, benzyl alcohol, edible oils, ethyl alcohol, glycerol, hydrogenated vegetable oils, isopropyl alcohol, mannitol, propylene glycol, sorbitol, sorbitol syrup, water, and xylitol. Accordingly, in certain embodiments, these are preferred solvents.

In some embodiments, the solvent is water. In some embodiments, the solvent is glycerol. In some embodiments, the solvent is a glycerol-water mixture with a glycerol:water ratio (v:v) of 10:1 to 1:10, 9:1 to 1:9, 8:1 to 1:8, 7:1 to 1:7, 6:1 to 1:6, 1:5 to 5:1, 1:4 to 4:1, 1:3 to 3:1, 1:2 to 2:1. In some embodiments, the solvent is a glycerol-water mixture with a glycerol:water ratio (v:v) of 1:9, 1:8, 1:7, 1:6, 1:5, 1:4, 1:3, 1:2, 1:1, 2:1, 3:1, 4:1, 5:1, 6:1, 7:1, 8:1 or 9:1.

In some embodiments, the reaction mixture comprises a solvent in an amount of 10-90 wt %, 10-80 wt %, 10-70 wt %, 10-60 wt %, 10-50 wt %, 10-40 wt %, 10-30 wt %, 10-20 wt %, 20-90 wt %, 20-80 wt %, 20-70 wt %, 20-60 wt %, 20-50 wt %, 20-40 wt %, 20-30 wt %, 30-90 wt %, 30-80 wt %, 30-70 wt %, 30-60 wt %, 30-50 wt %, 30-40 wt %, 40-90 wt %, 40-80 wt %, 40-70 wt %, 40-60 wt %, 40-50 wt %, 50-90 wt %, 50-80 wt %, 50-70 wt %, 50-60 wt %, 60-90 wt %, 60-80 wt %, 60-70 wt %, 70-90 wt %, 70-80 wt %, or 80-90 wt % of the reaction mixture. In some embodiments, the reaction mixture comprises a solvent in an amount of about 10 wt %, about 15 wt %, about 20 wt %, about 25 wt %, about 30 wt %, about 33 wt %, about 35 wt %, about 40 wt %, about 45 wt %, about 50 wt %, about 55 wt %, about 60 wt %, about 65 wt %, about 70 wt %, about 75 wt %, about 80 wt %, about 85 wt %, or about 90 wt % of the reaction mixture.

### (ii) Maillard Reaction Conditions

Maillard reaction conditions are affected by temperature, pressure, pH, reaction times, ratio of different reactants, types of solvents, and solvents-to-reactants ratio. Accordingly, in certain embodiments, the reaction mixture may include a pH regulator, which can be an acid or a base. Suitable base regulators include, for example, sodium hydroxide, potassium hydroxide, baking powder, baking soda, any useable food grade base salts including alkaline amino acids. Additionally, the Maillard reaction can be conducted in the presence of alkalinic amino acids without the need of an additional base where the alkaline amino acid serves as the base itself. The pH of the reaction mixture can be maintained at any pH suitable for the Maillard reaction. In certain embodiments, the pH is maintained at a pH of from about 2 to about 14, from about 2 to about 7, from about 3 to about 9, from about 4 to about 8, from about 5 to about 7, from about 7 to about 14, from about 8 to about 10, from about 9 to about 11, from about 10 to about 12, or any pH range derived from these integer values.

In some embodiments, the reaction mixture has a pH of 4, 5, 6, 7, 8 or 9 at the initiation of the Maillard reaction.

In some embodiments, the reaction temperature in any of the MRP reaction mixtures described in the present application may range from 0° C. to 1000° C., 10° C. to 300° C., from 15° C. to 250° C., from 20° C. to 250° C., from 40° C. to 250° C., from 60° C. to 250° C., from 80° C. to 250° C., from 100° C. to 250° C., from 120° C. to 250° C., from 140° C. to 250° C., from 160° C. to 250° C., from 180° C. to 250° C., from 200° C. to 250° C., from 220° C. to 250° C., from 240° C. to 250° C., from 30° C. to 225° C., from 50° C. to 225° C., from 70° C. to 225° C., from 90° C. to 225° C., from 110° C. to 225° C., from 130° C. to 225° C., from 150° C. to 225° C., from 170° C. to 225° C., from 190° C. to 225° C., from 210° C. to 225° C., from 80° C. to 200° C., from 100° C. to 200° C., from 120° C. to 200° C., from 140° C. to 200° C., from 140° C. to 200° C., from 160° C. to 200° C., from 180° C. to 200° C., from 90° C. to 180° C., from 100° C. to 180° C., from 110° C. to 180° C., from 120° C. to 180° C., from 130° C. to 180° C., from 140° C. to 180° C., from 150° C. to 180° C., from 160° C. to 180° C., from 80° C. to 160° C., from 90° C. to 160° C., from 100° C. to 160° C., from 110° C. to 160° C., from 120° C. to 160° C., from 130° C. to 160° C., from 140° C. to 160° C., from 150° C. to 160° C., from 80° C. to 140° C., from 90° C. to 140° C., from 100° C. to 140° C., from 110° C. to 140° C., from 120° C. to 140° C., from 130° C. to 140° C., from 80° C. to 120° C., from 85° C. to 120° C., from 90° C. to 120° C., from 95° C. to 120° C., from 100° C. to 120° C., from 110° C. to 120° C., from 115° C. to 120° C., from 80° C. to 100° C., from 85° C. to 100° C., from 90° C. to 100° C., from 95° C. to 100° C.; or any aforementioned temperature value in this paragraph, or a temperature range defined by any pair of the aforementioned temperature values in this paragraph.

Maillard reaction(s) can be conducted either under open or sealed conditions. The reaction time is generally from 1 second to 100 hours, more particularly from 1 minute to 24 hours, from 1 minute to 12 hours, from 1 minute to 8 hours, from 1 minute to 4 hours, from 1 minute to 2 hours, from 1 minute to 1 hour, from 1 minute to 40 minutes, from 1 minute to 20 minutes, from 1 minute to 10 minutes, from 10 minutes to 24 hours, from 10 minutes to 12 hours, from 10 minutes to 8 hours, from 10 minutes to 4 hours, from 10 minutes to 2 hours, from 10 minutes to 1 hour, from 10 minutes to 40 minutes, from 10 minutes to 20 minutes, from 20 minutes to 24 hours, from 20 minutes to 12 hours, from 20 minutes to 8 hours, from 20 minutes to 4 hours, from 20 minutes to 2 hours, from 20 minutes to 1 hour, from 20 minutes to 40 minutes, from 40 minutes to 24 hours, from 40 minutes to 12 hours, from 40 minutes to 8 hours, from 40 minutes to 4 hours, from 40 minutes to 2 hours, from 40 minutes to 1 hour, from 1 hour to 24 hours, from 1 hour to 12 hours, from 1 hour to 8 hours, from 1 hour to 4 hours, from 1 hour to 2 hours, from 2 hour to 24 hours, from 2 hour to 12 hours, from 2 hour to 8 hours, from 2 hour to 4 hours, from 4 hour to 24 hours, from 4 hour to 12 hours, from 4 hour to 8 hours, from 8 hour to 24 hours, from 8 hour to 12 hours, or from 12 hour to 24 hours. Depending on the desired taste, the reaction can be terminated at any time. The Maillard reaction mixture can contain unreacted reactants, degraded substances from the reactants, pH regulator(s), and/or salt(s).

The Maillard reactions can be conducted at atmospheric pressure or under pressure. When conducted under pressure, the reaction mixture may be subjected to constant pressure or it may be subjected to varying pressures over time. In certain embodiments, the pressure in the reaction vessel is at least 10 MPa, at least 20 MPa, at least 30 MPa, at least 40 MPa, at least 50 MPa, at least 75 MPa, at least 100 MPa, at least 150 MPa, at least 200 MPa, at least 250 MPa, at least 300 MPa, at least 400 MPa, at least 500 MPa, at least 600 MPa, at least 700 MPa, at least 800 MPa, and any pressure range derived from the aforementioned pressure values.

In some embodiments, the Maillard reaction is conducted with the assistance of microwave heating. Microwave heating results in the superheating of substances, particularly those that response to dipole rotation or ionic conductivity.

In some embodiments, it is desirable to suppress the Maillard reaction, in part. This can be achieved by exercising one or more of the following approaches, including the use of raw materials that are not susceptible to browning, adjusting the factors affecting the browning velocity of Maillard reaction, lowering the temperature, lowering pH, adjusting water activity, increasing the level of oxygen, using oxidant, introducing enzymes, etc.

In certain embodiments, the use of low solubility or insoluble amino acids in the Maillard reaction may result in insoluble reactants present in the final MRP composition. In such cases, filtration may be used to remove any insoluble components present in the MRP compositions.

A general method to prepare derived Maillard reaction product(s) is described as follows. Briefly, a steviol glycoside composition of the present application, such as RA, or a glycosylated steviol glycoside composition of the present application, such as GRA, is dissolved with or without a sugar donor, and together with amino acid donor in a solvent, such as water, to form a reaction mixture, followed by heating of the reaction mixture at an elevated temperature, for example, from 30, 40, or 50° C. up to 250° C. The reaction time can be varied from more than one minute to a few days, more generally a few hours, until Maillard reaction products (MRPs) are formed or one of the reaction components has been exhausted or the reaction has been completed, with or without formation of caramelization reaction products (CRPs), which are further described below. When required, a pH adjuster or pH buffer can be added to regulate the pH of the reaction mixture before, during or after reaction as further described herein. The resultant solution is dried by spray dryer or hot air oven to remove the water and to obtain the MRP composition of the present application.

When the reaction is completed, the product mixture does not need to be neutralized or it can be neutralized. Water and/or solvent(s) do not necessarily need to be removed but can be removed by distillation, spray drying or other known methods if the product is desired as a powder or liquid, whatever the case may be.

Interestingly, when a reaction mixture is dried to a powder, such as by spray drying, the resultant powder typically only has a slight smell associated with them. This is in contrast to regular powdered flavoring agents that generally have a strong smell. The dried powdered reaction mixtures of the embodiments, when dissolved in a solvent, such as water or alcohol or mixtures thereof, release the smell. This demonstrates that the volatile substances in the MRP can be preserved by the SG or GSG present in the MRP composition of the present application. Powders with strong aromas can be obtained too, particularly where the carrier, such as RA or GRA, is much less compared with MRP flavors or strong flavor substances used during Maillard reactions.

In some embodiments, the MRP composition may further include one or more carriers (or flavor carriers) acceptable for use with sweetener agents or flavoring agents. In addition, such carriers may be suitable e.g., as solvents for the Maillard reaction.

Exemplary carriers include acetylated distarch adipate, acetylated distarch phosphate, agar, alginic acid, beeswax, beta-cyclodextrine, calcium carbonate, calcium silicate, calcium sulphate, candelilla wax, carboxymethyl cellulose, sodium salt, carnauba wax, carrageenan, microcrystalline cellulose, dextran, dextrin, diammonium phosphate, distarch phosphate, edible fats, elemi resin, ethyl lactate, ethyl cellulose, ethyl hydroxyethyl cellulose, ethyl tartrate, gelatin, gellan gum, ghatti gum, glucose, glyceryl diacetate, glyceryl diesters of aliphatic fatty acids C6-C18, glyceryl monoesters of aliphatic fatty acids C6-C18, gyceryl triacetate (triacetin), glyceryl triesters of aliphatic fatty acids C6-C18, glyceryl tripropanoate, guar gum, gum arabic, hydrolyzed vegetable protein, hydroxyproplymethyl cellulose, hydroxypropyl cellulose, hydroxypropyl distarch phosphate, hydroxypropyl starch, karaya gum, konjac gum, lactic acid, lactose, locust bean gum (carob bean gum), magnesium carbonate, magnesium salts of fatty acids, maltodextrin, methyl cellulose, medium chain triglyceride, modified starches, such as acetylated distarch adipate, acetylated oxidized starch, acid-treated starch, alkaline treated starch, bleached starch, roasted starch dextrins, distarch phosphate, hydroxypropyl distarch phosphate, acetylated distarch phosphate, hydroxypropyl starch, monostarch phosphate, oxidized starch, phosphated distarch phosphate, starch acetate, starch sodium octenyl succinate, and enzyme treated starches; mono-,di- and tri-calcium orthophosphate, Na, K, NH4 and Ca alginate, pectins, processed euchema seaweed, propylene glycol alginate, sodium chloride (salt), silicon dioxide, sodium aluminium diphosphate, sodium aluminium silicate, Sodium, potassium and calcium salts of fatty acids, starch, starch (sodium) octenyl succinate, starch acetate, sucro glycerides, sucrose, sucrose esters of fatty acids, type I and type II sucrose oligoesters, taragum, tragacanth, triethylcitrate, whey powder, xanthan gum, fibers such as non-starch polysaccharides, lignin, cellulose, methylcellulose, the hemicelluloses, β-glucans, mucilage, inulins, oligosaccharides, polydextrose, fructooligosaccharides, cyclodextrins, chitins, and combinations thereof, and thickeners such as carbomers, cellulose base materials, gums, waxes, algin, agar, pectins, carrageenan, gelatin, mineral or modified mineral thickeners, polyethylene glycol and polyalcohols, polyacrylamide and other polymeric thickeners, and combinations thereof.

When utilizing the MRP compositions for use in a sweetener or flavoring composition, one or more additional components may be added to the MRP composition after the Maillard reaction has occurred. In some embodiments, these additional components include flavoring substances. Moreover, the reaction products after the Maillard reaction has been completed can further include, for example, one or more sweetener agents, reducing sugars (i.e., residue sugar donors), amine donors, sweetener enhancers, and CRPs, as well as one or more degraded sweetener agents, degraded sugar donors, degraded amine donors, and salts.

It should also be understood, for example, that the Maillard reaction can be performed under conditions containing an excess of amine donors in comparison to reducing sugars or much less than the amount of reducing sugars present. In the first instance, the resultant MRPs would include unreacted amine donors, degraded amine donors and/or residues from reacted amine donors. Conversely, when there is an excess of reducing sugars present in the Maillard reaction, the amine donors would be more fully reacted during the course of the reaction and a greater amount of unreacted reducing sugars as well as degraded reducing sugars and/or degrading reducing sugars and residues therefrom. Surprisingly, where the reducing sugar is replaced with a sweetener agent (e.g., a material such as an RA that does not include a reactive aldehydic or ketone moiety) and reacted with one or more amine donors, the amine donors may be present in the reaction products in reduced amounts reflecting their consumption in the Maillard type reaction or there excess of amine donors, as well as amine donor residues and/or amine degradation products after the Maillard reaction has been completed.

There are many ways to control the resulting MRP composition. For instance, adjusting the pH, pressure, reaction time, and ingredient additions to optimize the ratio of raw materials etc. Further, the separation of Maillard reaction products can provide a means for preparing different types of flavors or flavor enhancers. For example, a Maillard reaction product composition includes both volatile substances and non-volatile substances. Therefore, by evaporating the volatile substances, non-volatile substances can be purified for use. These non-volatile substances (or products) can be used as flavor modifiers or with the top note flavor in final products, such as volatile peach, lemon flavor provided by traditional flavor houses.

Volatile substances can be used as flavor or flavor enhancers as well. Partial separation/purification of a MRP can be carried out to obtain volatile substances, which can be further separated by distillation etc. or obtain non-volatile substances for instance by recrystallization, chromatograph etc. could be done to meet different targets of taste and flavor. Therefore, the MRP compositions of the present application include compositions containing one or more volatile substances, one or more non-volatile substances or mixtures thereof. Non-volatile substances in MRPs or isolated from MRPs can provide a good mouth feel, umami and Kokumi taste.

In some embodiments, the sweetener or flavoring composition of the present application further comprises a MRP formed from a reaction mixture comprising one or more flavonoid glycosides, isoflavone glycosides, saponin glycosides, phenol glycosides, cynophore glycosides, anthraquinone glycosides, cardiac glycosides, bitter glycosides, coumarin glycosides, and/or sulfur glycosides.

In some embodiments, the sweetener or flavoring composition further comprises a MRP formed from a reaction mixture comprising one or more glycosylated flavonoid glycosides, glycosylated isoflavone glycosides, glycosylated saponin glycosides, glycosylated phenol glycosides, glycosylated cynophore glycosides, glycosylated anthraquinone glycosides, glycosylated cardiac glycosides, glycosylated bitter glycosides, glycosylated coumarin glycosides, and/or glycosylated sulfur glycosides.

In some embodiments, the sugar donor may account for one or more flavors produced from a Maillard reaction. More particularly, a flavor may be produced from a Maillard reaction by using one or more sugar donors, wherein at least one sugar donor is selected from a product comprising a glycoside and a free carbonyl group. In some embodiments, glycosidic materials for use in Maillard reactions include natural juice/concentrates/extracts selected from strawberry, blueberry, blackberry, bilberry, raspberry, lingonberry, cranberry, red currants, white currants, blackcurrants, apple, peach, pear, apricot, mango, grape, water melon, cantolope, grapefruit, passion fruit, dragon fruit, carrot, celery, eggplant, tomato, etc.

The natural extracts used in Maillard reactions described herein can include any solvent extract-containing substances, such as polyphenols, free amino acids, flavonoids etc. The extracts can be further purified by methods such as resin-enriched, membrane filtration, crystallization etc., as further described herein.

In one embodiment, a Maillard reaction mixture or an MRP composition produced thereof may include a sweetener, a sweetener enhancer, such as thaumatin, and optionally one or more MRP products, wherein the sweetener is selected from date paste, apple juice concentrate, monk fruit concentrate, sugar beet syrup, pear juice or puree concentrate, apricot juice concentrate. Alternatively, a root or berry juice may be used as sugar donor or sweetener added to an MRP composition.

In some embodiments, particular flavors may be produced from a Maillard reaction through the use of one or more sugar donors, where at least one sugar donor is selected from plant juice/powder, vegetable juice/powder, berries juice/powder, fruit juice/powder. In certain preferred embodiments, a concentrate or extract may be used, such as a bilberry juice concentrate or extract having an abundance of anthocyanins. Optionally, at least one sugar donor and/or one amine donor is selected from animal source based products, such as meat, oil etc. Meat from any part of an animal, or protein(s) from any part of a plant could be used as source of amino donor(s) in this application.

In some embodiments, the Maillard reactants may further include one or more high intensity synthetic sweeteners, natural non-SG sweeteners, and/or the glycosylation products thereof. Alternatively, or in addition, the high intensity synthetic sweeteners may be added to an MRP composition comprising reaction products formed in the Maillard reaction.

Caramelization can occur in the course of Maillard reaction. Exemplary reactions include:

1. equilibration of anomeric and ring forms

2. sucrose inversion to fructose and glucose

3. condensation

4. intramolecular bonding

5. isomerization of aldoses to ketoses

6.dehydration reactions

7. fragmentation reactions

8. unsaturated polymer formation

One embodiment comprises one or more of these non-volatile substances originating from the MRP of the present application, including remaining sugar donors, remaining amine donors, and caramelized substances thereof. The caramelized substances can include e.g., caramelized disaccharides, trisaccharides, tetrasaccharides etc., which are formed by sugar donors; dimer-peptides, tri-peptides, tetra-peptides etc., which are formed by amine donors; glycosylamine and their derivatives, such as Amadori compounds, Heyns compounds, enolisated compounds, sugar fragments, amino acid fragments, and non-volatile flavor compounds formed by Maillard reactions of sugars and amino acid donors.

(iii) Precision Fermentation

In some embodiments, a desirable MRP or a glycosylated amine donor is prepared by precision fermentation. Precision fermentation technology is a form of synthetic biology that typically requires the use of genetically engineered microorganisms. The genetically engineered microorganisms, such as yeast, algae or bacteria, are capable of producing or excreting a particular desirable material, such as edible fats, proteins and glycosylated amines donors. In some embodiments, glycosylated conventional amine donors, glycosylated natural high intensity sweeteners, glycosylated Stevia extracts, glycosylated SGs, glycosylated sweet tea extracts, or glycosylated monk fruit extracts, are produced by precision fermentation. In some embodiments, the C-MRPs, SG-MRPs or GSG-MRPs of the present application are produced by precision fermentation.

### III. Comsumable Product Comprising the Flavor/Taste Modifying Agent or the Sweetener Flavor Composition of the Present Application

Another aspect of the present application relates to a consumable product containing a flavor/taste modifying agent of the present application or a sweetener or flavor composition of the present application. In some embodiments, the consumable product is a food product or foodstuff as e.g., described in the present application. In certain particular embodiments, the food product (or foodstuff) is a confection, a condiment, a baked good, a cereal composition, a dairy product, a chewing composition, a table-top sweetener or any other specific food product or foodstuff as described in the present application.

In other embodiments, the consumable product is a beverage product. In other embodiments, the consumable product containing the composition is e.g., a pharmaceutical product, an oral hygiene product, a cosmetic product, smokable product or another consumable product as described in the present application.

In some embodiments, the flavor/taste modifying agent of the present application or the sweetener composition of the present application is present in the consumable product at a final concentration in the range of 1 ppm to 10,000 ppm, 1 ppm to 5000 ppm, 1 ppm to 2000 ppm, 1 ppm to 1000 ppm, 1 ppm to 500 ppm, 1 ppm to 200 ppm, 1 ppm to 100 ppm, 10 ppm to 10,000 ppm, 10 ppm to 5000 ppm, 10 ppm to 2000 ppm, 10 ppm to 1000 ppm, 10 ppm to 500 ppm, 10 ppm to 200 ppm, 50 ppm to 10,000 ppm, 50 ppm to 5000 ppm, 50 ppm to 2000 ppm, 50 ppm to 1000 ppm, 50 ppm to 500 ppm, 50 ppm to 200 ppm, 100 ppm to 10,000 ppm, 100 ppm to 5000 ppm, 100 ppm to 2000 ppm, 100 ppm to 1000 ppm, 100 ppm to 500 ppm, 200 ppm to 10,000 ppm, 200 ppm to 5000 ppm, 200 ppm to 2000 ppm, 200 ppm to 1000 ppm, 500 ppm to 10,000 ppm, 500 ppm to 5000 ppm, 500 ppm to 2000 ppm, 1000 ppm to 10,000 ppm, or 2000 ppm to 10,000 ppm.

### IV. Methods

Another aspect of the present application relates to a method for a modifying a flavor or a taste profile of a high-intensity sweetener (HIS), comprising the step of adding to the HIS a flavor/taste modifying agent of the present application. In some embodiments, the flavor/taste modifying agent is selected from the group consisting of Stevia extracts (SEs), glycosylated Stevia extracts (G-SEs), Stevia extract flavor/taste modifying agent of the present application-MRPs (SE-MRPs), glycosylated Stevia extract-MRPs (G-SE-MRPs), Stevia glycosides (SGs), glycosylated Stevia glycosides (GSGs), Stevia glycoside-MRPs (SG-MRPs), glycosylated Stevia glycoside-MRPs (GSG-MRPs), sweet tea extracts (STEs), glycosylated sweet tea extracts (G-STEs), sweet tea extract-MRPs (ST-MRPs), glycosylated sweet tea extract-MRPs (G-ST-MRPs), sweet tea glycosides (STGs), glycosylated sweet tea glycosides (G-STGs), sweet tea glycoside-MRPs (STG-MRPs), glycosylated sweet tea glycoside-MRPs (G-STG-MRPs), monk fruit extracts (A/IFEs), glycosylated monk fruit extracts (G-MFEs), monk fruit glycosides (A/FGs), glycosylated monk fruit glycosides (G-MFG), monk fruit glycoside-MRPs (MFG-MRPs) and glycosylated monk fruit glycoside-MRPs (G-MFG-MRPs), and wherein the flavor/taste modifying agent is present at an amount sufficient to enhance a flavor and/or taste profile of the HIS.

In some embodiments, the flavor/taste modifying agent is added to the sweetener composition at a final concentration in the range of 1 ppm to 10,000 ppm, 1 ppm to 5000 ppm, 1 ppm to 2000 ppm, 1 ppm to 1000 ppm, 1 ppm to 500 ppm, 1 ppm to 200 ppm, 1 ppm to 100 ppm, 10 ppm to 10,000 ppm, 10 ppm to 5000 ppm, 10 ppm to 2000 ppm, 10 ppm to 1000 ppm, 10 ppm to 500 ppm, 10 ppm to 200 ppm, 50 ppm to 10,000 ppm, 50 ppm to 5000 ppm, 50 ppm to 2000 ppm, 50 ppm to 1000 ppm, 50 ppm to 500 ppm, 50 ppm to 200 ppm, 100 ppm to 10,000 ppm, 100 ppm to 5000 ppm, 100 ppm to 2000 ppm, 100 ppm to 1000 ppm, 100 ppm to 500 ppm, 200 ppm to 10,000 ppm, 200 ppm to 5000 ppm, 200 ppm to 2000 ppm, 200 ppm to 1000 ppm, 500 ppm to 10,000 ppm, 500 ppm to 5000 ppm, 500 ppm to 2000 ppm, 1000 ppm to 10,000 ppm, or 2000 ppm to 10,000 ppm.

Another aspect of the present application relates to a method for increase the sweetless of a sugar-containing sweetener, comprising the step of adding to the sugar-containing sweetener a flavor/taste modifying agent of the present application, or a sweetener composition of the present application.

In some embodiments, the flavor/taste modifying agent, or the sweetener composition of the present application is added to the sugar-containing sweetener in an amount in the range of 0.1-99 wt %, 0.1-90 wt %, 0.1-30 wt %, 0.1-10 wt %, 0.1-3 wt %, 0.1-1 wt %, 0.1-0.3 wt %, 0.3-99 wt %, 0.3-90 wt %, 0.3-30 wt %, 0.3-10 wt %, 0.3-3 wt %, 0.3-1 wt %, 1-99 wt %, 1-90 wt %, 1-30 wt %, 1-10 wt %, 1-3 wt %, 3-99 wt %, 3-90 wt %, 3-30 wt %, 3-10 wt %, 10-99 wt %, 10-90 wt %, 10-30 wt %, 30-99 wt % or 30-90 wt % of the final product.

Another aspect of the present application relates to a method for identifying chemical species associated with an olfactory taste attribute, comprising: (a) generating a first aerosol sample from a first test sample with a sample testing device that comprises: an aerosol generator for generating an aerosol from a test sample; a chemical sample analyzer connected to the aerosol generator, wherein the chemical sample analyzer collects aerosol particles from the aerosol and determines chemical composition of the collected aerosol particles; and a delivery device connected to the aerosol generator, wherein the delivery device is designed to deliver the aerosol to an orthonasal and/or retronasal passageway of a human testor; (b) subjecting a portion of the first aerosol sample to the orthonasal and/or retronasal passageway of the subject and generate a first retronasal and/or orthonasal taste profile; (c) delivering another portion of the first aerosol sample to the chemical sample analysis device and generating a chemical fingerprint of the first aerosol sample; (d) generating a second aerosol sample from a second test sample with the sample testing device; (e) subjecting a portion of the second aerosol sample to the retronasal and/or passageway of the subject and generate a second retronasal and/or orthonasal taste profile; (f) delivering another portion of the second aerosol sample to a sample analysis device, and generating a chemical fingerprint of the second aerosol sample; and (g) correlating the first and second taste profiles with the first and second chemical fingerprint to identify one or more chemical species associated with an olfactory taste attribute present in the taste profiles.

In some embodiments, the chemical composition of the collected aerosol particles is determined by high pressure liquid chromatography (HPLC), gas chromatography (GC), or mass spectrometry (MS).

### V. Compositions That Inhibit Glucose Absorption and Use Thereof

Another aspect of the present application relates to a method for inhibiting glucose absorption in a subject Glucose, a key nutrient utilized by human cells to provide cellular energy and a carbon source for biomass synthesis, is internalized in cells via glucose transporters that regulate glucose homeostasis throughout the human body. Glucose transporters have been used as important targets for the discovery of new drugs to treat cancer, diabetes, and heart disease, owing to their abnormal expression during these disease conditions.

In some embodiments, the method comprise the step of administering to the subject, an effective amount of a plant extract that inhibits glucose transport in a mammalian cell. In some embodiments, the plant extract inhibits the activity of GLUTs, SGLTs, and/or SWEETs. In some embodiments, the plant extract contains one or more substances selected from the group consisting of alkaloids, flavonoids, polyphenols, and isoprenoids.

Another aspect of the present application relates to a composition that comprises (1) a high intensity sweetner (HIS) and (2) one or more glucose transport inhibitors. In some embodiments, the glucose transport inhibitor is also an antioxidant. In some embodiments, the HIS is selected from the group consisting of Stevia extracts, sweet tea extracts, monk fruit extracts and guava extracts. In some embodiments, the one or more glucose transport inhibitors have antioxidant activities. In some embodiments, the one or more glucose transport inhibitors are selected from the group consisting of alkaloids, flavonoids, polyphenols and isoprenoids. In some embodiments, the one or more glucose transport inhibitors comprises a glucose transport inhibitor that is not derived from the HIS in component (1).

In some embodiments, the plant extract is a guava extract. In some embodiments, the plant extract is a guava fruit extract. In some embodiments, the plant extract is a guava leaf extract. In some embodiments, the plant extract is a plant extract comprising rubusoside. In some embodiments, the plant extract is a sweet tea extract. In some embodiments, the sweet tea extract is RU60 or RU85 In some embodiment, the plant extract is a Stevia extract. In some embodiments, the plant extract is a monk fruit extract. In some embodiments, the plant extract is administered orally.

In some embodiments, the one or more glucose transport inhibitors are present in the composition, individually or collectively, at a final concentration in the range of 1 ppm to 10,000 ppm, 1 ppm to 5000 ppm, 1 ppm to 2000 ppm, 1 ppm to 1000 ppm, 1 ppm to 500 ppm, 1 ppm to 200 ppm, 1 ppm to 100 ppm, 10 ppm to 10,000 ppm, 10 ppm to 5000 ppm, 10 ppm to 2000 ppm, 10 ppm to 1000 ppm, 10 ppm to 500 ppm, 10 ppm to 200 ppm, 50 ppm to 10,000 ppm, 50 ppm to 5000 ppm, 50 ppm to 2000 ppm, 50 ppm to 1000 ppm, 50 ppm to 500 ppm, 50 ppm to 200 ppm, 100 ppm to 10,000 ppm, 100 ppm to 5000 ppm, 100 ppm to 2000 ppm, 100 ppm to 1000 ppm, 100 ppm to 500 ppm, 200 ppm to 10,000 ppm, 200 ppm to 5000 ppm, 200 ppm to 2000 ppm, 200 ppm to 1000 ppm, 500 ppm to 10,000 ppm, 500 ppm to 5000 ppm, 500 ppm to 2000 ppm, 1000 ppm to 10,000 ppm, or 2000 ppm to 10,000 ppm.

In some embodiments, the one or more glucose transport inhibitors are present in the composition, individually or collectively, in an amount in the range of 0.1-99 wt %, 0.1-90 wt %, 0.1-30 wt %, 0.1-10 wt %, 0.1-3 wt %, 0.1-1 wt %, 0.1-0.3 wt %, 0.3-99 wt %, 0.3-90 wt %, 0.3-30 wt %, 0.3-10 wt %, 0.3-3 wt %, 0.3-1 wt %, 1-99 wt %, 1-90 wt %, 1-30 wt %, 1-10 wt %, 1-3 wt %, 3-99 wt %, 3-90 wt %, 3-30 wt %, 3-10 wt %, 10-99 wt %, 10-90 wt %, 10-30 wt %, 30-99 wt % or 30-90 wt % of the final product.

### EXAMPLES

### Example 1. Guava Fruit and Leave Extract and Sweet Tea Extracts Inhibit Glucose Absorption in a Caco-2 Trans-Well Model

Two different guava extracts: guava fruit extract sample no. 909, Lot No. XS20221219 from EPC Products Co. Ltd., (hereinafter “guava fruit 909”), guava leaf extract sample no. 910, Lot No. 20221103/11781 from EPC Products Co. Ltd., (hereinafter “guava fruit 910”) and a sweet tea extract (sweet tea extract sample no. 885, Lot No. 20221101 from EPC Products Co. Ltd., (hereinafter “sweet tea 885”) were tested in a Caco-2 based trans-well model regarding their inhibitory potential on glucose transport. The applied concentrations were selected based on cell viability analysis to avoid cytotoxicity during the tests. In addition, HPLC analysis and characterization of the extracts obtained was performed.

### Material and Methods

Solid extracts: Two guava extracts were obtained (guava fruit 909 with 0.05944% guaijaverin, and guava leaf 910) and one Sweet tea extract rich in polyphenol (sweet tea 885, with 12.23% RU, 23.73% polyphenols and 46.05% polysacchrides). For the sweet tea extract we obtained additional information regarding rubusoside, polyphenol and polysaccharide content (Table on the right). The amounts of dry matter in the extracts are shown in Table 1-1.

TABLE 1-1
Dry matter of the solid extracts:

| Extract | Dry matter [%] |
|---|---|
| sweet tea 885 | 94.5 |
| guava fruit 909 | 92.3 |
| guava leaf 910 | 96.0 |

### Liquid Extract Preparation

About 0.5 g of solid extracts was extracted with 10 ml water as shown in Table 1-2.

TABLE 1-2
Liquid extract preparation

| | | | | Theoretical |
|---|---|---|---|---|
| | Amount | Dissolved in | x dry | concentration |
| Extract | [g] | water [mL] | matter [g] | [mg/ml] |
| sweet tea 885 | 0.4641 | 10 | 0.4386 | 43.86 |
| guava fruit 909 | 0.4549 | 10 | 0.4199 | 41.99 |
| guava leaf 910 | 0.4828 | 10 | 0.4635 | 46.35 |

### Cell Culture

Human intestinal Caco-2 (DSMZ, Germany) cells were cultured in MEM (PAN™ Biotech, P04-08056) supplemented with 10% FBS and 100 U/mL penicillin and 100 μg/mL streptomycin (PAN™ Biotech, P06-07050) at 37° C. in a humidified 5% CO₂ atmosphere.

### Cell Viability Assay

Caco-2 cells were seeded in 96-well plates (Greiner Bio-One, Kremsmünster, Austria) and grown overnight to reach confluency on the next day. The treatment with the test substances was performed for 3 h and 24 h. Upon the treatment for 3 h and 24 h, cell viability was determined with resazurin (Sigma-Aldrich). Resazurin was added in an amount equal to 10% of the volume in the well and the cells were incubated for 1.5 h. The non-fluorescent resazurin is converted to the highly fluorescent resorufin by cellular respiration. The fluorescence intensity (Ex560 nm/Em590 nm) of the product resorufin was detected and normalized to the signal of untreated control. Statistical analysis in cell viability assays was carried out using one-way ANOVA in GraphPad Prism (version 9.3.1, GraphPad Software Inc., San Diego, CA, USA).

### Glucose Transport Assay

Caco-2 cells were seeded on 0.4 1.tm trans-well inserts for monolayer formation and fast differentiation (enterocyte differentiation medium). On day 5, glucose transport across the cell monolayer was performed. Therefore, cell culture medium containing 13.5 g/L glucose and 1 g/L xylitol with or without the indicated concentrations of rubusoside plant extract or phloretin was placed as donor solution onto the apical compartment. Samples were collected from the basolateral compartment (HEPES buffer) after 0, 0.5, 1, 1.5, and 2 hours. Glucose and xylitol concentrations of the samples were measured by HPLC. Cell layer integrity was confirmed by TEER measurements (Millicell ERS-2 Voltometer) at each sampling time point. Statistical analysis in cell viability assays was carried out using two-way ANOVA in GraphPad Prism (version 9.3.1, GraphPad Software Inc., San Diego, CA, USA).

### Results

### Extract Preparation and HPLC Analysis

In order to perform analytical investigations and cell culture experiments, liquid extracts had to be prepared. Due to limited solubility, an undissolved residue remained in the liquid extracts shown in Table 1-2. The undissolved residue was removed by centrifugation. Only supernatant was used for further experiments. The concentration of dissolved matter in the supernatant was determined and shown in Table 1-3. Approximately 70-87% of the solid extract remained in the supernantant.

TABLE 1-3
Extract concentration in the supernatant

| | Concentration extract | % Extraction |
|---|---|---|
| Extract | supernatant [mg/mL] | Yield |
| sweet tea 885 | 37.2 | 84.82% |
| guava fruit 909 | 36.4 | 86.69% |
| guava leaf 910 | 32.6 | 70.33% |

HPLC analysis of the above-described extract supernatants has been performed to quantify flavonoids occurring in the plant material which are linked to glucose inhibition.

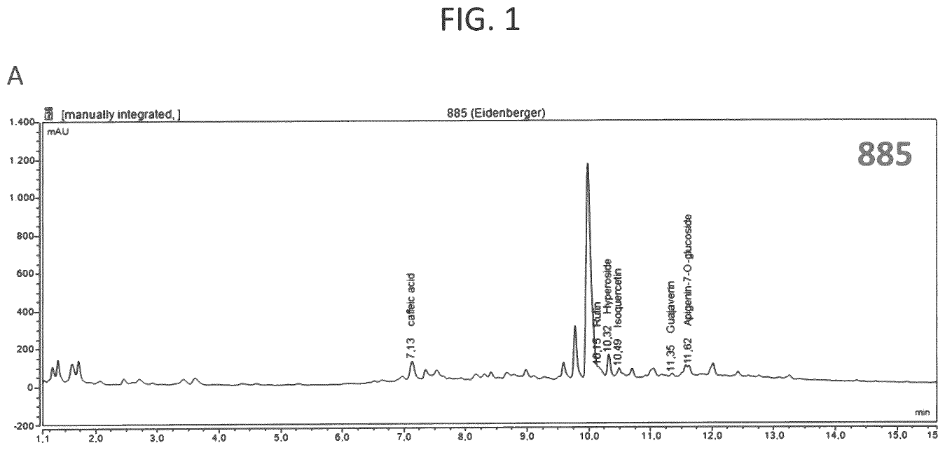

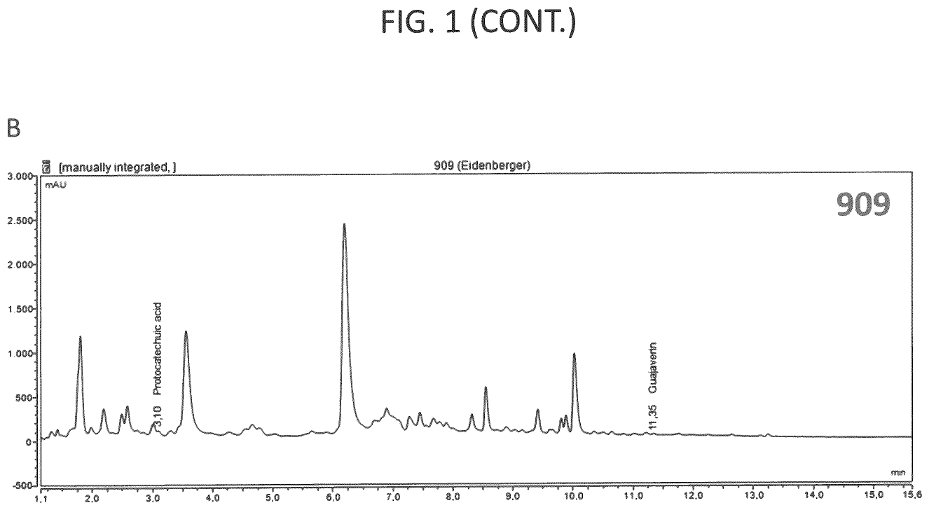

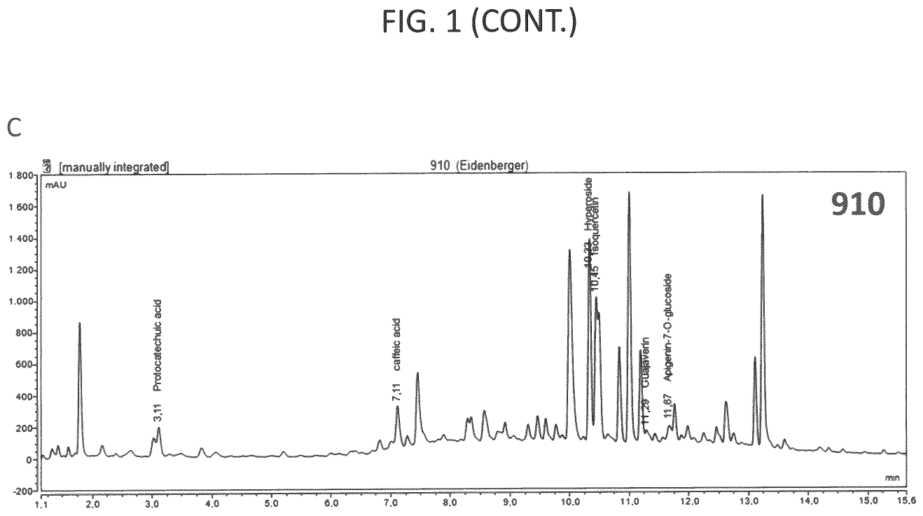

FIG. 1, panel A shows the HPLC profile of the extract supernatant Lot No. 20221101-885. Compounds identified in the profile are listed in Table 1-4.

TABLE 1-4
HPLC analysis and compounds identified in extract supernatant of
sweet tea 885.

| | | Ret. Time | Amount | Amount | Rel. Area | Area |
|---|---|---|---|---|---|---|
| Peak | Peak Name | min | mg/mL | % of dissolved matter | % | mAU*min |
| 8 | Caffeic acid | 7.127 | n.a. | | 3.63 | 6.997 |
| 16 | Rutin | 10.15 | 0.049 | 0.132 | 1.38 | 2.667 |
| 17 | Hyperoside | 10.32 | 0.0802 | 0.216 | 3.02 | 5.819 |
| 18 | Isoquercetin | 10.487 | 0.0304 | 0.082 | 1.62 | 3.118 |
| 21 | Guajaverin | 11.347 | 0.0083 | 0.022 | 0.33 | 0.638 |
| 24 | Apigenin-7- | 11.623 | 0.0234 | 0.063 | 1.5 | 2.892 |
| | O-glucoside | | | | | |

FIG. 1, panel B shows the HPLC profile of the extract supernatant of guava fruit 909. Compounds identified in the profile are listed in Table 1-5.

TABLE 1-5
HPLC analysis and compounds identified in extract supernatant of
guava fruit 909.

| | | Ret. Time | Amount | Amount | Rel.Area | Area |
|---|---|---|---|---|---|---|
| Peak | Peak Name | min | mg/mL | % of dissolved matter | % | mAU*min |
| 6 | Protocatechuic | 3.1 | n.a. | | 0.35 | 2.7557 |
| | acid | | | | | |
| 23 | Guajaverin | 11.347 | 0.005 | 0.0137 | 0.05 | 0.3689 |

FIG. 1, panel C shows the HPLC profile of the extract supernatant of guava leaf 910. Compounds identified in the profile are listed in Table 1-6.

TABLE 1-6
HPLC analysis and compounds identified in extract supernatant
guava leaf 910.

| | | Ret. Time | Amount | Amount | Rel. Area | Area |
|---|---|---|---|---|---|---|
| Peak | Peak Name | min | mg/mL | % of dissolved matter | % | mAU*min |
| 3 | Protocatechuic | 3.11 | n.a. | | 1.7 | 11.423 |
| | acid | | | | | |
| 5 | Caffeic acid | 7.113 | n.a. | | 2.35 | 15.810 |
| 15 | Hyperoside | 10.333 | 0.9109 | 2.7942 | 10.05 | 67.693 |
| 16 | Isoquercetin | 10.447 | 1.1182 | 3.4301 | 12.73 | 85.706 |
| 19 | Guajaverin | 11.29 | 0.009 | 0.0276 | 0.1 | 0.698 |
| 20 | Apigenin-7-O- | 11.667 | 0.0233 | 0.0715 | 0.43 | 2.887 |
| | glucoside | | | | | |

Since only a few components (Tables 1-4 to 1-6) could be identified and quantified by HPLC, the TPC (total phenolic content) was determined and expressed as gallic acid equivalents (Table 1-7).

TABLE 1-7
Total phenolic content (TPC) of extract supernatants.

| | TPC [GAE/g | TPC [GAE/g dry | |
|---|---|---|---|
| Extract | sample] | sample] | TPC [%] |
| sweet tea 885 | 237.3 | 224.0 | 22.4* |
| guava fruit 909 | 572.3 | 528.4 | 52.8 |
| guava leaf 910 | 568.9 | 545.9 | 54.6 |

*23.73% in datasheet

### Cell Viability Testing

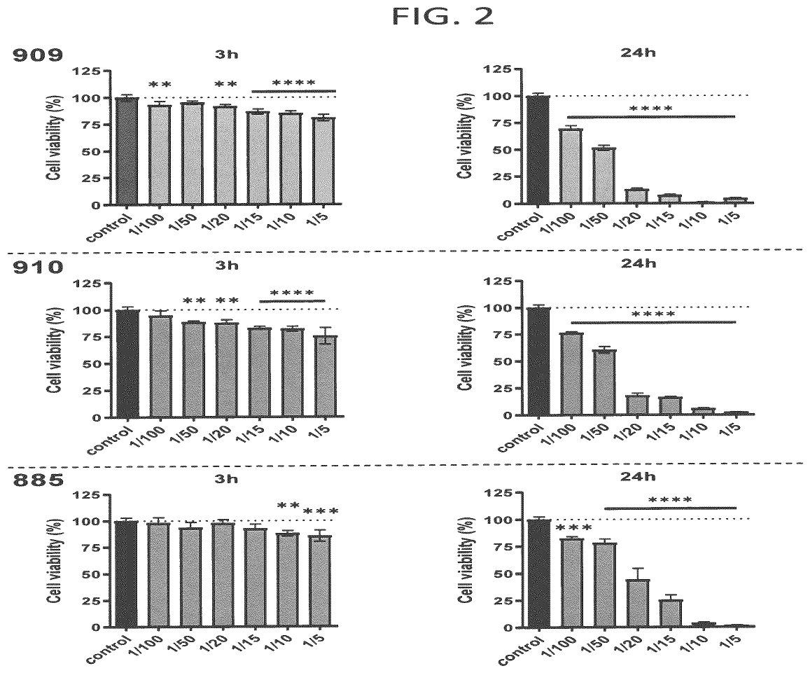

To confirm that the extract concentrations used in Caco-2 glucose transport experiments are not cytotoxic, a cell viability assay had to be performed. Therefore, Caco-2 cells were prepared in 96-well microtiter plates and then treated for 3 and 24 hours with a dilution series of the prepared extracts (see under material and methods, extract preparation). Consequently, the cell viability was detected with resazurin. As shown in FIG. 2, all concentrations tested for 24 h were already cytotoxic. However, the 3 h cell viability test is more relevant, since the glucose transport test is also performed in this time period. For guava fruit 909, the 1/100 dilution already significantly differed from the control. However, as the cell viability was still above 80% at the 1/10 dilution, the 1/100 to 1/10 dilutions can be regarded as non-cytotoxic for the 3 h treatment duration. The same is true for guava leaf 910. Regarding sweet tea 885, all tested concentrations tested for 3 h were above 80% (see FIG. 2).

To exclude cytotoxicity, the concentrations given in Table 1-3 were used for the subsequent glucose transport experiment.

### Glucose Transport With Extracts 909, 910 and 885

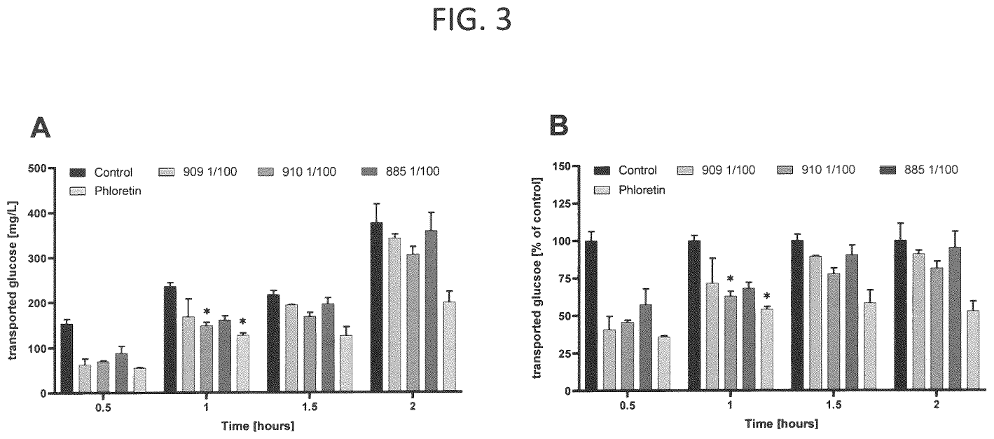

For the transport test, Caco-2 cells were seeded into trans-wells for fast differentiation. On day 5, the inhibitory potential on glucose absorption was investigated. All tested extracts showed an inhibitory effect on glucose transport throughout the experiment (FIG. 3, panel A and panel B). The effect was generally stronger during the first half of the experiment and was significant for extract 910 and phloretin after 1 hour of treatment.

The inhibitory effect of the extracts on glucose transport was generally stronger during the first half of the experiment (0.5 h: 41-57% glucose transport compared to control, Table 1-8). After 1 hour, guava leaf 910 (63% compared to control) and phloretin (54% compared to control) significantly reduced glucose absorption (Table 1-8, bold).

TABLE 1
Glucose transport compared to untreated control [% of control].

| | guava fruit 909 | guava leaf 910 | sweet tea 885 | Phloretin |
|---|---|---|---|---|
| 0.5 h | 41% | 46% | 57% | 36% |
| 1.0 h | 71% | 63% | 68% | 54% |

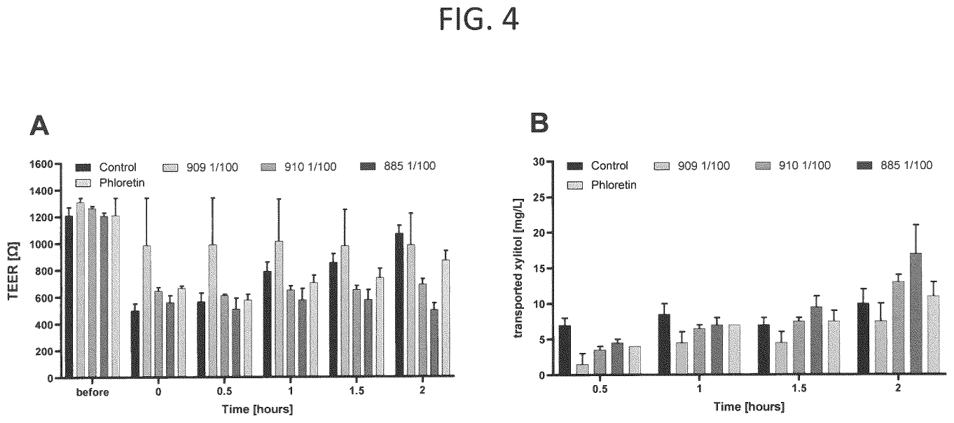

The Caco-2 barrier integrity was investigated during the experiment by measuring TEER and the passage of the reference substance xylitol. The barrier of Caco-2 layers remained intact throughout the transport test, as the TEER remained around 400 Ω (FIG. 4, panel A). At this TEER, the passage of xylitol trough the cell layer could be still observed (FIG. 4, panel B), however at a low level, which also confirms barrier integrity. Interestingly, although sweet tea 885 had the weakest cytotoxic effect in the cell viability testing, it had the strongest effect on the TEER of the Caco-2 barrier. All cell layers were at a higher TEER level or started to recover, whereas sweet tea 885 treated cell layers did not. This also explains the slightly higher xylitol transport (diffusion) and the loss of the inhibitory potential after 1.5 hours. Therefore, it can be concluded, that the 1/100 dilution of sweet tea 885 was already close to cytotoxicity.

Conclusion: In this study, guava fruit extract 909 and guava leaf extract 910 and sweet tea extract 885 were investigated regarding their effect on glucose absorption using a human intestinal transwell model. For all three extracts, an inhibitory effect on glucose transport was observed, which mainly occurred within the first 1.5 hours of treatment. Guava leaf extract 910 exerted a stronger activity than guava fruit extract 909. Sweet tea extract 885 exerted a weaker effect than guava leave or fruit presumably caused by higher cytotoxicity. HPLC analysis revealed a few (polyphenolic) compounds present in the extracts which may explain the effects observed.

### Example 2. Rubusoside Containing Plant Extracts Inhibit Glucose Absorption in a Human Intestinal Trans-Well Model

Two different samples of tea leave extracts with different % of rubusoside were obtained from EPC Products Co., Ltd. Both products were tested in the Caco-2 based trans-well model regarding their inhibitory potential on glucose transport. The concentrations were selected based on concentrations used in this above-mentioned paper (up to 20 mM).

### Material and Methods

The obtained powders consist of sweet tea leaf (Brombeerblatt) extract supplemented with 60 or 85% rubusoside. The one with 60% represents the “crude” extract, whereas the one with 85% rubusoside represents the “refined” extract.

### Cultivation of Caco-2 Cells

Human intestinal Caco-2 (DSMZ, Germany) cells were maintained in MEM (PAN™ Biotech, P04-08056) supplemented with 10% FBS and 100 U/mL penicillin and 100 μg/mL streptomycin (PAN™ Biotech, P06-07050) and were cultured at 37° C. in a humidified 5% CO₂ atmosphere.

### Cell Viability Assay

Caco-2 (150,000 cells/well) cells were seeded in 96-well plates (Greiner Bio-One, Kremsmünster, Austria) and grown overnight to reach confluency on the next day. The treatment with the test substances was performed for 24 h (100 μL/well). Upon the treatment for 24 h, cell viability was detected with resazurin (Sigma-Aldrich). Resazurin was added in an amount equal to 10% of the volume in the well (10 μL) and the cells were incubated for 1.5 h. The non-fluorescent resazurin is converted to the highly fluorescent resorufin by cellular respiration. The fluorescence intensity (Ex560 nm/Em590 nm) of the product resorufin was detected and normalized to the signal of untreated control. Statistical analysis in cell viability assays was carried out using one-way ANOVA in GraphPad Prism (version 9.3.1, GraphPad Software Inc., San Diego, CA, USA).

Extract concentrations used for cell viability testing are shown in Table 2-1.

TABLE 2-1
Extract concentrations used for cell viability testing

| 813 RU60 | | 814 RU85 | |
|---|---|---|---|
| extract | rubusoside | extract | rubusoside |
| concentration | concentration | concentration | concentration |
| [g/L] | [mM] | [g/L] | [mM] |
| 0.05 | 0.05 | 0.04 | 0.05 |
| 0.11 | 0.1 | 0.08 | 0.1 |
| 0.16 | 0.15 | 0.11 | 0.15 |
| 0.27 | 0.25 | 0.19 | 0.25 |
| 0.54 | 0.5 | 0.38 | 0.5 |
| 1.07 | 1 | 0.76 | 1 |
| 1.61 | 1.5 | 1.13 | 1.5 |
| 2.68 | 2.5 | 1.89 | 2.5 |
| 5.36 | 5 | 3.78 | 5 |
| 12.05 | 7.5 | 8.51 | 7.5 |
| 26.78 | 10 | 18.90 | 10 |
| 80.34 | 15 | 56.71 | 15 |
| 241.01 | 20 | 170.13 | 20 |
| 803.38 | 30 | 567.09 | 30 |

Glucose transport Assay

Caco-2 (165,000 cells/insert) cells were seeded on 0.4 μm trans-well inserts for monolayer formation and fast differentiation (enterocyte differentiation medium). On day 5, glucose transport across the cell monolayer was performed. Briefly, cell culture medium containing 13.5 g/L glucose and 1 g/L xylitol with or without the indicated concentrations of rubusoside plant extract or phloretin was placed as donor solution onto the apical compartment. Samples were collected from the basolateral compartment (HEPES buffer) after 0, 0.5, 1, 1.5, 2 and 3 hours. Glucose and xylitol concentrations of the samples were measured by HPLC. Cell layer integrity was confirmed by TEER measurements (Millicell ERS-2 Voltometer) at each sampling time point. Statistical analysis in cell viability assays was carried out using two-way ANOVA in GraphPad Prism (version 9.3.1, GraphPad Software Inc., San Diego, CA, USA). Extract concentrations used in the glucose transport assay are shown in Table 2-2.

TABLE 2-2
Extract concentrations used in the glucose transport assay:

| | extract | rubusoside |
|---|---|---|
| extract sample | concentration [g/L] | concentration [mM] |
| 813 RU60 | 0.54 * | 0.5 |
| | 0.27 | 0.25 |
| 814 RU85 | 1.13 * | 1.5 |
| | 0.57 | 0.75 |

* highest non-cytotoxic extract concentration

### Results

### 1. Cell Viability Testing

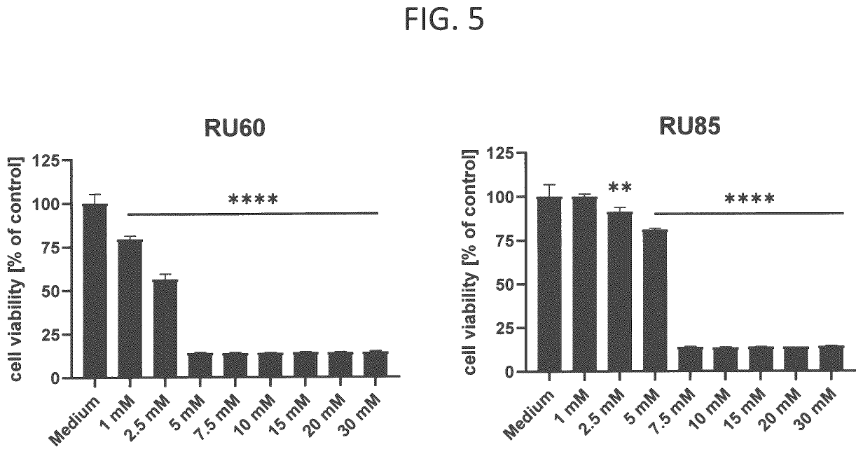

To confirm that the extract concentrations used in Caco-2 glucose transport experiments are not cytotoxic, a cell viability assay had to be performed. Therefore, Caco-2 cells were prepared in 96-well microtiter plates and then treated for 24 hours with a dilution series of RU60 and RU85. Consequently, the cell viability was detected with resazurin. As shown in FIG. 5, RU60 extract had cytotoxic effects at 1 mM rubusoside (1.1 g/L RU60 extract), whereas for RU85 extract was not cytotoxic until 2.5 mM rubusoside (1.9 g/L RU85 extract).

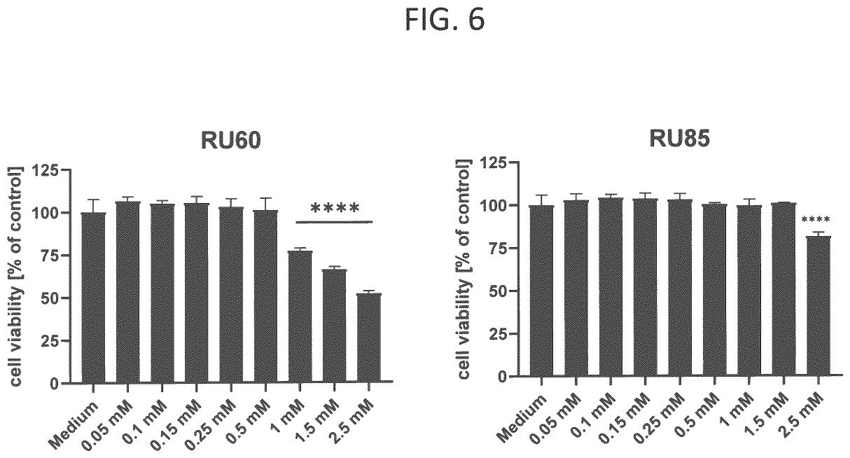

To exactly determine the highest non-cytotoxic concentrations of both extracts, that can be applied in the glucose transport assay, the cell viability test was repeated using a smaller concentrations range of the extracts. As shown in FIG. 6, The second cell viability test revealed that RU60 can be applied up to 0.5 mM rubusoside (0.54 g/L RU60) and RU85 can be used up to 1.5 mM rubusoside (1.13 g/L RU85).

### 2. Glucose Transport Assay With RU60 and RU85

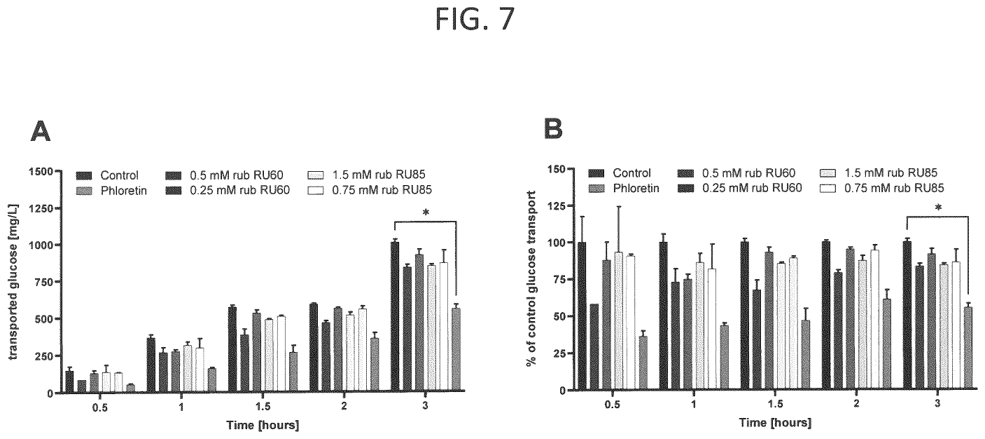

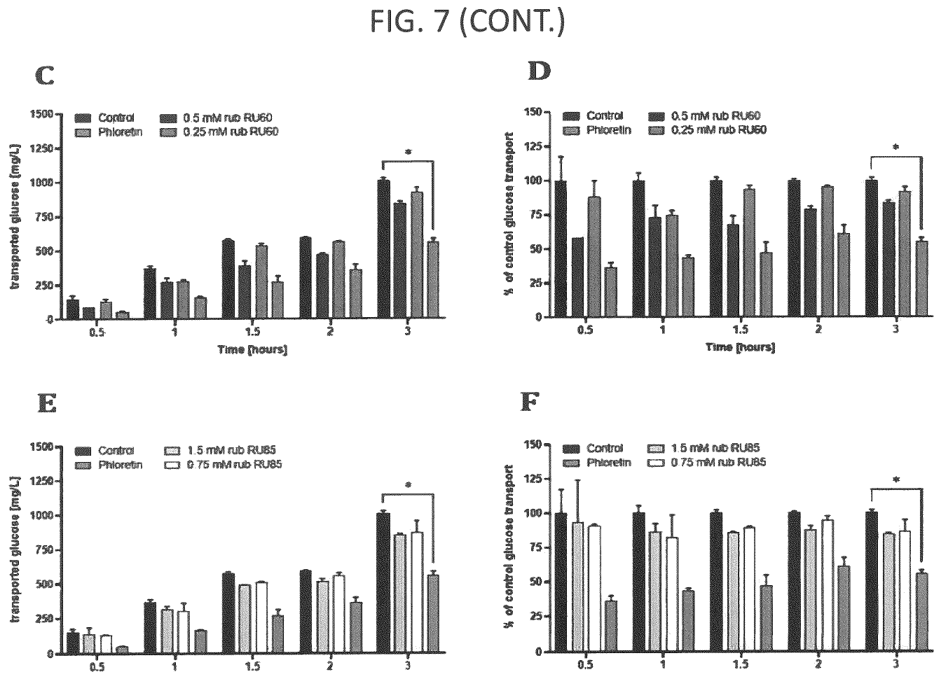

For the transport test, Caco-2 cells were seeded into transwells for fast differentiation. On day 5, the inhibitory potential on glucose absorption was investigated. As shown in FIG. 7, the tested extracts showed an inhibitory effect on glucose transport, especially the higher concentrations. However, the effect was not as strong as those of the control phloretin and thus not significant.

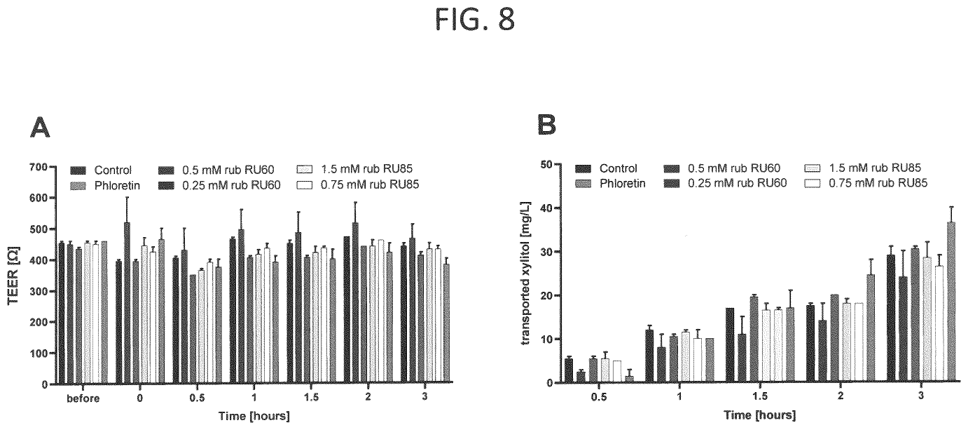

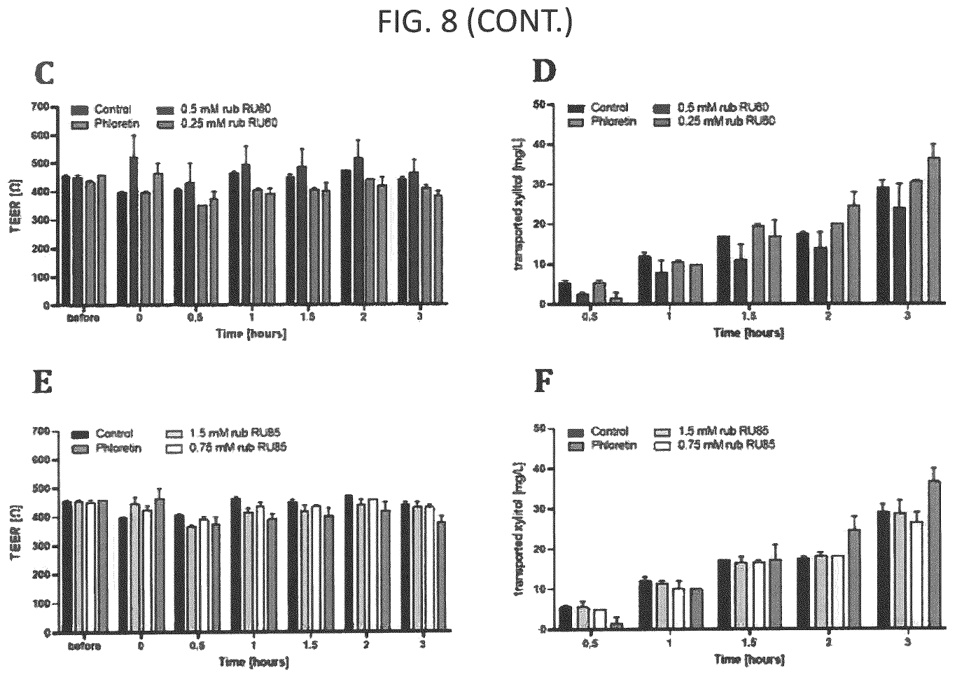

The Caco-2 barrier integrity was investigated during the experiment by performing TEER measurements and by measuring the passage of the reference substance xylitol. The barrier of Caco-2 layers remained intact throughout the transport test, as the TEER remained around 400 Ω (FIG. 8, Panels A, C and E). At this TEER, the passage of xylitol trough the cell layer could be still observed (FIG. 8, Panels B, D and F). However, as the phloretin treated cell layers, whose xylitol permeability was the highest, had the desired effect of a strongly reduced glucose absorption, the cell layers can be regarded as intact.

What is claimed is:

1. A method for inhibiting glucose absorption in a subject, comprising the step of:
administering to the subject, an effective amount of a plant extract that inhibits glucose transport in a mammalian cell, wherein the plant extract contains one or more substances selected from the group consisting of alkaloids, flavonoids, polyphenols and isoprenoids.

2. The method of claim 1, wherein the plant extract comprises one or more of the substances selected from the group consisting of rubusosides, protocatechuic acid, caffeic acid, rutin, hyperodise, isoquercetin, guajaverin, and apigenin-7-O-glucoside. inhibits the activity of a GLUT protein, a SGLT protein, or a SWEET protein.

3. The method of claim 1, wherein the plant extract is a sweet tea extract.

4. The method of claim 1, wherein the plant extract comprises rubusoside.

5. The method of claim 1, wherein the plant extract is a monk fruit extract.

5. The method of claim 1, wherein the plant extract is a Stevia extract.

6. The method of claim 1, wherein the plant extract is a guava fruit extract or guava leaf extract.

7. A composition comprising:
(1) a high intensity sweetner (HIS); and
(2) a glucose transport inhibitor that is not derived from the HIS.

8. The composition of claim 7, wherein the glucose transport inhibitor is a plant extract comprising rubusoside.

9. The composition of claim 7, wherein the glucose transport inhibitor is a Stevia extract.

10. The composition of claim 7, wherein the glucose transport inhibitor is a non-SG substance.

11. The composition of claim 7, wherein the glucose transport inhibitor is a monk fruit extract.

12. The composition of claim 7, wherein the glucose transport inhibitor is a sweet tea extract

13. The composition of claim 12, wherein the sweet tea extract is RU60 or RU85.

14. The composition of claim 7, wherein the glucose transport inhibitor is a guava leaf extract or a guava fruit extract.

15. The composition of claim 7, wherein the glucose transport inhibitor has antioxidant activities.

16. The composition of claim 7, wherein the glucose transport inhibitor is selected from the group consisting of alkaloids, flavonoids, polyphenols and isoprenoids.

17. A beverage comprising the composition of claim 7.

18. A diary product comprising the composition of claim 7.

19. A food product comprising the composition of claim 7.

20. A method for inhibiting glucose absorption in a subject, comprising the step of:
administering to the subject, an effective amount of the composition of claim 7.
